(19) United States
(12) Patent Application Publication
(10) Pub. No.: US 2002/0041595 A1
(43) Pub. Date: Apr. 11, 2002

(54) System and method for suspending and resuming transmission of information without creating significant additional overhead

(76) Inventor: Marc Delvaux, Metuchen, NJ (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/963,771

(22) Filed: Sep. 27, 2001

Related U.S. Application Data
(60) Provisional application No. 60/238,793, filed on Oct. 5, 2000.

(51) Int. Cl. H04L 12/56

(52) U.S. Cl. 370/392; 370/444

(57) ABSTRACT

A system and method for suspending and resuming transmission of data streams without creating significant additional overhead is described. The transmission of information is governed by a priority sorting mechanism that keeps track of data stream transmission order, thereby allowing for suspension and resumption of data stream transmission without the creation of significant additional overhead.

### CROSS REFERENCE TO RELATED APPLICATIONS

This application claims the benefit of U.S. Provisional Patent Application No. 60/238,793, dated Oct. 5, 2000, which is incorporated herein by reference in its entirety.

### FIELD OF INVENTION

The present invention generally relates to communication systems, and more particularly to an improved system and method for suspending and resuming transmission of data according to a predetermined priority sorting mechanism.

### BACKGROUND

As the Internet has grown in size and popularity, an accompanying need for faster and more reliable data transmission systems has also arisen. Particularly, problems arise with low speed links. One such problem, known as waiting time jitter, occurs when a higher priority message may have to wait behind a lower priority message that is currently being transmitted. Typically, two approaches have been used to combat waiting time jitter. In the first approach, the maximum allowed packet size is reduced and, therefore, the waiting time jitter is correspondingly decreased. However, this type of approach decreases the link efficiency because, while the payload rate decreases, the packet overhead remains constant. In the second approach, a lower priority data stream is aborted, thereby opening up the channel for transmission of higher priority data packets. Unfortunately, the aborted lower priority data packet generally needs to be re-transmitted in its entirety at a later time and, thus, efficiency is reduced.

In an effort to address these problems, a suspend/resume-oriented solution has been proposed. In this approach, higher priority data streams interrupt lower priority data streams without aborting the transmission of the lower priority data streams. This is accomplished by dynamically fragmenting a lower priority data stream that is currently being transmitted, thereby allowing the higher priority data stream to be transmitted ahead of the lower priority data stream. Although this approach increases the efficiency of transmission, there is an added inefficiency that arises upon fragmentation of the lower priority data stream. This inefficiency arises because each fragmentation of a lower priority data stream creates an additional header that identifies the packet associated with the fragment. This creation of additional headers results in significant additional overhead. Examples of this are more clearly explained with reference to FIGS. 1A through 4B.

FIG. 1A is a diagram illustrating an unsuspended transmission of a data stream, frame-0 100. Typically, frame-0 100 comprises several distinct segments. For purposes of clarity, these segments are shown in FIG. 1 as being transmitted along a time axis 10 down the page, where the top of the page represents an earlier time and the bottom of the page represents a later time. Frame-0 100 comprises a start flag 110, a frame-0 header 120, frame-0 data 130 that makes up the body of frame-0 100, and an end-flag 140 for frame-0 100. Although separate start flags and end flags are shown in the following examples, the system may be configured so that the start flag of the next frame serves a dual role of indicating the beginning of the next frame as well as indicating the end of the current frame. In a typical frame transmission system, the start flag 110 enters the stream to indicate the beginning of frame-0 100. Immediately after the start flag 110, the frame-0 header 120 follows. The frame-0 header 120 typically contains information indicating the type of data stream or the priority of the data stream. Once the frame-0 header 120 has been transmitted, frame-0 data 130 is transmitted and followed up by a frame-0 end-flag 140 indicating the end of frame-0 100. Thus, in the absence of any interruption, the start flag 110, the frame-0 header 120, frame-0 data 130, and the frame-0 end-flag 140 are transmitted in one continuous stream as shown in FIG. 1A. From this it can be seen that the frame header that is associated with the transmitted frame identifies the transmitted frame.

The data stream (or frame) of FIG. 1A is typically based on an eight-bit base or an octet as shown in FIG. 1B. Thus, in the particular example of FIG. 1B, both the header 120 and the data 130 are comprised of octets. This type of octet based system is limited by the fact that there are only eight bits to encode the priority information for the frame.

FIG. 2A is a diagram illustrating a suspension of a low-priority data stream, frame-0 100, by a high-priority data stream, frame-1 200, as performed in the prior art. Similar to FIG. 1A, the time axis 10 is shown going from the top of the page to the bottom of the page. This example of interrupted data transmission shows a start flag 110 being transmitted, followed by a frame-0 header 120a for the first fragment of frame-0 100a. Following the transmission of the frame-0 header 120a, frame-0 data 130a is transmitted. As shown in FIG. 2A, upon detection of higher priority frame-1 200 a frame suspend enable flag (FSE) 210 is inserted into the data stream and the transmission of frame-0 is suspended. The suspension of frame-0 100 creates a second fragment of frame-0 100b having another frame-0 header 120b, which identifies the second frame-0 fragment 100b as belonging to frame-0 100. Once frame-0 100 has been suspended by higher priority frame-1 200 and a FSE flag 210 has been inserted into the data stream, higher priority frame-1 200 is transmitted. As shown in FIG. 2A, higher priority frame-1 200 comprises a frame-1 header 220 which identifies the higher priority frame-1 200, data 230 which is associated with higher priority frame-1 200, and an end-flag 240 which marks the end of higher priority frame-1 200. Once higher priority frame-1 200 has been transmitted in its entirety, the remaining portion of lower priority frame-0 100b is transmitted. This is done by transmitting the last portion of lower priority frame-0 100b, which comprises another frame-0 header 120b, the remaining frame-0 data 130b, and the frame-0 end-flag 140 which identifies the end of the transmission of lower priority frame-0 100.

FIG. 2B is a diagram illustrating the transmission of data in FIG. 2A with a black arrow highlighting the additional frame-0 header 120b that is typically created upon fragmentation of the lower priority data stream 100. If the interruption of data were to be shown as a sequential set of events they would be as follows. First, a start flag 110 would be transmitted. Immediately following the start flag 110, a frame-0 header 120a, which indicates the beginning of the first data stream, would be transmitted. Frame-0 data 130a associated with the lower priority first frame would then be transmitted after the frame-0 header 120a. A FSE flag 210 would then follow, which would indicate that frame-0 100 was being suspended in order to allow higher priority frame-1 200 to be transmitted ahead of the remaining portions of lower priority frame-0 100. Immediately following the FSE flag 210, a header 220 for higher priority frame-1 200 would be transmitted. Following the frame-1 header 220, the higher priority frame-1 data 230 would be transmitted, and, once frame-1 data 230 transmission was completed, a frame-1 end-flag 240, indicating the end of higher priority frame-1 200, would be transmitted. At this point, transmission of the suspended lower priority frame-0 100 would be resumed. Thus, a frame-0 header 120b associated with lower priority frame-0 100b would be transmitted, followed by the remaining frame-0 data 130b, and, finally, the frame-0 end-flag 140. Thus, as shown in FIG. 2B, upon fragmentation of lower priority frame-0 100, an additional frame-0 header 120b is created in order to identify frame-0 data 130b associated with the lower priority frame-0 100. Here, it can be seen that the frame headers associated with their respective frame fragments identify the fragmented portions of the transmitted frames. These headers allow for reconstruction of the frames at the site of reception.

FIG. 3A is a diagram illustrating the suspension of low-priority frame-0 100 by two higher priority data streams, frame-1A and frame-1B, as performed in the prior art. The approach here is similar to the approach described in FIGS. 2A and 2B, the only difference here being that lower priority frame-0 100 is being suspended twice, rather than once. For purposes of clarity, the lower priority data stream is, once again, designated as frame-0 100, and the two higher priority data streams as frame-1A and frame-1B. The transmission begins with a start flag 110 followed by a frame-0 header 120a. The frame-0 header 120a identifies frame-0 data 130a, which follows the frame-0 header 120a. Upon detection of the higher priority frame-1A 200a, a FSE flag 210a is inserted into the stream. Following the FSE flag 210a, frame header-1A 220 is transmitted. Frame header-1A 220 identifies frame-1A data 230 associated with the first higher priority data stream, frame-1A 200a. After frame-1A data 230 has been transmitted, a frame-1A end-flag 240 is inserted into the transmission path to indicate the end of frame-1A 200. Following transmission of frame-1A 200a, the second fragment of frame-0 100c is transmitted. This second fragment of frame-0 100c comprises a frame-0 header 120c, which indicates the continuation of frame-0 100. The frame-0 header 120c is followed by frame-0 data 130c. At this point, if a higher priority frame-1B 200b is detected, the lower priority frame-0 100c is once again suspended. Thus, another FSE flag 210b is inserted into the stream and immediately followed by a frame-1B header 320. The frame-1B header 320 identifies the frame-1B data 330, which follows the frame-1B header 320. A frame-1B end-flag 340 is inserted after the transmission of all of the frame-1B data 330. After completing transmission of frame-1B 200b, the system resumes transmission of the last fragment of frame-0 100b. This is done by transmitting a frame-0 header 120b, followed by the frame-0 data 130b, and closed off by a frame-0 end-flag 140.

FIG. 3B is a diagram illustrating the transmission of data in FIG. 3A with black arrows highlighting the additional headers 120c, 120b that are typically created upon fragmentation of lower priority data streams. Since, in this example, the lower priority frame-0 100 has been interrupted or suspended twice, there are two headers 120c, 120b created, one with each fragmentation. Thus, the transmission of sequential frame segments would be described in the following manner. First, a start flag 110 enters the stream. This is followed by a frame-0 header 120b, which identifies frame-0 100 as the data stream being transmitted. Frame-0 data 130a is then transmitted after frame-0 header 120b. A FSE flag 210a indicates that higher priority frame-1A will interrupt the transmission of frame-0 100. Following the FSE flag 210a, frame-1A header 220 is transmitted followed by frame-1A data 230. Once all the data 230 for frame-1A 200 has been transmitted, a frame-1A end-flag 240 is transmitted to indicate the end of frame-1A 200. The transmission of frame-1A is followed by the second fragment of frame-0 100c, which comprises a frame-0 header 120c, frame-0 data 130b, and another FSE flag 210b, which indicates another interruption by higher priority frame-1B 300. Once frame-0 100 is suspended for a second time, frame-1B 300 is transmitted. Frame 1B comprises a frame-1B header 320, frame-1B data 330, and a frame-1B end-flag 340. After transmission of higher priority frame-1B 200b, the remaining portion of frame-0 100 is transmitted. This final portion of frame-0 100b comprises a frame-0 header 120b, frame-0 data 130c, and a frame-0 end-flag 140, which indicates the end of frame-0 100. Again, it is worthwhile to note that because of the two interruptions by frame-1A 200 and frame-1B 300, there are two additional headers 120c, 120b created in this example. Similar to the example of FIGS. 2A and 2B, the frame headers associated with their respective frame fragments identify the fragmented portions of the transmitted frames here. These headers allow for reconstruction of the frames at the site of reception.

FIG. 4A is a diagram illustrating successive suspensions of a low-priority data stream, frame-0 100, by a mid-priority data stream, frame-1 200, and the mid-priority data stream by a high-priority data stream, frame-2 400, as performed in the prior art. For purposes of clarity, the low-priority frame is designated as frame-0 100, the mid-priority frame is designated as frame-1 200, and the high-priority frame is designated as frame-2 400. Similar to the previous figures, transmission of information starts with a start flag 110. Following the start flag, frame-0 100 is transmitted. Frame-0 100 comprises a frame-0 header 120a, followed by frame-0 data 130a. The frame-0 data 130a is followed by a FSE flag 210, which indicates that a higher priority frame will interrupt the transmission of frame-0 100. Following suspension of frame-0 100, a frame-1 header 220a is transmitted to identify incoming frame-1 200. The frame-1 header 220a is followed by frame-1 data 230a. At this point, another FSE flag 410 is inserted into the transmission path to indicate an interruption of frame-1 200 by frame-2 400. Upon suspension of frame-1 200, frame-2 400 is transmitted. Frame-2 400 comprises a frame-2 header 420, frame-2 data 430, and a frame-2 end-flag 440, which indicates the end of frame-2 400. Once frame-2 400 has been transmitted in its entirety, the transmission of mid-priority frame-1 200 is resumed. The resumed portion of frame-1 200b comprises another frame-1 header 220b, frame-1 data 230b, and a frame-1 end-flag 240, which indicates the end of frame-1 200. After transmission of mid-priority frame-1 200 has been completed, transmission of low-priority frame-0 100 is resumed. The remaining portion of low-priority frame-0 100b comprises another frame-0 header 120b, frame-0 data 130b, and a frame-0 end-flag 140, which indicates that frame-0 100 has been completely transmitted.

FIG. 4B is a diagram illustrating the transmission of data in FIG. 4A with black arrows highlighting the additional headers 200b, 120b that are created upon successive fragmentations of lower priority data streams (i.e., frame-0 100 and frame-1 200). As shown in FIG. 4B, there is one additional header 200b that is created by suspending frame-1 200, and another additional header 120b created by suspending frame-0 100. Thus, similar to FIGS. 3A and 3B, there is an additional header that is created for each time a frame is suspended. Again, as in FIGS. 2A and 2B, it can be seen that the frame headers associated with their respective frame fragments identify the fragmented portions of the transmitted frames. These headers allow for reconstruction of the frames at the site of reception.

These examples show that significant additional overhead is created with each interruption of a transmitted frame. This leads to inefficiencies in data transmission due to significant additional overhead if frames are continuously interrupted. Given this inefficiency, there is a need in the art for a system and method for suspending and resuming transmission of data streams without the creation of significant additional overhead.

### SUMMARY

The present invention provides a system and method for suspending and resuming transmission of data streams without creating significant additional overhead.

Briefly described, the invention allows a data transmission system to evaluate transmission priorities for multiple data streams according to a predetermined priority sorting mechanism. Once the priority of each data stream has been determined, a lower priority data stream is suspended in order for higher priority data streams to be transmitted ahead of the lower priority data streams. The transmitted data is then reconstructed at the receiver site using the predetermined priority sorting mechanism. Since the data streams are suspended and reconstructed according to a predetermined priority sorting mechanism, no significant additional overhead is created and, thus, greater efficiency in data transmission is achieved. Alternatively, higher priority data streams may be suspended by lower priority data streams by indicating a non-priority based transmission using a special flag, which indicates a deviation from a priority-based approach. This allows for fragmentation and reconstruction of non-priority based data streams with a minimal amount of additional overhead.

In architecture, the system comprises a processor having a priority sorting mechanism. The priority sorting mechanism is configured to determine a transmission order for multiple data streams according to priority values that are associated with each data stream. The processor is configured to transmit a higher priority data stream ahead of a lower priority data stream after the transmission order has been determined by the priority sorting mechanism. In the event that a higher priority data stream is waiting to be transmitted while a lower priority data stream is being transmitted, the processor is configured to suspend the lower priority data stream, thereby allowing the waiting higher priority data stream to be transmitted ahead of the lower priority data stream. This suspension and resumption of transmission is governed by a predefined priority sorting mechanism, which keeps track of transmission order. Thus, the system allows for suspension and resumption of data transmission without the creation of significant additional overhead. Again, since the suspension and resumption is governed by the priority sorting mechanism, the system may, in the alternative, allow for suspension of higher priority data streams by lower priority data streams.

In accordance with another aspect of the present invention, a method is provided for suspending and resuming transmission of lower priority data streams without creating significant additional overhead. The steps associated with the method can be broadly conceptualized as comparing frame priorities; preserving data stream transmission order using a predetermined priority sorting mechanism; suspending lower priority frames; transmitting higher priority frames ahead of lower priority frames; and resuming transmission of lower priority frames in accordance with the predetermined priority sorting mechanism. Here, depending on the transmission order established by the priority sorting mechanism, higher priority data streams may be suspended by lower priority data streams.

Other systems, methods, features, and advantages of the invention will be, or become, apparent to one with skill in the art upon examination of the following figures and detailed description. It is intended that all such additional systems, methods, features, and advantages be included within the scope of the invention, and be protected by the accompanying claims.

### BRIEF DESCRIPTION OF THE DRAWINGS

The above and further features, advantages, and benefits of the present invention will be apparent upon consideration of the following detailed description, taken in conjunction with the accompanying drawings, in which like reference characters refer to like parts throughout.

FIG. 1A is a diagram illustrating an unsuspended transmission of a data stream.

FIG. 1B is a diagram illustrating a typical 8-bit base associated with the data stream of FIG. 1A.

FIG. 2A is a diagram illustrating a suspension of a low-priority data stream by a high-priority data stream, as previously performed in the prior art.

FIG. 2B is a diagram illustrating the transmission of data in FIG. 2A with a black arrow highlighting the additional header that is typically created upon fragmentation of lower priority data streams.

FIG. 3A is a diagram illustrating the suspension of a low-priority data stream by two higher-priority data streams, as performed in the prior art.

FIG. 3B is a diagram illustrating the transmission of data in FIG. 3A with black arrows highlighting the additional headers that are typically created upon fragmentation of lower priority data streams.

FIG. 4A is a diagram illustrating successive suspensions of a low-priority data stream by a mid-priority data stream, and the mid-priority data stream by a high-priority data stream, as performed in the prior art.

FIG. 4B is a diagram illustrating the transmission of data in FIG. 4A with black arrows highlighting the additional headers that are created upon successive fragmentations of lower priority data streams.

FIG. 5A is a diagram showing an overview of an asymmetric digital subscriber line (ADSL) system.

FIG. 5B is a diagram showing the transmitting and receiving components of the ADSL system of FIG. 5A in greater detail.

FIG. 5C is a diagram showing the components of the ADSL transceiver unit (ATU) associated with the transmission of data in one embodiment of the suspend/resume-oriented system of the invention.

FIG. 5D is a diagram showing the components of the ATU associated with the reception of data in one embodiment of the suspend/resume-oriented system of the invention.

FIG. 6A is a diagram illustrating an embodiment of the invention, wherein a data stream is transmitted without interruption.

FIG. 6B is a diagram illustrating an embodiment of the invention, wherein a low-priority data stream is suspended by a high-priority data stream without the creation of significant additional overhead.

FIG. 6C is a diagram illustrating the transmission of data in FIG. 6B with a white arrow highlighting the absence of significant additional overhead.

FIG. 7A is a diagram illustrating an embodiment of the invention, wherein a low-priority data stream is suspended by two higher-priority data streams without the creation of significant additional overhead.

FIG. 7B is a diagram illustrating the transmission of data in FIG. 7A with white arrows highlighting the absence of significant additional overhead.

FIG. 8A is a diagram illustrating an embodiment of the invention, wherein a low-priority data stream is suspended by a mid-priority data stream without significant additional overhead, and the mid-priority data stream is suspended by a high-priority data stream without the creation of significant additional overhead.

FIG. 8B is a diagram illustrating the transmission of data in FIG. 8A with white arrows highlighting the absence of significant additional overhead.

FIG. 9A is a diagram illustrating an embodiment of the invention showing a data stream having no header.

FIG. 9B is a diagram illustrating a 12-bit base associated with the flags of FIG. 9A.

FIG. 9C is a diagram illustrating a 16-bit base associated with the flags of FIG. 9A.

FIG. 10A is a diagram illustrating an embodiment of the invention, wherein a low-priority header-less data stream (i.e., a data stream without a header) is suspended by a high-priority header-less data stream without the creation of significant additional overhead.

FIG. 10B is a diagram illustrating the transmission of data in FIG. 10A with a white arrow highlighting the absence of additional headers, and shaded arrows highlighting the absence of frame suspend enable (FSE) flags.

FIG. 11A is a diagram illustrating an embodiment of the invention, wherein a low-priority header-less data stream is suspended by two higher-priority header-less data streams without the creation of significant additional overhead.

FIG. 11B is a diagram illustrating the transmission of data in FIG. 1A with white arrows highlighting the absence of additional headers, and shaded arrows highlighting the absence of FSE flags.

FIG. 12A is a diagram illustrating an embodiment of the invention, wherein a low-priority header-less data stream is suspended by a mid-priority header-less data stream without significant additional overhead, and the mid-priority header-less data stream is suspended by a high-priority header-less data stream without the creation of significant additional overhead.

FIG. 12B is a diagram illustrating the transmission of data in FIG. 12A with white arrows highlighting the absence of additional headers, and shaded arrows highlighting the absence of FSE flags.

FIG. 13A is a diagram illustrating an embodiment of the invention, wherein low-priority and high-priority data streams are successively suspended and resumed.

FIG. 13B is a diagram illustrating the transmission of data in FIG. 13A with a black arrow highlighting the absence of an additional frame header, and a hashed arrow highlighting a frame suspend non-stack (FSN) flag that indicates a subsequent data stream interruption and a resumed transmission of a previously suspended data stream.

FIG. 14A is a diagram illustrating an embodiment of the invention, wherein low-priority and high-priority header-less data streams are successively suspended and resumed without the creation of significant additional overhead.

FIG. 14B is a diagram illustrating the transmission of data in FIG. 14A with a hashed arrow highlighting a frame continuation flag used for indicating a subsequent data stream interruption and a resumed transmission of a previously suspended data stream.

FIG. 15A is a diagram illustrating another embodiment of the invention, wherein low-priority and high-priority header-less data streams are successively suspended and resumed without the creation of significant additional overhead.

FIG. 15B is a diagram illustrating the transmission of data in FIG. 15A with a checkered arrow highlighting a special continuation flag and a frame start (opening) flag which, in combination, indicate a subsequent data stream interruption and a resumed transmission of a previously suspended data stream.

FIGS. 16A through 16C are flowcharts illustrating the method steps associated with transmitting the data streams of FIGS. 6A through 8B in one embodiment of the invention.

FIGS. 17A through 17C are flowcharts illustrating the method steps associated with transmitting the header-less data streams of FIGS. 9A through 12B in another embodiment of the invention.

FIGS. 18A through 18C are flowcharts illustrating the method steps associated with continued transmission of data streams as shown in FIGS. 13A and 13B in one embodiment of the invention.

FIGS. 19A through 19C are flowcharts illustrating the method steps associated with continued transmission of header-less data streams as shown in FIGS. 14A and 14B in another embodiment of the invention.

FIGS. 20A through 20C are flowcharts illustrating the method steps associated with continued transmission of header-less data streams using a predefined universal continuation flag as shown in FIGS. 15A and 15B in one embodiment of the invention.

### DETAILED DESCRIPTION OF DRAWINGS

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

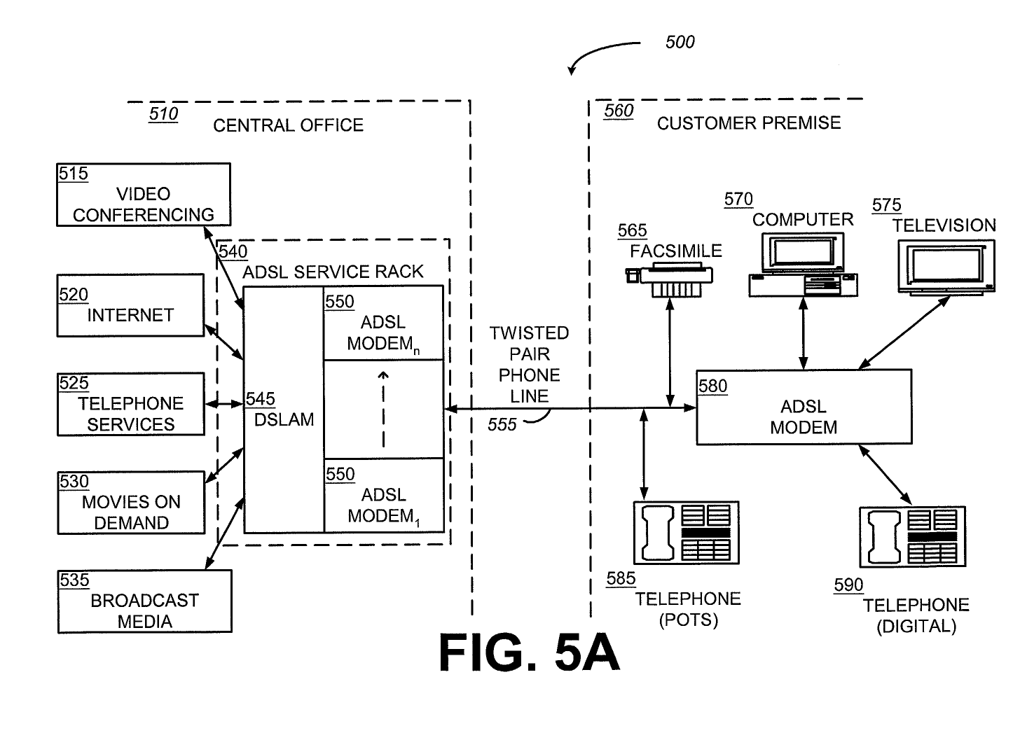

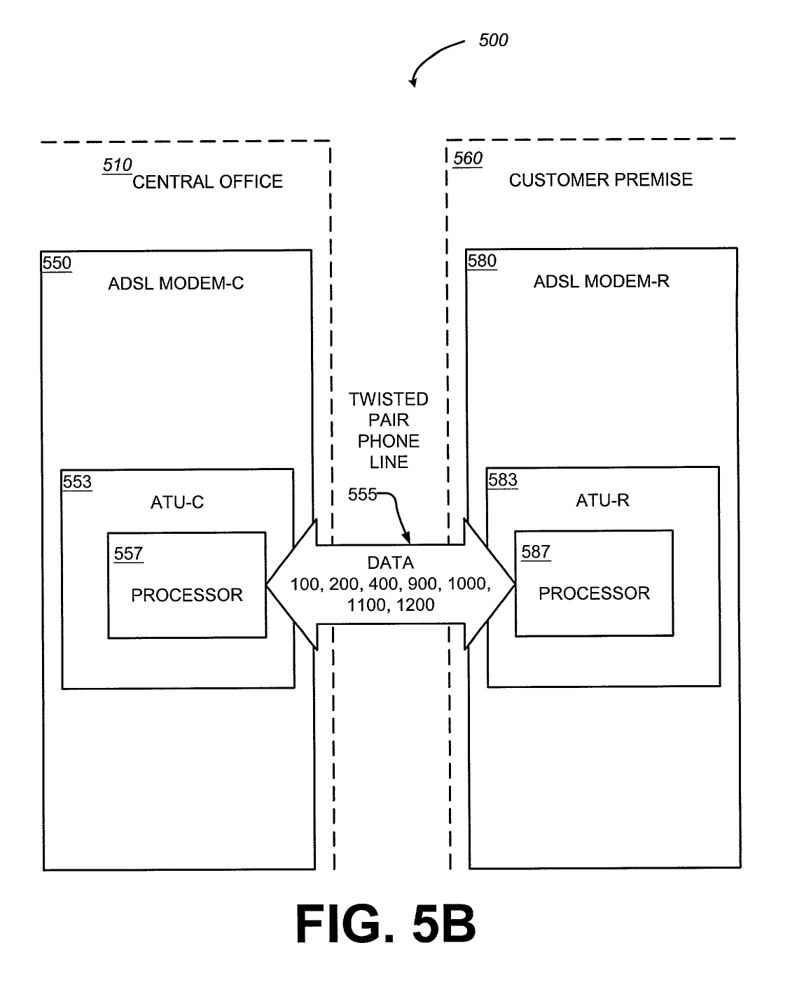

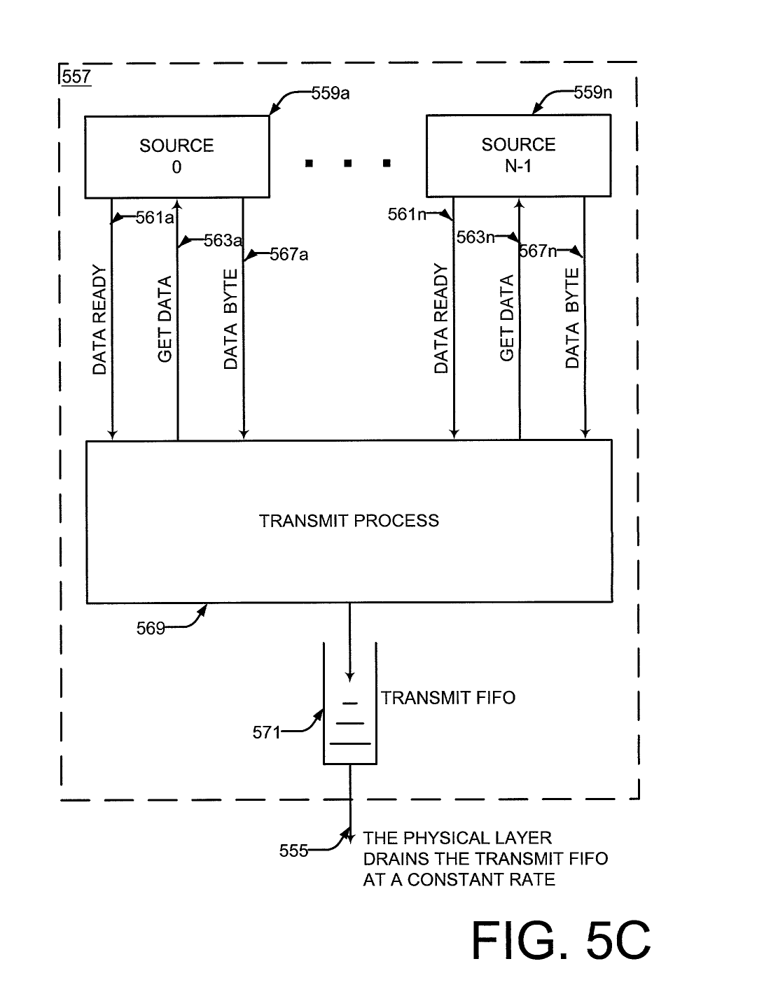

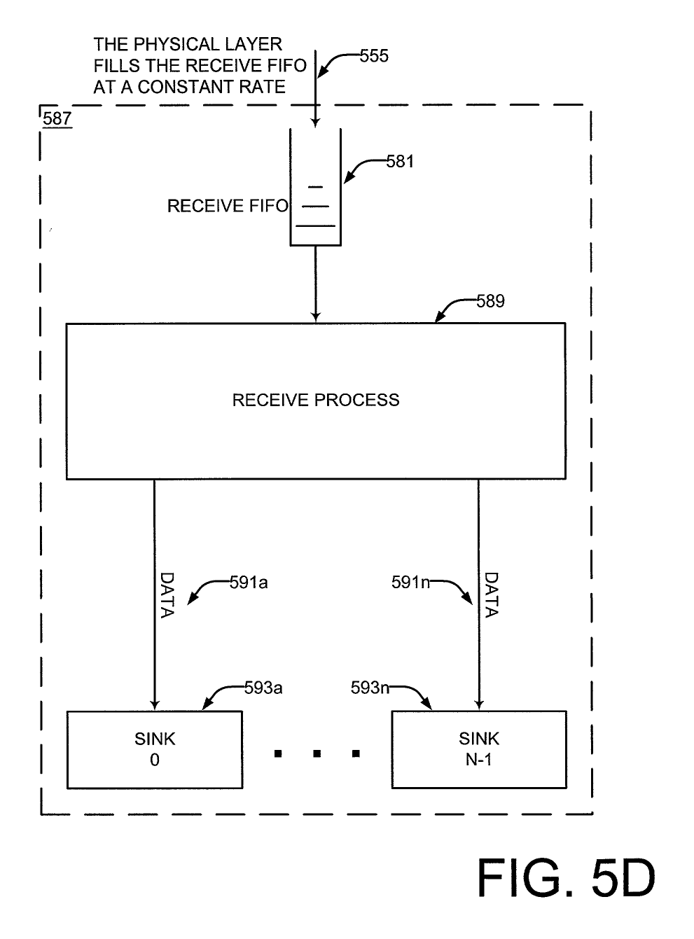

FIG. 5A is a diagram showing the overview of an asymmetric digital subscriber line (ADSL) environment, wherein a system and method for efficiently suspending and resuming transmission of information may be implemented. In this non-limiting example environment, a central office 510 is connected to a customer premise 560 via a twisted pair phone line. On the side of the central office 510 an ADSL service rack 540 gathers information for transmission. This information may be in the form of video conferencing 515, Internet 520, telephone services 525, movies on demand 530, or broadcast media 535. All of this information is gathered at a digital subscriber line access multiplexer (DSLAM) 545, which assembles the data for transmission by ADSL modems 550. Once this information has been coded and framed, it is sent to the customer premises via a twisted pair of phone lines 555. The data is received at the customer premises 560 by an ADSL modem 580. This information is then decoded and provided to the user. Several non-limiting examples of this include a fax 565, a user's computer 570, a television set 575, an analog telephone 585, or, in the alternative, a digital telephone 590.

FIG. 5B shows an embodiment of an ADSL transceiver unit (ATU-C) 553 for the ADSL modem 550 at the central office (i.e., the site of transmission) 510 and an embodiment of an ADSL transceiver unit (ATU-R) 583 for the ADSL modem 580 at the customer premise (i.e., the site of reception) 560 in greater detail. As shown in the non-limiting example of FIG. 5B, the ADSL modem-C 550 comprises an ADSL transceiver unit (ATU-C) 553, which is configured to frame the gathered information and establish a transmission order for various data streams 100, 200, 400, 900, 1000, 1100, 1200. This is carried out at a processor 557 at the site of transmission using a predefined priority sorting mechanism. The counterpart ADSL transceiver unit (ATU-R) 583 in the ADSL modem-R 580 comprises a processor 587, which is configured to reassemble the received signals into their respective data streams according to the predefined priority sorting mechanism.

FIG. 5C is a diagram showing the processor 557 components of the ADSL transceiver unit (ATU) 550, which are associated with the transmission of data in one embodiment of the suspend/resume-oriented system of the invention. In this non-limiting example, the ATU processor 557 comprises a transmit process 569, which determines priority according to a predefined priority sorting mechanism. In addition to the transmit process 569, the processor 557 comprises several sources (559a . . . 559n, hereinafter collectively referred to as 559), which are connected to the transmit process 569 and are responsible for supplying the transmit process with the data to be transmitted. The transmit process 569 is configured to receive data from the several sources 559 and determine the priority of received data according to a predefined priority sorting mechanism. The several sources 559 are configured to provide a data ready signal (561a . . . 561n, hereinafter collectively referred to as 561), which indicates to the transmit process 569 that data is ready for transmission. Once the transmit process 569 receives the data ready signal 561 from the several sources 559, a get data signal (563a . . . 563n, hereinafter collectively referred to as 563) is sent to the several sources 559. Upon receiving the get data signal 563 from the transmit process 569, the several sources 559 send their respective data bytes (567a . . . 567n, hereinafter collectively referred to as 567) to the transmit process, which orders and fragments the data streams according to a predefined priority sorting mechanism. In a preferred embodiment of the invention, the predefined priority sorting mechanism is a stacking algorithm configured to arrange the data in a hierarchical order according to data priority and transmit the data on a first-in last out (FILO) basis. The processor 557 further comprises a transmit FIFO 571, which receives the sorted data from the transmit process 569 and sequentially sends the received data to the physical layer (or channel) through the twisted pair phone line 555.

FIG. 5D is a diagram showing the components of the ATU processor 587 associated with the reception of data in one embodiment of the suspend/resume-oriented system of the invention. After the data traverses the channel, it is received at the site of reception by the ATU-R 583. The ATU-R 583 is configured to receive the transmitted information from the channel through the twisted pair phone line 555. The received data is then processed by the processor 587 at the ATU-R 583, which is configured to receive the data and re-assemble any fragmented data streams (or frames) according to the predefined priority sorting mechanism by which the data streams were originally fragmented before transmission. The processor 587 comprises a receive FIFO 581, which is configured to receive the sequentially transmitted data and send it to the receive process 589. The receive process 589 receives the data from the receive FIFO 581 and re-assembles any fragmented frame according to the predefined priority sorting mechanism. Since a predefined priority sorting mechanism is employed to track and re-assemble the received data, there is no significant additional overhead created in the data itself. In the preferred embodiment, wherein the priority sorting mechanism is a stacking algorithm, the data streams are reconstructed on a FILO basis. Once the data streams have been reconstructed, that data (591a . . . 591n, hereinafter collectively referred to as 591) is sent by the receive process 589 to various sinks (593a . . . 593n, hereinafter collectively referred to as 593), which make the data available to a user at the reception site. As shown in the non-limiting example of FIGS. 5A through 5D, the transmit processor 557 and the receive processor 587 are configured to prioritize data using a predefined priority sorting mechanism and suspend lower priority data streams that are being transmitted in order to allow higher priority data streams to be transmitted ahead of the lower priority data streams. Since the priority sorting mechanism is used at the site of transmission and at the site of reception, all of the fragmentation and reconstruction of the data streams is done without the creation of significant additional overhead.

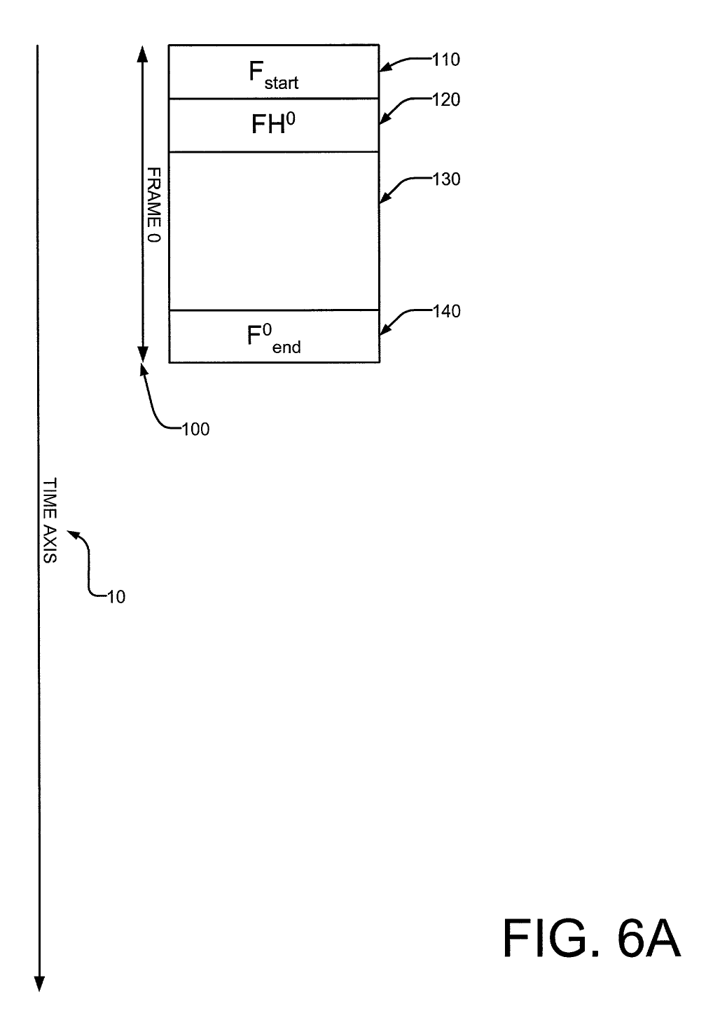

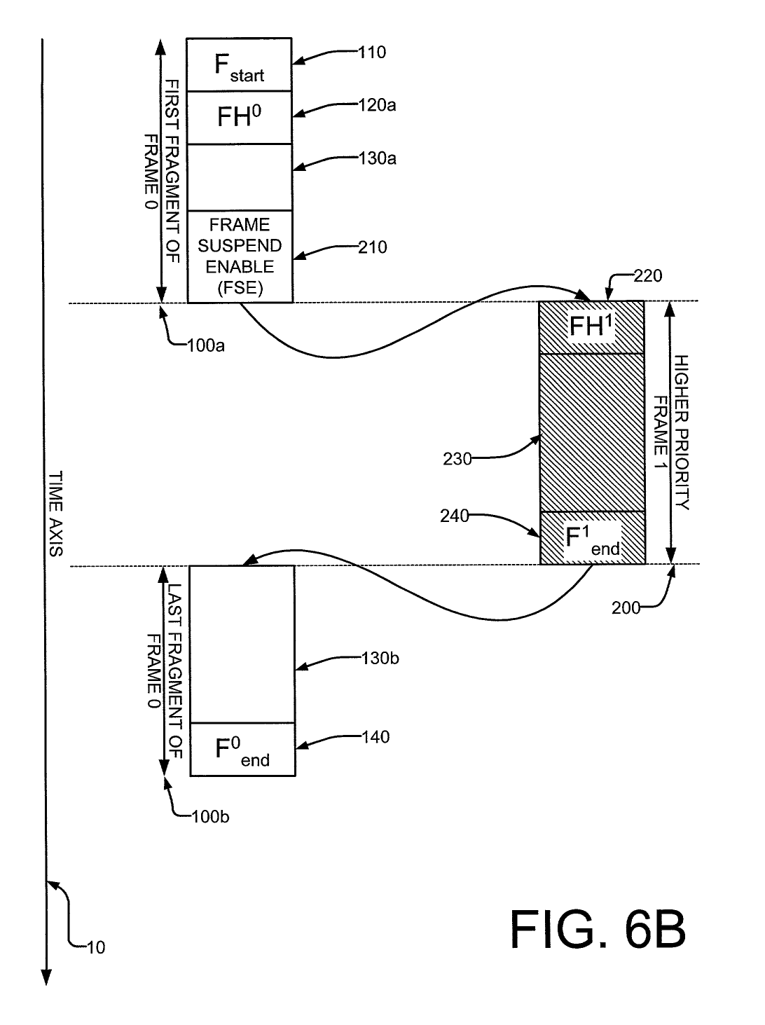

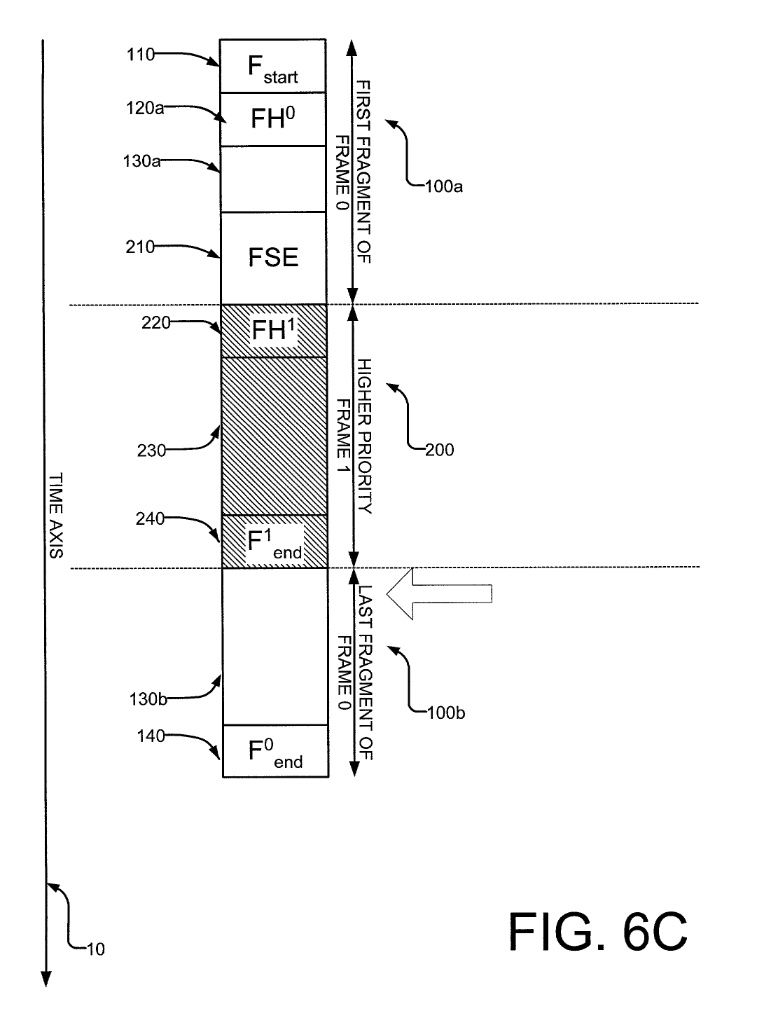

The following FIGS. 6A through 15B show various approaches that may be used to facilitate the suspend/resume-oriented system described in FIGS. 5A, 5B, 5C, and 5D. These non-limiting examples are provided for illustrative purposes only and are not intended to limit the scope of the invention.

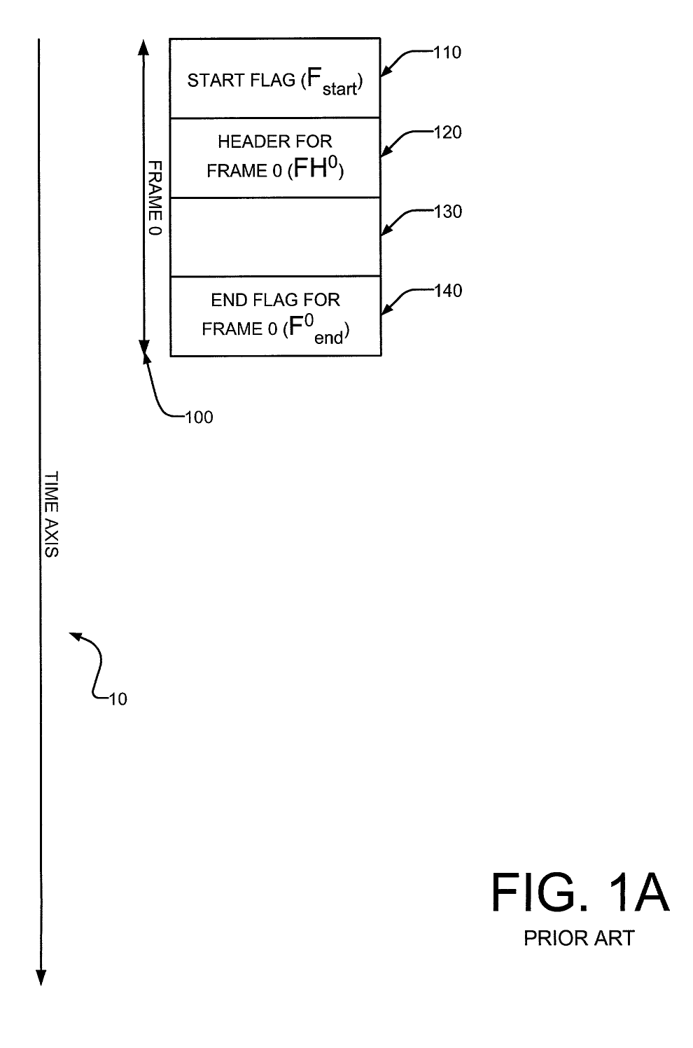

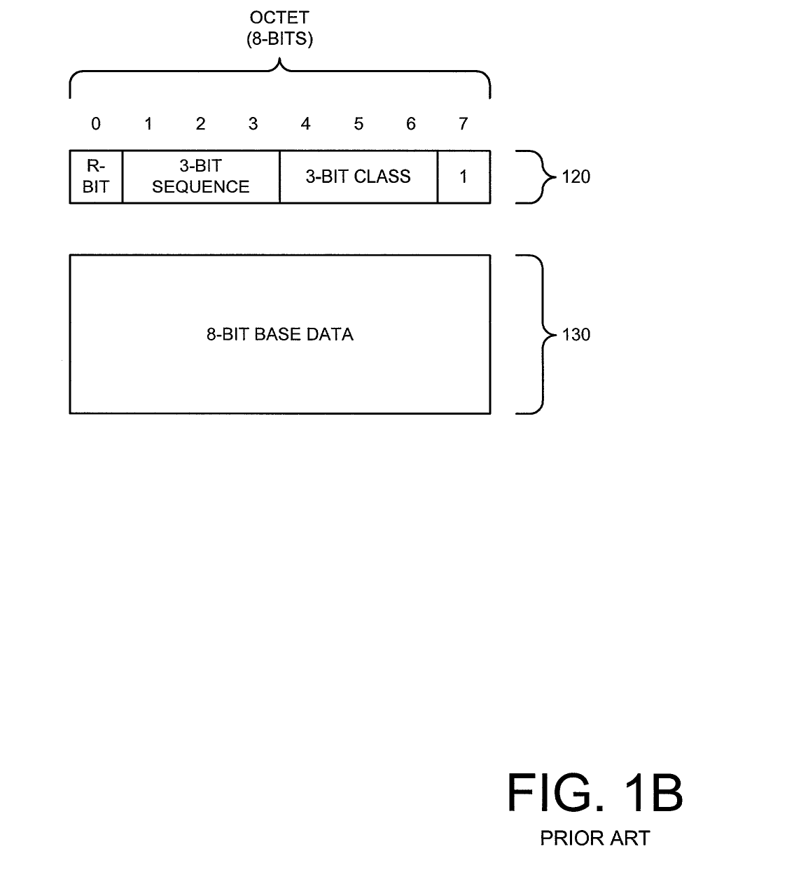

FIG. 6A is a diagram illustrating an embodiment of the invention, wherein a data stream 100 having a header 120 is transmitted without interruption. For illustrative purposes, the data stream is designated as frame-0 100. In this particular non-limiting example, where there is no interruption in the data stream 100, there is no structural difference between the data stream 100 here and the data stream of FIG. 1. This is because there is no interruption and, therefore, no creation of substantial additional overhead. Thus, the uninterrupted data stream 100 of FIG. 6A looks similar to the uninterrupted data stream 100 of FIG. 1A, beginning with a start flag 110, followed by a frame-0 header 120, then frame-0 data 130, and, finally, ending with a frame-0 end-flag 140.

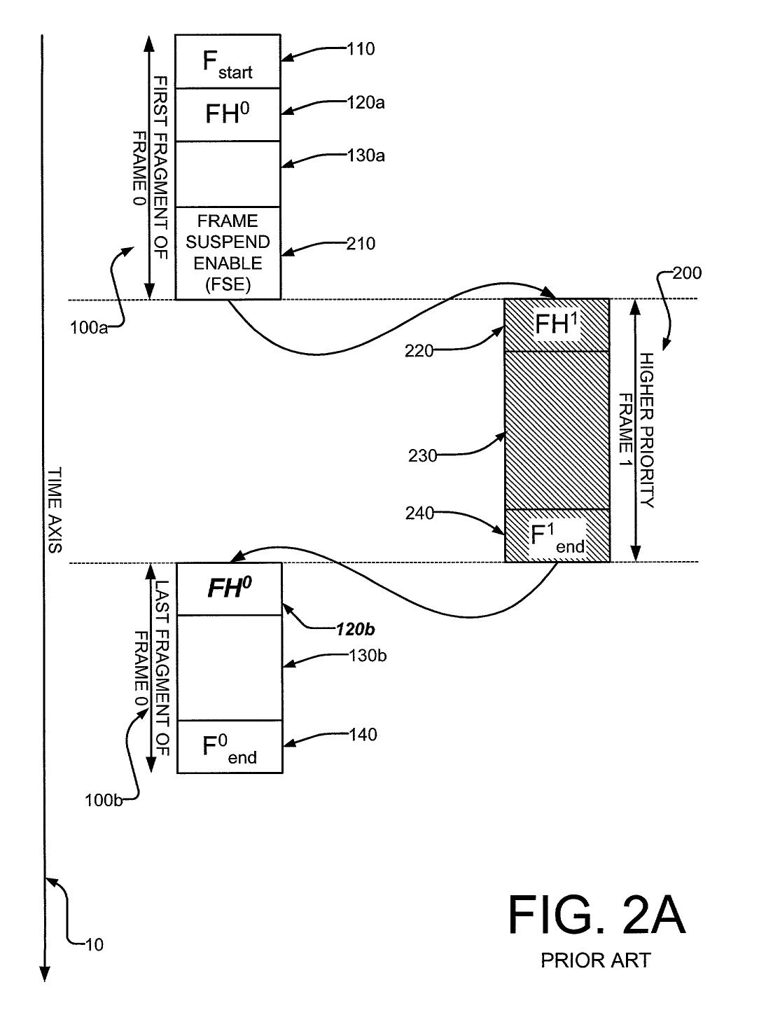

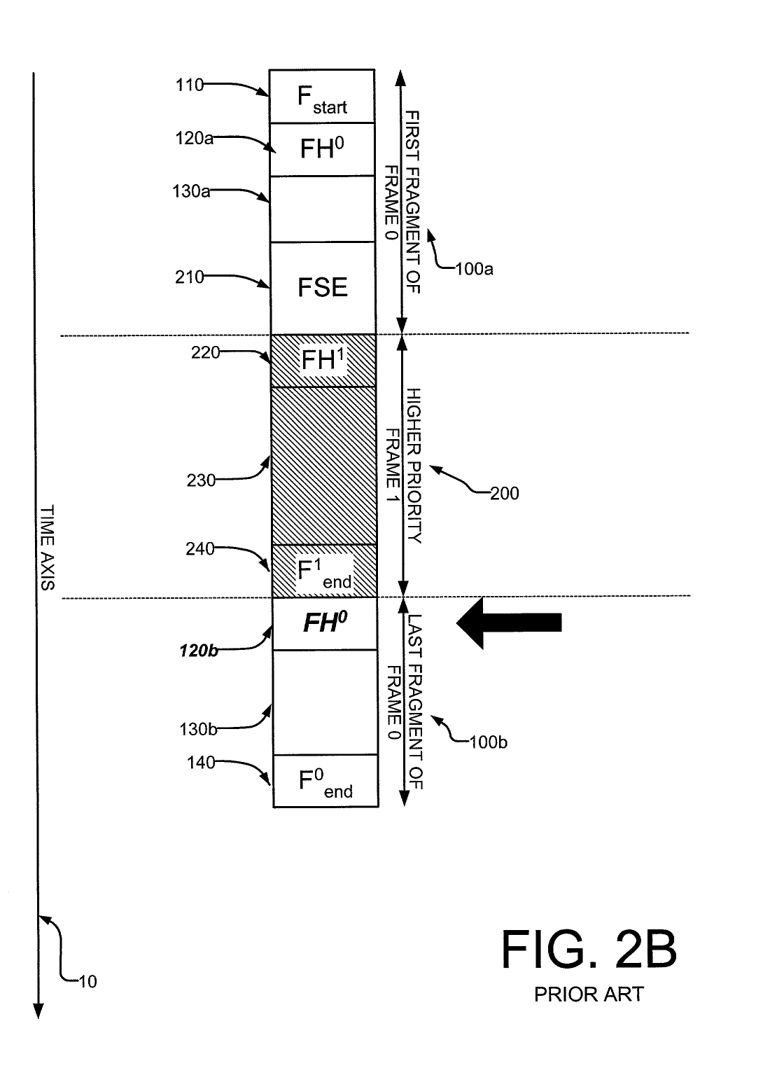

FIG. 6B is a diagram illustrating an embodiment of the invention, wherein a low-priority data stream (or frame) 100 is suspended by a high-priority data stream 200 without the creation of significant additional overhead. For illustrative purposes, the lower priority frame is designated as frame-0 100, and the higher priority data stream as frame-1 200. Unlike the approach of the prior art, since the fragmentation and reconstruction of the data stream 100 is governed by a priority sorting mechanism such as a strict stacking algorithm, the suspend/resume operation proceeds without the creation of significant additional overhead. As shown in FIG. 6B, data transmission begins with a start-flag 110 being inserted into the transmit FIFO 571 (FIG. 5C), which indicates to the system that data transmission is beginning. The transmit process 569 (FIG. 5C) then sends a frame-0 header 120a to the transmit FIFO 571 (FIG. 5C), which indicates to the system that frame-0 data 130a will follow. After the frame-0 header 120a, the transmit process 569 (FIG. 5C) transmits frame-0 data 130a to the transmit FIFO (FIG. 5C) for transmission to the physical layer (or channel) via the twisted pair phone line 555 (FIG. 5C). When the transmit process 569 (FIG. 5C) receives a second data stream (e.g., frame-1 200) it performs a priority analysis to determine whether frame-1 200 has priority over frame-0 100, which is currently being transmitted. If, as in the non-limiting example of FIG. 6B, frame-1 200 has a higher priority than frame-0 100, the transmit process 569 (FIG. 5C) suspends transmission of frame-0 100 and inserts a frame suspend enable (FSE) flag 210 into the transmit FIFO 571 (FIG. 5C), which indicates the suspended transmission of the lower priority frame-0 100. Upon suspension of frame-0 100, the higher priority frame-1 200 is transmitted. This is done by the transmit process 569 (FIG. 5C), which sends a frame-1 header 220 to the transmit FIFO 571 (FIG. 5C) followed by frame-1 data 230. Once the frame-1 data 230 has been transmitted in its entirety, the transmit process 569 (FIG. 5C) sends a frame-1 end-flag 240 to the transmit FIFO 571 (FIG. 5C) to indicate the end of frame-1 200 transmission. Having completed the transmission of higher priority frame-1 200, the transmit process 569 (FIG. 5C) fluidly resumes transmission of frame-0 data 130b by sending the remaining frame-0-data 130b to the transmit FIFO 571 (FIG. 5C) for transmission through the channel. Once all of frame-0 data 130b has been transmitted, the transmit process 569 (FIG. 5C) inserts a frame-0 end-flag 140 into the transmit FIFO 571 (FIG. 5C) to indicate the end of frame-0 100 transmission. Since data stream hierarchy is determined at the transmit process 569 (FIG. 5C) by a predefined priority sorting mechanism prior to transmission, reconstruction of the received frame fragments by the receive process 589 (FIG. 5D) may now be accomplished by employing the predefined priority sorting mechanism to re-establish the original data stream hierarchy. As shown in FIG. 6C, the priority sorting mechanism (e.g., a strict stacking algorithm) allows transmission of data without the creation of significant additional overhead. This is shown with a white arrow, which highlights the absence of the additional header that had existed in the prior art approach (FIGS. 2A and 2B).

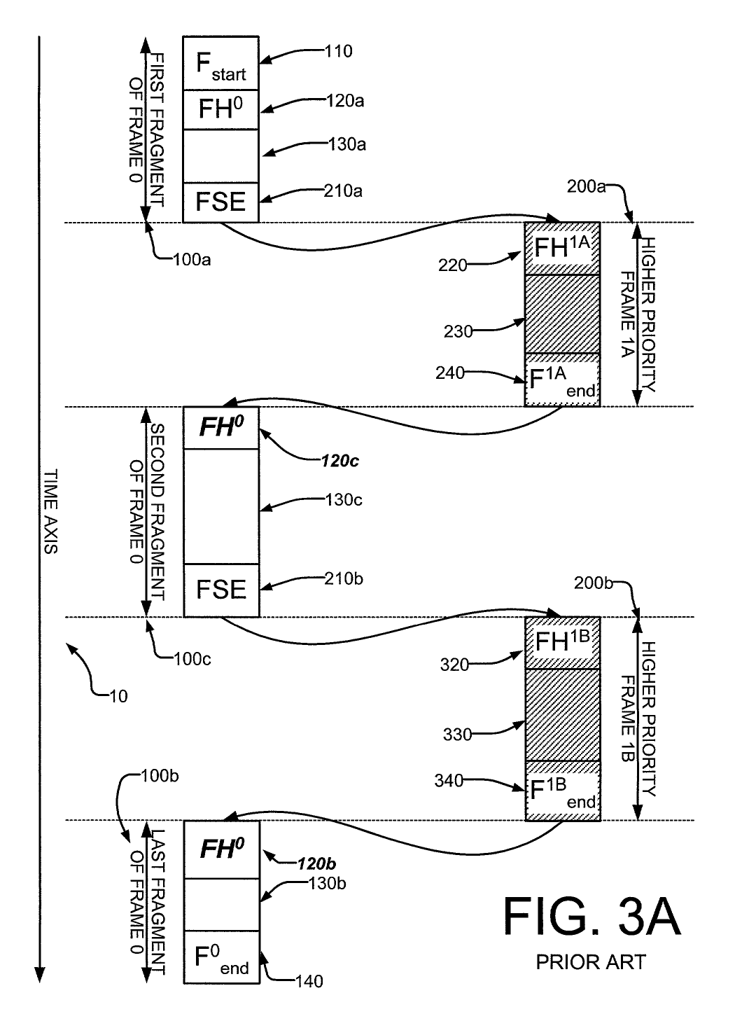

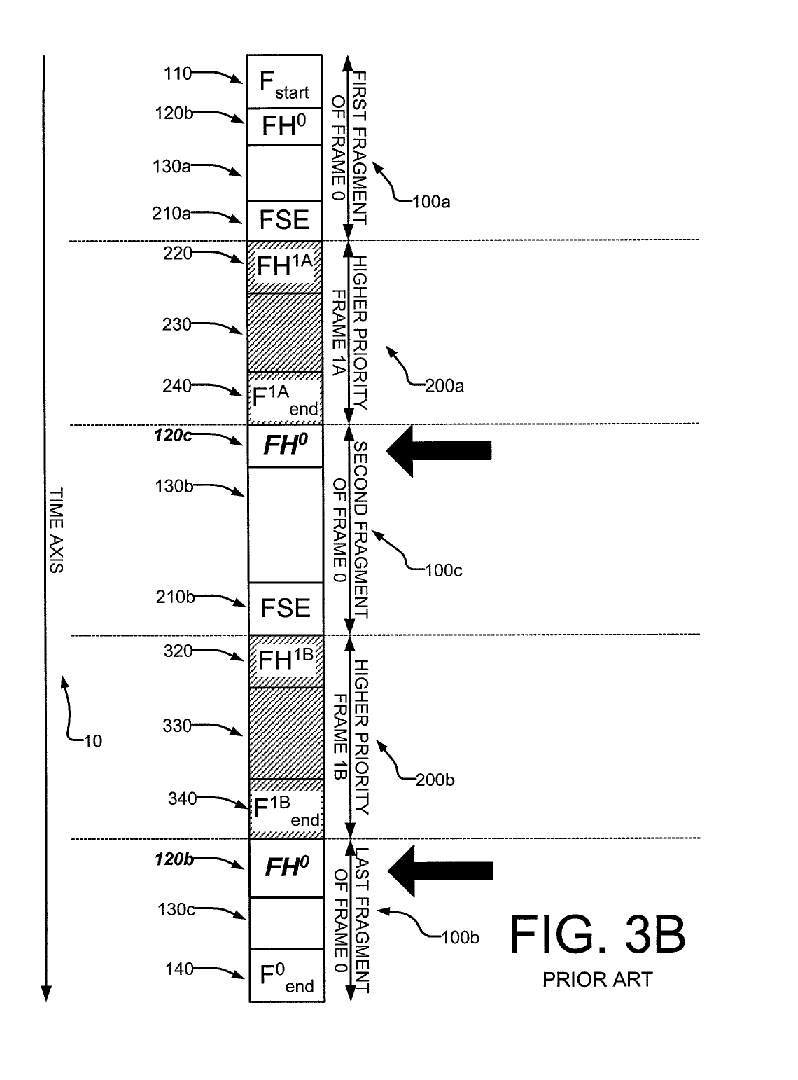

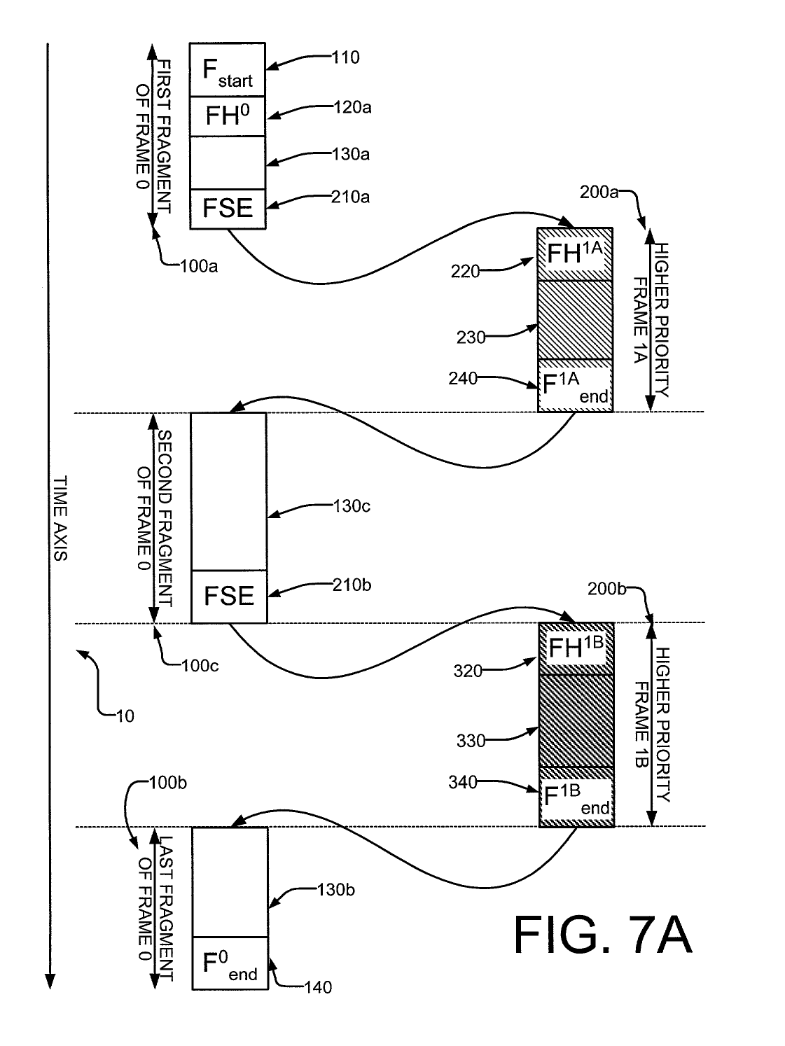

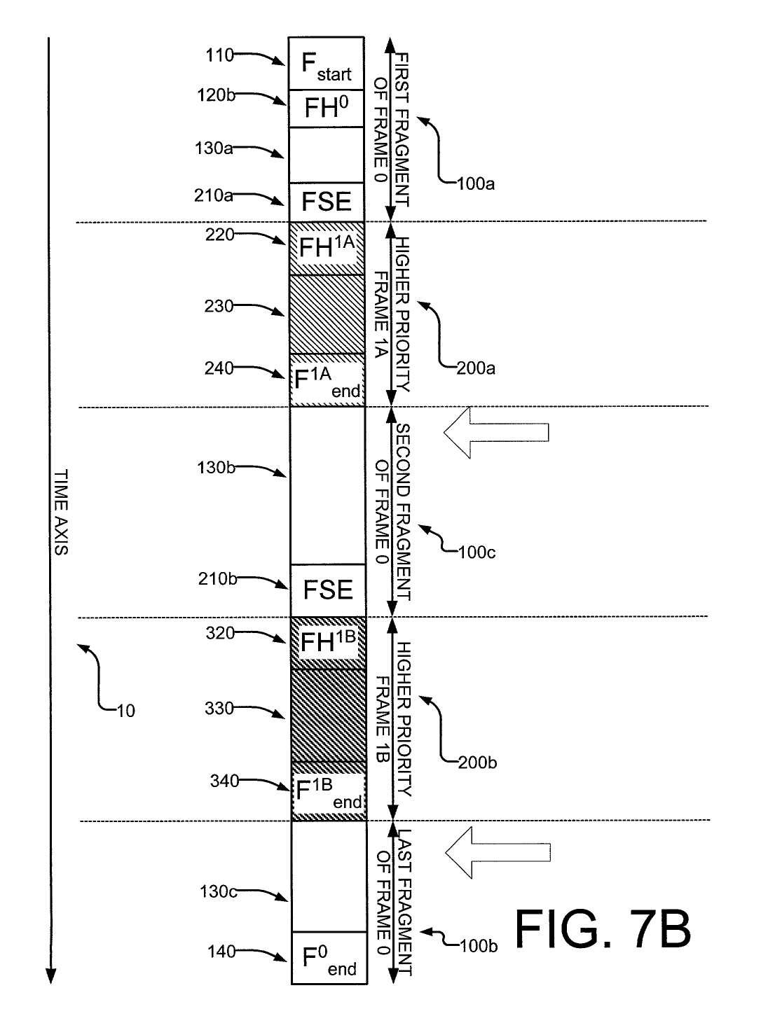

FIG. 7A is a diagram illustrating an embodiment of the invention, wherein a low-priority data stream 100 is suspended by two higher-priority data streams 200a, 200b without the creation of significant additional overhead. For illustrative purposes, the lower priority frame is designated as frame-0 100, and the higher priority data streams as frame-1A 200a and frame-1B 200b, respectively. Unlike the approach of the prior art, since the fragmentation and reconstruction of the data stream 100 is governed by a priority sorting mechanism, the suspend/resume operation again proceeds without the creation of significant additional overhead. As shown in FIG. 7A, data transmission begins with a start-flag 110 being inserted into the transmit FIFO 571 (FIG. 5C), which indicates to the system that data transmission is beginning. The transmit process 569 (FIG. 5C) then sends a frame-0 header 120a to the transmit FIFO 571 (FIG. 5C), which indicates to the system that frame-0 data 130a will follow. After the frame-0 header 120a, the transmit process 569 (FIG. 5C) transmits frame-0 data 130a to the transmit FIFO (FIG. 5C) for transmission to the channel via the twisted pair phone line 555 (FIG. 5C). When the transmit process 569 (FIG. 5C) receives a second data stream (e.g., frame-1A 200a) it performs a priority analysis to determine whether frame-1A 200a has priority over frame-0 100, which is currently being transmitted. If, as in the non-limiting example of FIG. 7A, frame-1A 200a has a higher priority than frame-0 100, the transmit process 569 (FIG. 5C) suspends transmission of frame-0 100 and inserts a frame suspend enable (FSE) flag 210a into the transmit FIFO 571 (FIG. 5C), which indicates the suspended transmission of the lower priority frame-0 100. Upon suspension of frame-0 100, higher priority frame-1A 200a is transmitted. This is done by the transmit process 569 (FIG. 5C), which sends a frame-1A header 220 to the transmit FIFO 571 (FIG. 5C) followed by frame-1A data 230. Once the frame-1A data 230 has been transmitted in its entirety, the transmit process 569 (FIG. 5C) sends a frame-1A end-flag 240 to the transmit FIFO 571 (FIG. 5C) to indicate the end of frame-1A 200a transmission. Having completed the transmission of higher priority frame-1A 200a, the transmit process 569 (FIG. 5C) fluidly resumes transmission of frame-0 data 130c by sending frame-0-data 130c to the transmit FIFO 571 (FIG. 5C) for transmission through the channel. When the transmit process 569 (FIG. 5C) receives yet another data stream (e.g., frame-1B 200b) it performs a priority analysis to determine whether frame-1B 200b has priority over frame-0 100, which is currently being transmitted. If, as in the non-limiting example of FIG. 7A, frame-1B 200b has a higher priority than frame-0 100, the transmit process 569 (FIG. 5C) once again suspends transmission of frame-0 100c and inserts another frame suspend enable (FSE) flag 210b into the transmit FIFO 571 (FIG. 5C), which indicates the second suspension of lower priority frame-0 100. Upon suspension of frame-0 100, higher priority frame-1B 200b is transmitted. This is done by the transmit process 569 (FIG. 5C), which sends a frame-1B header 320 to the transmit FIFO 571 (FIG. 5C) followed by frame-1B data 330. Once the frame-1B data 330 has been transmitted in its entirety, the transmit process 569 (FIG. 5C) sends a frame-1B end-flag 340 to the transmit FIFO 571 (FIG. 5C) to indicate the end of frame-1B 200b transmission. Having completed the transmission of higher priority frame-1B 200b, the transmit process 569 (FIG. 5C) fluidly resumes transmission of frame-0 data 130b by sending frame-0-data 130b to the transmit FIFO 571 (FIG. 5C) for transmission through the channel. Once all of frame-0 data 130b has been transmitted, the transmit process 569 (FIG. 5C) inserts a frame-0 end-flag 140 into the transmit FIFO 571 (FIG. 5C) to indicate the end of frame-0 100 transmission. Since data stream hierarchy is determined at the transmit process 569 (FIG. 5C) by a predefined priority sorting mechanism prior to transmission, reconstruction of the received frame fragments by the receive process 589 (FIG. 5D) may again be accomplished by employing the predefined priority sorting mechanism to re-establish the original data stream hierarchy. As shown in FIG. 7B, the priority sorting mechanism allows transmission of data without the creation of significant additional overhead. This is shown with white arrows, which highlight the absence of additional headers that had existed in the prior art approach (FIGS. 3A and 3B).

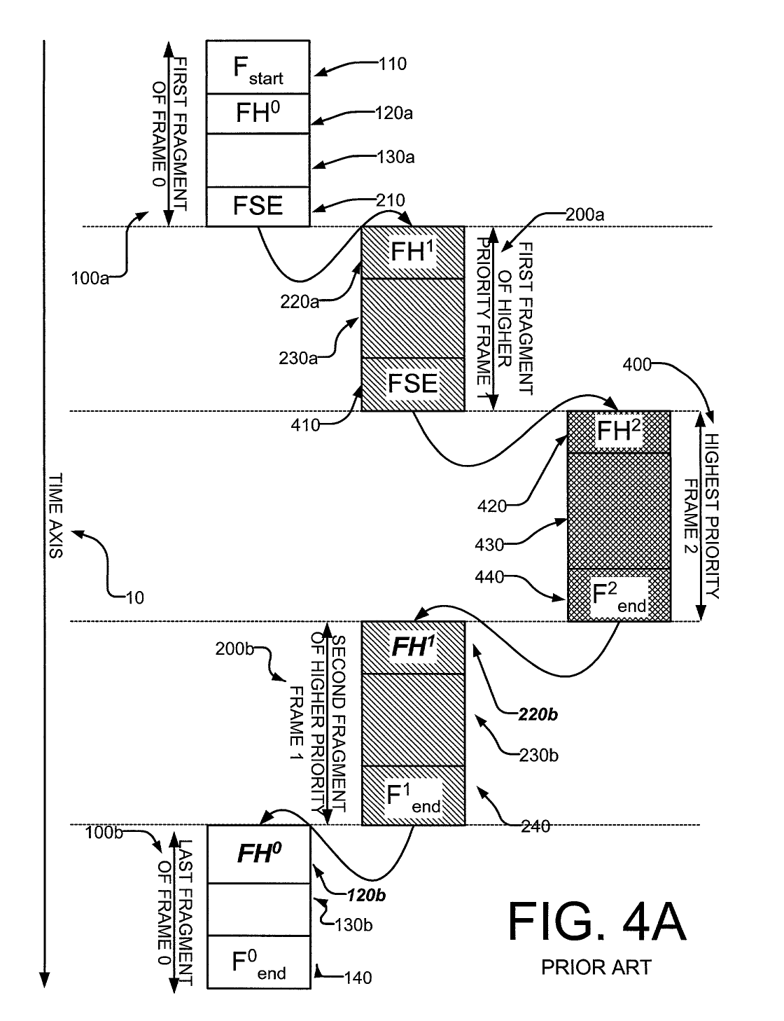

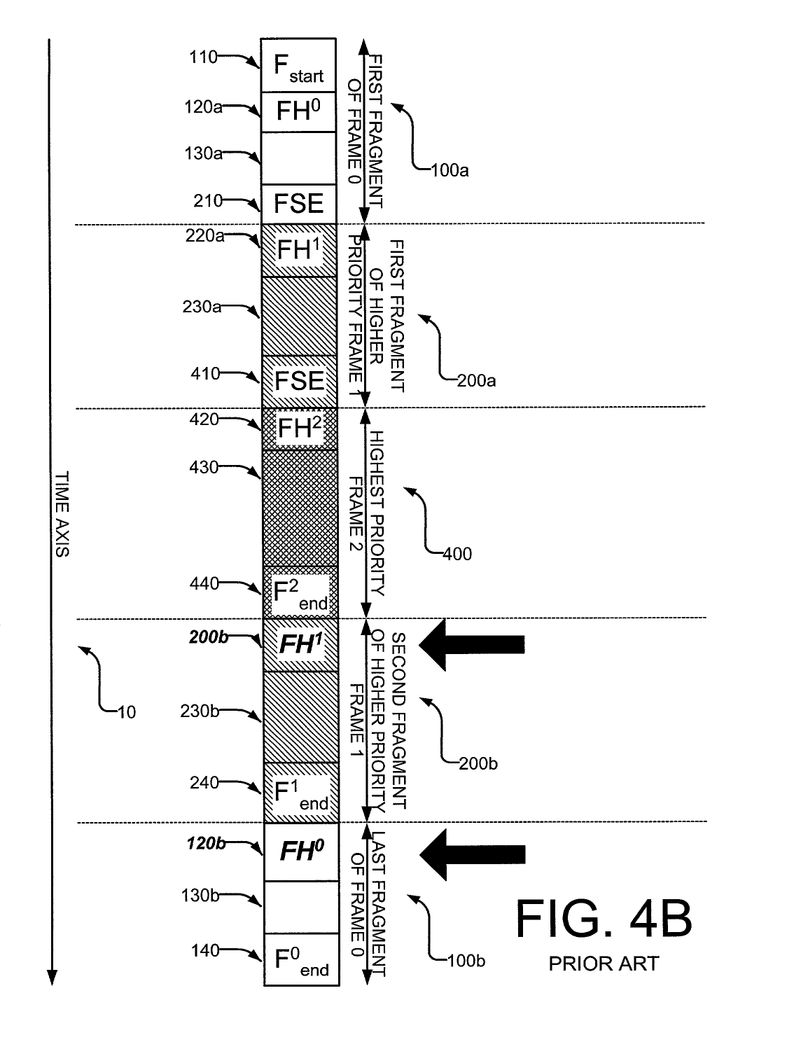

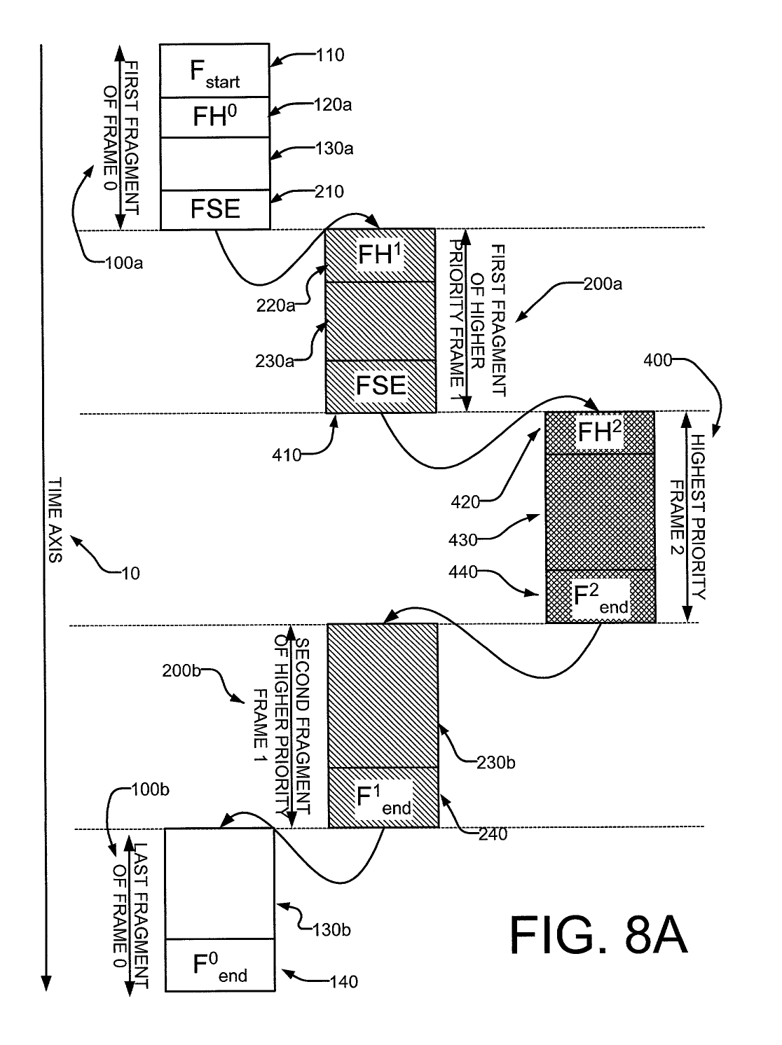

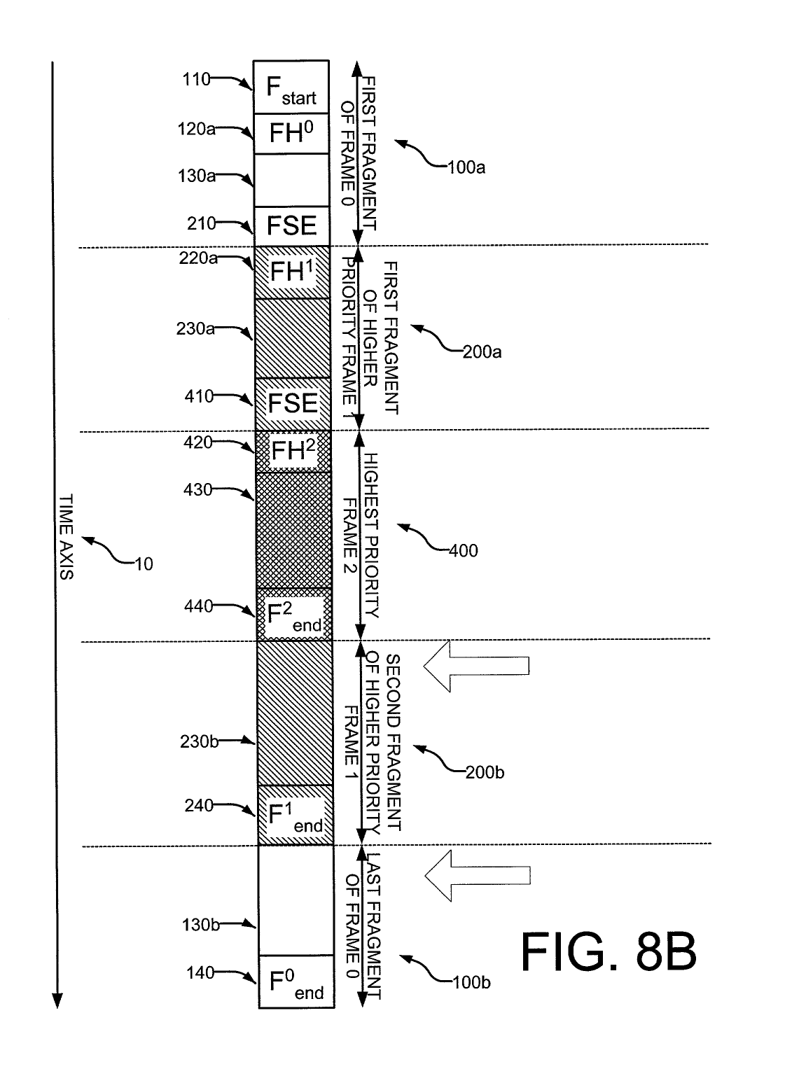

FIG. 5A is a diagram illustrating an embodiment of the invention, wherein a low-priority data stream 100 is suspended by a mid-priority data stream 200 without significant additional overhead, and the mid-priority data stream 200 is suspended by a high-priority data stream 400 without the creation of significant additional overhead. For illustrative purposes, the low-priority frame is designated as frame-0 100, the mid-priority data stream as frame-1 200, and the high-priority data stream as frame-2 400, respectively. Unlike the approach of the prior art, since the fragmentation and reconstruction of the data streams 100, 200 are governed by a priority sorting mechanism, the suspend/resume operation again proceeds without the creation of significant additional overhead. As shown in FIG. 8A, data transmission begins with a start-flag 110 being inserted into the transmit FIFO 571 (FIG. 5C), which indicates to the system that data transmission is beginning. The transmit process 569 (FIG. 5C) then sends a frame-0 header 120a to the transmit FIFO 571 (FIG. 5C), which indicates to the system that frame-0 data 130a will follow. After the frame-0 header 120a, the transmit process 569 (FIG. 5C) transmits frame-0 data 130a to the transmit FIFO (FIG. 5C) for transmission to the channel via the twisted pair phone line 555 (FIG. 5C). When the transmit process 569 (FIG. 5C) receives a second data stream (e.g., frame-1 200) it performs a priority analysis to determine whether frame-1 200 has priority over frame-0 100, which is currently being transmitted. If, as in the non-limiting example of FIG. 8A, frame-1 200 has a higher priority than frame-0 100, the transmit process 569 (FIG. 5C) suspends transmission of frame-0 100 and inserts a frame suspend enable (FSE) flag 210a into the transmit FIFO 571 (FIG. 5C), which indicates the suspended transmission of the lower priority frame-0 100. Upon suspension of frame-0 100, the higher priority frame-1 200 is transmitted. This is done by the transmit process 569 (FIG. 5C), which sends a frame-1 header 220 to the transmit FIFO 571 (FIG. 5C) followed by frame-1 data 230. If the transmit process 569 (FIG. 5C) receives a third data stream (e.g., frame-2 400) it performs a priority analysis to determine whether frame-2 400 has priority over frame-1 200, which is currently being transmitted. If, as in the non-limiting example of FIG. 8A, high-priority frame-2 400 has a higher priority than mid-priority frame-1 200, the transmit process 569 (FIG. 5C) suspends transmission of frame-1 200 and inserts another FSE flag 410 into the transmit FIFO 571 (FIG. 5C), which indicates the suspended transmission of mid-priority frame-1 200. Upon suspension of mid-priority frame-1 200, the high-priority frame-2 400 is transmitted. This is done by the transmit process 569 (FIG. 5C), which sends a frame-2 header 420 to the transmit FIFO 571 (FIG. 5C) followed by frame-2 data 430. Once the frame-2 data 430 has been transmitted in its entirety, the transmit process 569 (FIG. 5C) sends a frame-2 end-flag 440 to the transmit FIFO 571 (FIG. 5C) to indicate the end of frame-2 400 transmission. Having completed the transmission of high-priority frame-2 400, the transmit process 569 (FIG. 5C) fluidly resumes transmission of mid-priority frame-1 data 230 by sending frame-1 data 230 to the transmit FIFO 571 (FIG. 5C) for transmission through the channel. Once all of frame-1 data 230 has been transmitted, the transmit process 569 (FIG. 5C) inserts a frame-1 end-flag 240 into the transmit FIFO 571 (FIG. 5C) to indicate the end of frame-1 200 transmission. After completion of mid-priority frame-1 200 transmission, the transmit process 569 (FIG. 5C) fluidly resumes transmission of low-priority frame-0 data 130b by sending frame-0-data 130b to the transmit FIFO 571 (FIG. 5C) for transmission through the channel. Once all of frame-0 data 130b has been transmitted, the transmit process 569 (FIG. 5C) inserts a frame-0 end-flag 140 into the transmit FIFO 571 (FIG. 5C) to indicate the end of frame-0 100 transmission. Since data stream hierarchy here is once again determined at the transmit process 569 (FIG. 5C) by a predefined priority sorting mechanism prior to transmission, reconstruction of the received frame fragments by the receive process 589 (FIG. 5D) may again be accomplished by employing the predefined priority sorting mechanism to re-establish the original data stream hierarchy. As shown in FIG. 8B, the priority sorting mechanism allows transmission of data without the creation of significant additional overhead. This is shown with white arrows, which highlight the absence of the additional headers that had existed in the prior art approach (FIGS. 4A and 4B).

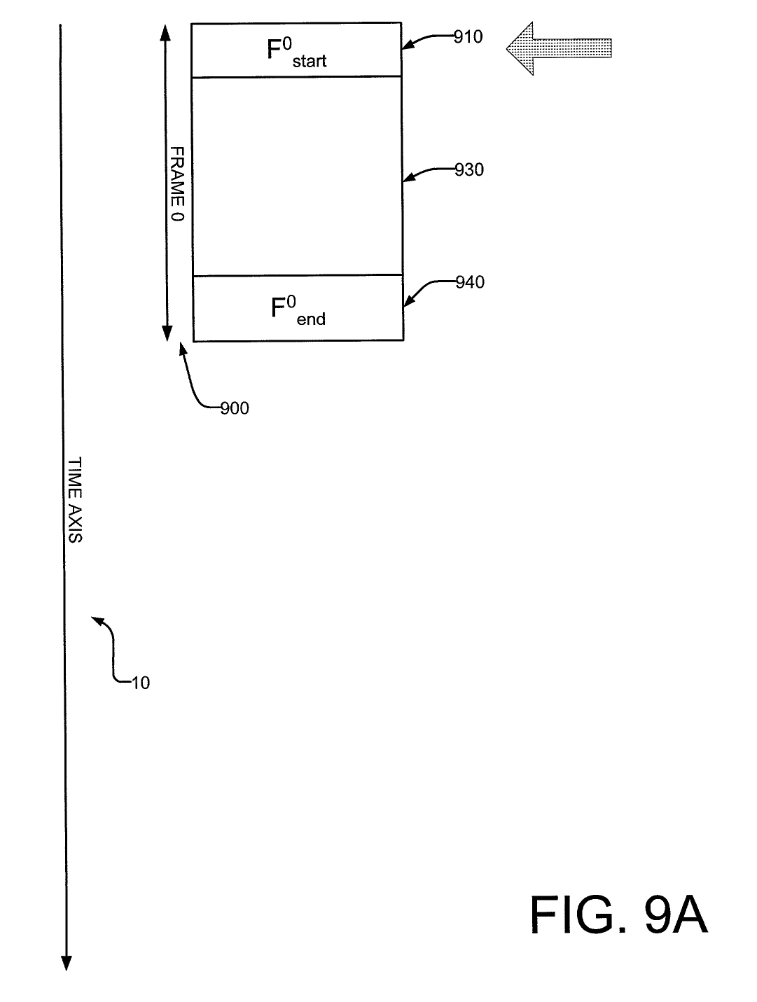

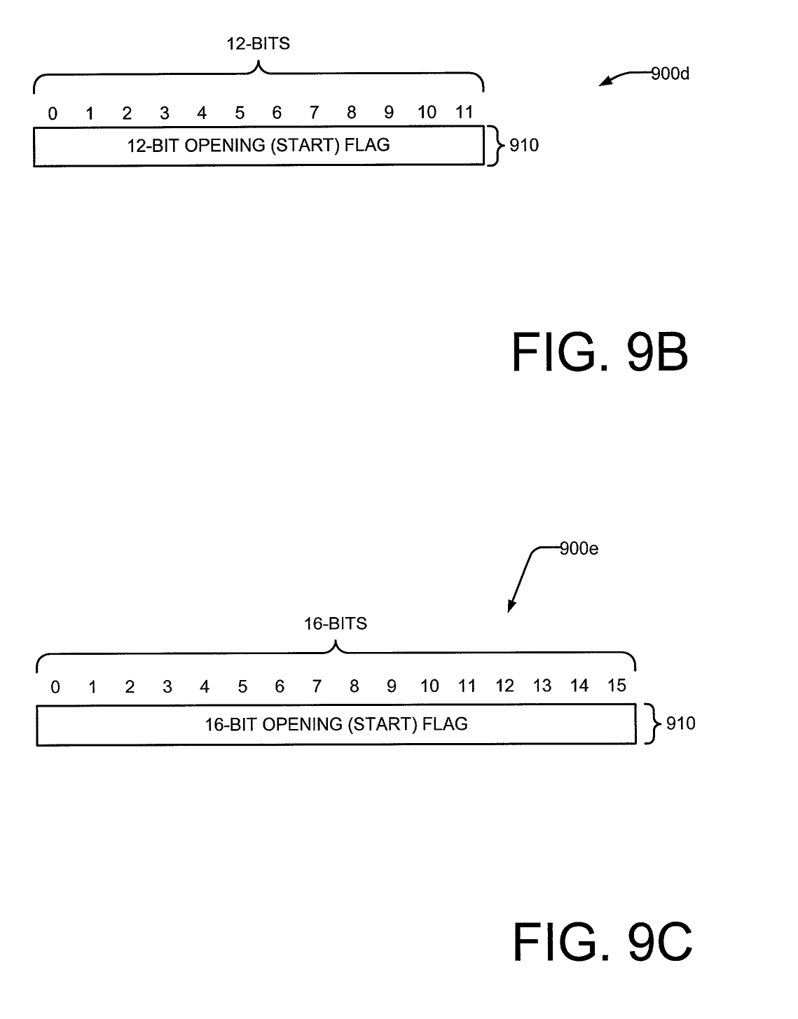

FIG. 9A is a diagram illustrating an embodiment of the invention, wherein a data stream 900 containing no header (hereinafter referred to as header-less data stream or header-less frame) is transmitted without interruption. Here, the priority information that was previously conveyed in the header of the data stream is now contained in a special start flag 910, which is unique to different priority data streams. For illustrative purposes, the data stream is designated as frame-0 900. The use of header-less frames provides for additional efficiencies because there is less overhead with the removal of headers. The transmission of an uninterrupted header-less frame-0 900 begins with a frame-0 start-flag 910, which serves at least a two-fold purpose: (1) notifying the system that data transmission is beginning, and (2) identifying the transmitted data 930 as belonging to frame-0 900. After the frame-0 start-flag 910, frame-0 data 930 is transmitted, followed by a frame-0 end-flag 940, which indicates the end of the data stream.

FIGS. 9B and 9C are diagrams illustrating a 12-bit and a 16-bit base, respectively, which may be used with the transmission of header-less frames. These higher-bit bases allow for more efficient transmission of information because of transparency issues related to the transmission of special characters, such as escape characters (ESC), etc. Transparency issues tend to pose problems due to the fact that additional overhead is created for every special character being transmitted. In other words, it is axiomatic that, as the number of special characters increases, there arises is a concomitant increase in the probability of encountering these special characters during transmission of a data stream. One way to reduce the probability of encountering special characters is by reducing the number of special characters. However, this approach is wanting because it limits the functionality of the data transmission system (i.e., fewer special characters lead to fewer functions). Another way to reduce the probability of encountering special characters is by increasing the size of the character set, and thereby decreasing the fraction of special characters in that character set. In other words, increasing the character set produces a corresponding reduction in the probability of encountering a special character. This increase in character set size may be accomplished by using a larger base for transmitting the special flags, such as a 12-bit or 16-bit base (i.e., a 12-bit base provides a larger set of characters than an 8-bit base, and a 16-bit base provides an even larger set than a 12-bit base). It is worthwhile to note that the size of the flag need not be identical to the size of the data (e.g., the data may be transmitted using an octet base while the flag uses a 12-bit base). Since header-less frames use special flags to indicate the opening, the closing, the suspension, and the continuation of data streams, additional special characters are generally required to accommodate these additional flags, thereby increasing overhead and concomitantly decreasing efficiency. This may be circumvented to some extent by using 12-bit or 16-bit bases as shown in FIGS. 9B and 9C, rather than the standard 8-bit base (or octet), as shown in FIG. 1B. Also, while 12-bit and 16-bits may provide more convenient software implementations, in a general sense, any n-bit base may be used where n may be optimized to maximize the efficiency based on the expected distribution of frame lengths and the number of special characters. In other words, given a finite number of special characters and an expected distribution of frame lengths, there exists an optimal n that maximizes efficiency. This n may be 12, or 16, or any integer.

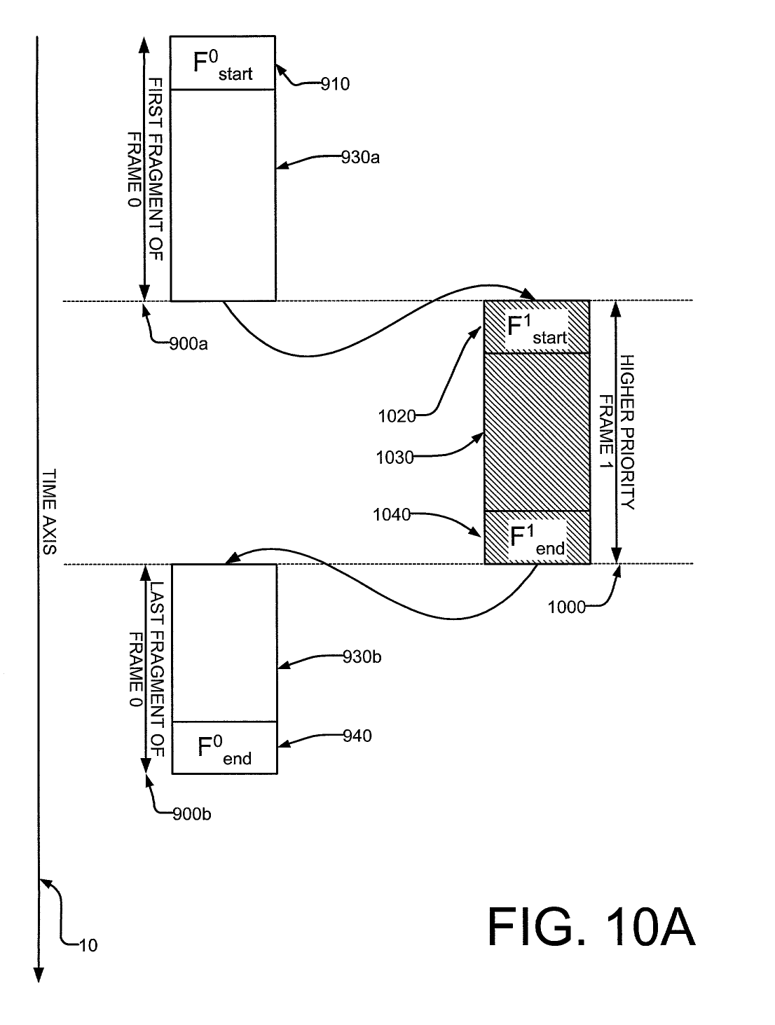

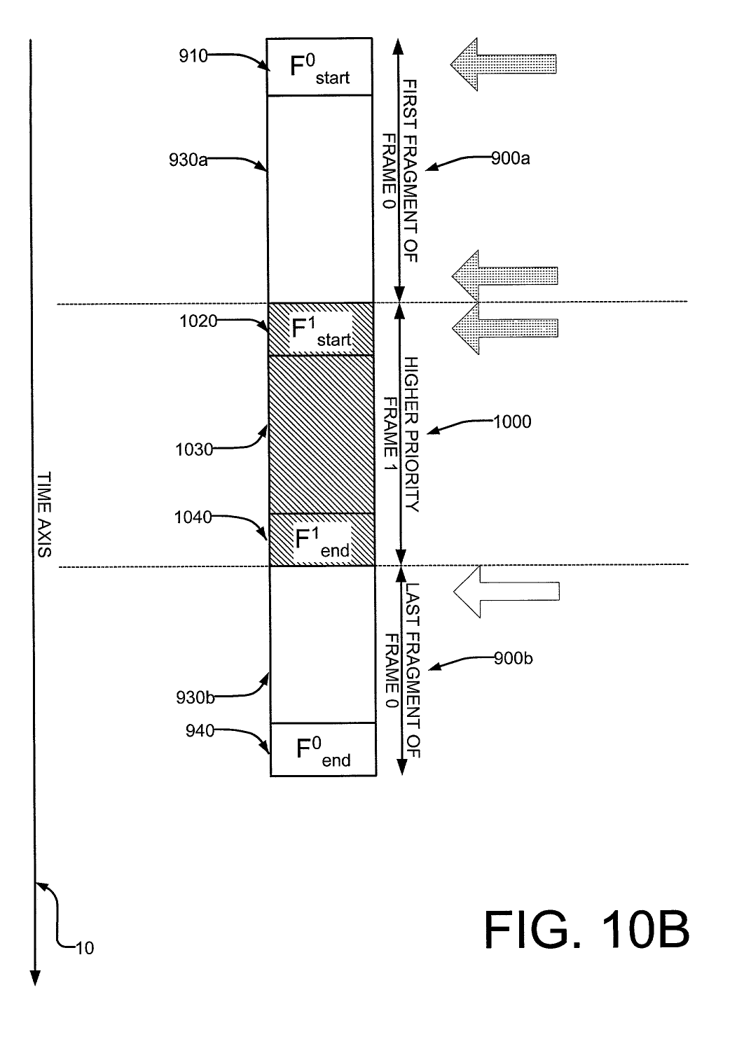

FIG. 10A is a diagram illustrating an embodiment of the invention, wherein a low-priority header-less data stream (or header-less frame) 900 is suspended by a high-priority header-less data stream 1000 without the creation of significant additional overhead. For illustrative purposes, the lower priority header-less frame is designated as header-less frame-0 900, and the higher priority header-less data stream as header-less frame-1 1000. Unlike the approach of the prior art, since the fragmentation and reconstruction of the header-less data stream 900 is governed by a priority sorting mechanism such as a strict stacking algorithm, the suspend/resume operation proceeds without the creation of significant additional overhead. Additionally, since this non-limiting example shows special start flags configured to perform at least a two-fold function: (1) replace the FSE flag of FIGS. 6B-8B, and (2) identify the data stream and demarcate the beginning of the frame. As shown in FIG. 10A, data transmission begins with a frame-0 start-flag 910 being inserted into the transmit FIFO 571 (FIG. 5C), which indicates to the system that frame-0 data 930a transmission is beginning. The transmit process 569 (FIG. 5C) then sends header-less frame-0 data 930a to the transmit FIFO (FIG. 5C) for transmission to the physical layer (or channel) via the twisted pair phone line 555 (FIG. 5C). When the transmit process 569 (FIG. 5C) receives a second header-less data stream (e.g., header-less frame-1 1000) it performs a priority analysis to determine whether header-less frame-1 1000 has priority over header-less frame-0 900, which is currently being transmitted. If, as in the non-limiting example of FIG. 10A, header-less frame-1 1000 has a higher priority than header-less frame-0 900, the lower priority header-less frame-0 900 is suspended and the higher priority header-less frame-1 1000 is transmitted ahead of the remaining portions of the lower priority header-less frame-0 900. This is done by the transmit process 569 (FIG. 5C), which sends a header-less frame-1 start-flag 1020 to the transmit FIFO 571 (FIG. 5C) followed by the header-less frame-1 data 1030. Once the header-less frame-1 data 1030 has been transmitted in its entirety, the transmit process 569 (FIG. 5C) sends a header-less frame-1 end-flag 1040 to the transmit FIFO 571 (FIG. 5C) to indicate the end of header-less frame-1 1000 transmission. Having completed the transmission of higher priority header-less frame-1 1000, the transmit process 569 (FIG. 5C) fluidly resumes transmission of header-less frame-0 data 930b by sending the remaining header-less frame-0-data 930b to the transmit FIFO 571 (FIG. 5C) for transmission through the channel. Once all of header-less frame-0 data 930b has been transmitted, the transmit process 569 (FIG. 5C) inserts a header-less frame-0 end-flag 940 into the transmit FIFO 571 (FIG. 5C) to indicate the end of header-less frame-0 900 transmission. Since data stream hierarchy is determined at the transmit process 569 (FIG. 5C) by a predefined priority sorting mechanism prior to transmission, reconstruction of the received frame fragments by the receive process 589 (FIG. 5D) may now be accomplished by employing the predefined priority sorting mechanism to re-establish the original data stream hierarchy. As shown in FIG. 10, the header-less frames, in conjunction with the priority sorting mechanism (e.g., a strict stacking algorithm), further increases efficiency and allows for transmission of data without the creation of significant additional overhead. The absence of an additional header is shown with a white arrow, while the shaded arrows show the absence of FSE flags associated with the use of special frame start flags 910, 1020.

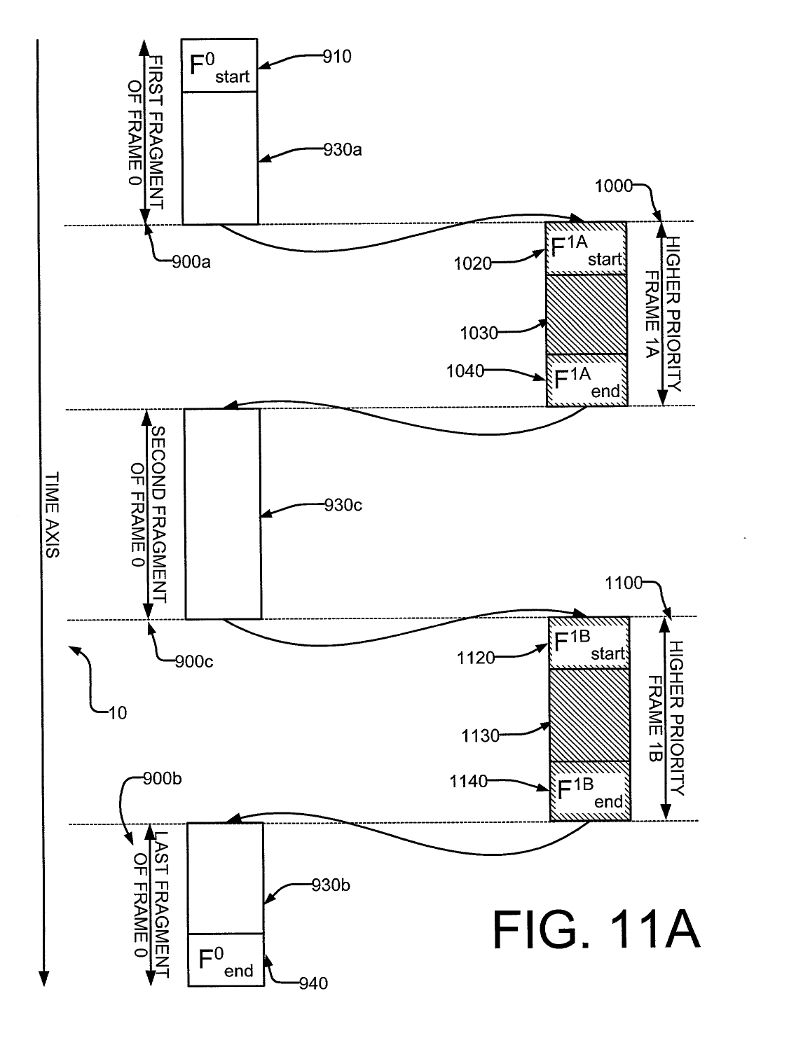

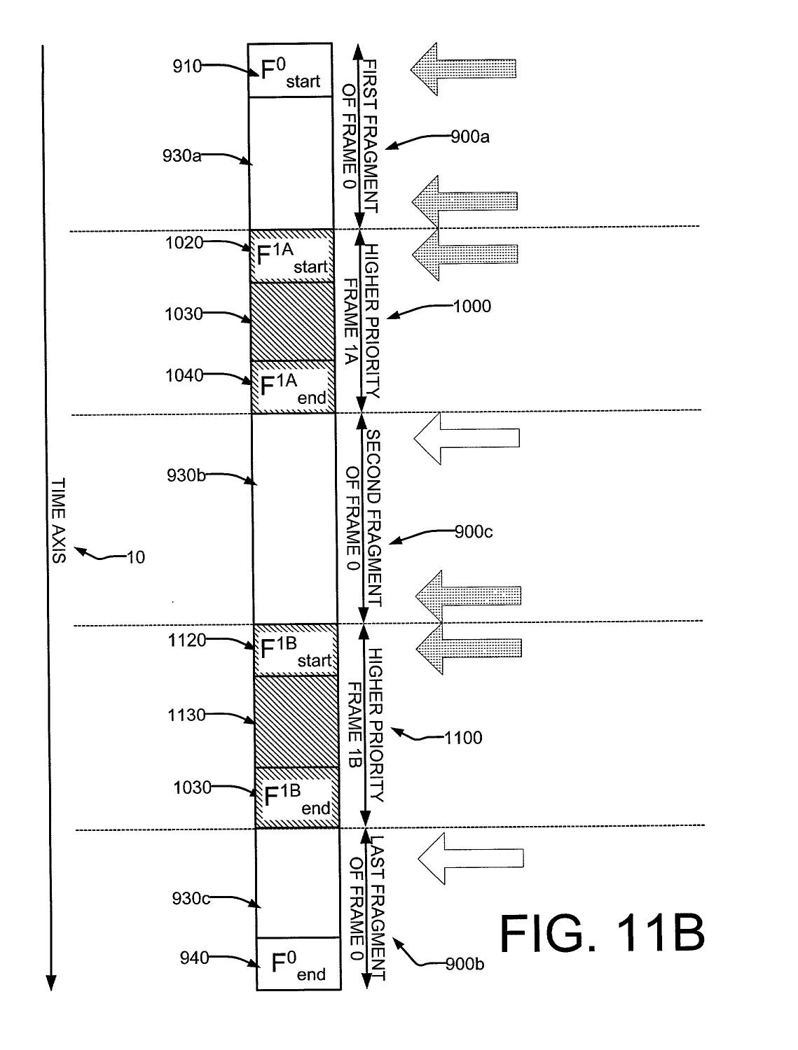

FIG. 11A is a diagram illustrating an embodiment of the invention, wherein a low-priority header-less data stream 900 is suspended by two higher-priority header-less data streams 1000a, 1100 without the creation of significant additional overhead. For illustrative purposes, the lower priority header-less frame is designated as header-less frame-0 900, and the higher priority header-less data streams as header-less frame-1A 1000a and header-less frame-1B 1100, respectively. Unlike the approach of the prior art, since the fragmentation and reconstruction of the header-less data stream 900 is governed by a priority sorting mechanism, the suspend/resume operation again proceeds without the creation of significant additional overhead. As shown in FIG. 11A, data transmission begins with a frame-0 start-flag 910 being inserted into the transmit FIFO 571 (FIG. 5C), which indicates to the system that frame-0 data 930a transmission is beginning. The transmit process 569 (FIG. 5C) then sends header-less frame-0 data 930a to the transmit FIFO (FIG. 5C) for transmission to the channel via the twisted pair phone line 555 (FIG. 5C). When the transmit process 569 (FIG. 5C) receives a second header-less data stream (e.g., header-less frame-1A 1000a) it performs a priority analysis to determine whether header-less frame-1A 1000a has priority over header-less frame-0 900, which is currently being transmitted. If, as in the non-limiting example of FIG. 11A, header-less frame-1A 1000a has a higher priority than header-less frame-0 900, the transmit process 569 (FIG. 5C) suspends transmission of header-less frame-0 900 and transmits the higher priority header-less frame-1A 1000a. This is done by the transmit process 569 (FIG. 5C), which sends a header-less frame-1A start flag 1020 to the transmit FIFO 571 (FIG. 5C) followed by header-less frame-1A data 1030. Once the header-less frame-1A data 1030 has been transmitted in its entirety, the transmit process 569 (FIG. 5C) sends a header-less frame-1A end-flag 1040 to the transmit FIFO 571 (FIG. 5C) to indicate the end of header-less frame-1A 1000a transmission. Having completed the transmission of higher priority header-less frame-1A 1000a, the transmit process 569 (FIG. 5C) fluidly resumes transmission of header-less frame-0 data 930c by sending header-less frame-0-data 930c to the transmit FIFO 571 (FIG. 5C) for transmission through the channel. When the transmit process 569 (FIG. 5C) receives yet another header-less data stream (e.g., header-less frame-1B 1100) it performs a priority analysis to determine whether header-less frame-1B 1100 has priority over header-less frame-0 900, which is currently being transmitted. If, as in the non-limiting example of FIG. 11A, header-less frame-1B 1100 has a higher priority than header-less frame-0 900, the transmit process 569 (FIG. 5C) once again suspends transmission of header-less frame-0 900c and transmits the higher priority header-less frame-1B 1100 through the channel. This is done by the transmit process 569 (FIG. 5C), which sends a header-less frame-1B start flag 1120 to the transmit FIFO 571 (FIG. 5C) followed by header-less frame-1B data 1130. Once the header-less frame-1B data 1130 has been transmitted in its entirety, the transmit process 569 (FIG. 5C) sends a header-less frame-1B end-flag 1140 to the transmit FIFO 571 (FIG. 5C) to indicate the end of header-less frame-1B 1100 transmission. Having completed the transmission of higher priority header-less frame-1B 1100, the transmit process 569 (FIG. 5C) fluidly resumes transmission of header-less frame-0 data 930b by sending header-less frame-0 data 930b to the transmit FIFO 571 (FIG. 5C) for transmission through the channel. Once all of header-less frame-0 data 930b has been transmitted, the transmit process 569 (FIG. 5C) inserts a header-less frame-0 end-flag 940 into the transmit FIFO 571 (FIG. 5C) to indicate the end of header-less frame-0 900 transmission. Since data stream hierarchy is determined at the transmit process 569 (FIG. 5C) by a predefined priority sorting mechanism prior to transmission, reconstruction of the received header-less frame fragments by the receive process 589 (FIG. 5D) may be accomplished by employing the predefined priority sorting mechanism to re-establish the original data stream hierarchy. As shown in FIG. 11B, the header-less frames, used in conjunction with the priority sorting mechanism, further increases efficiency and allows for transmission of data without the creation of significant additional overhead. Here, white arrows highlight the absence of the additional headers, while shaded arrows highlight the absence of FSE flags resulting from the use of special start flags.

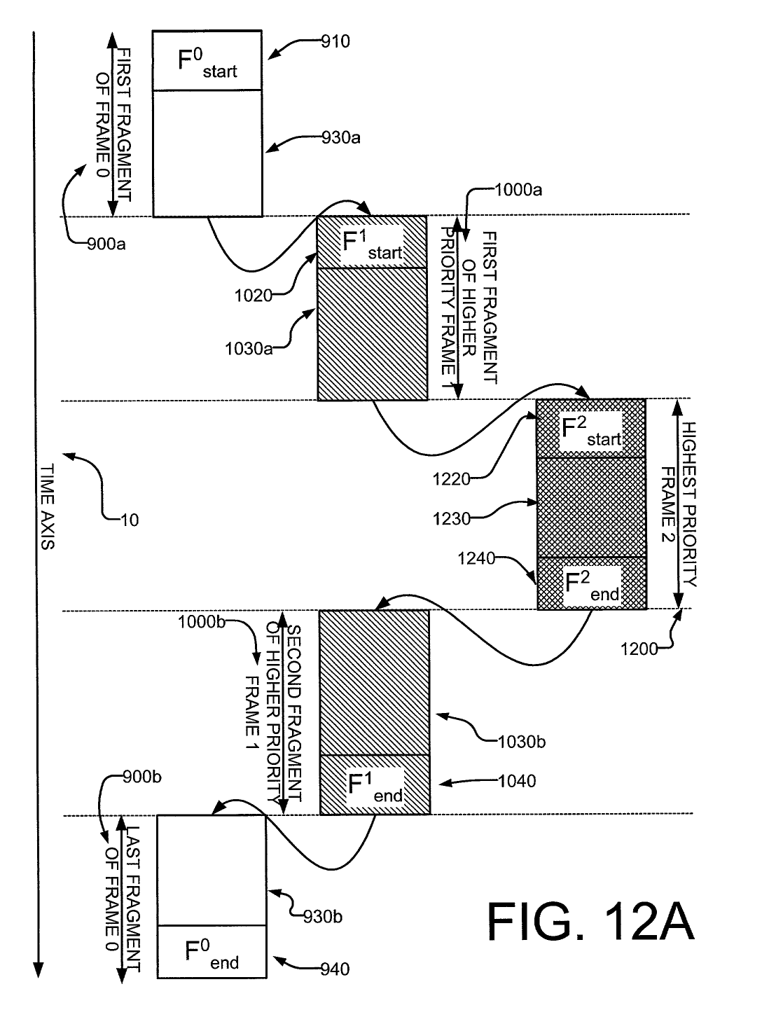

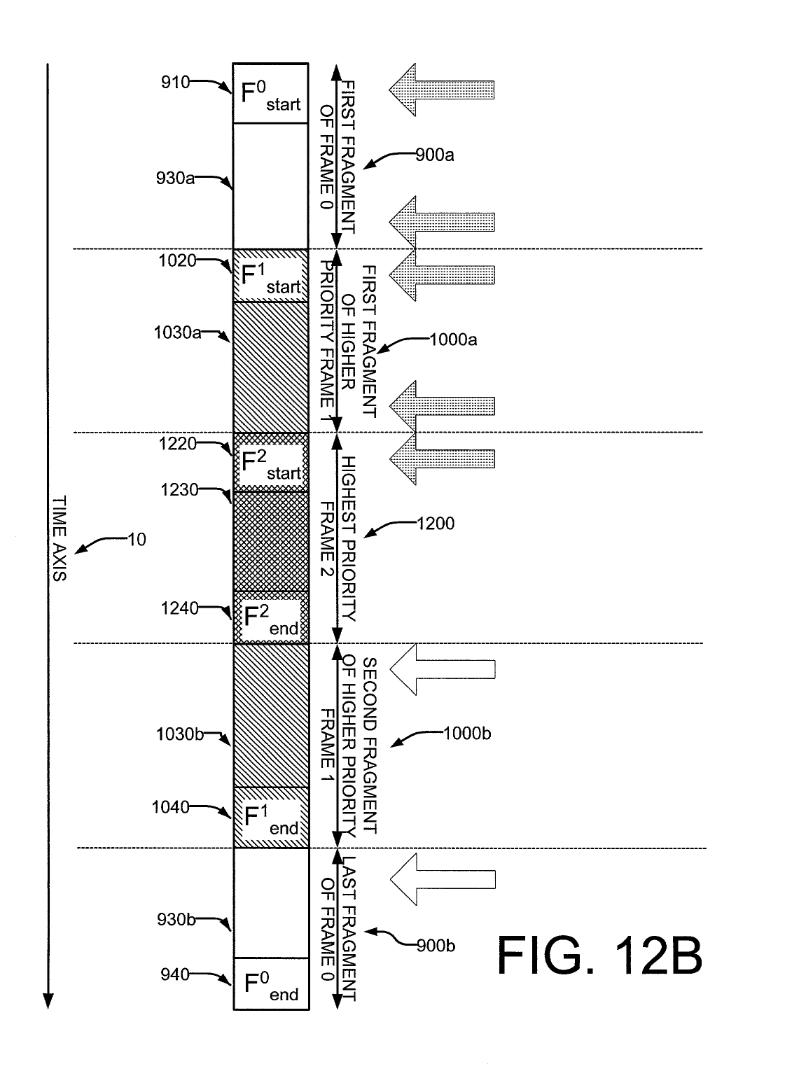

FIG. 12A is a diagram illustrating an embodiment of the invention, wherein a low-priority header-less data stream 900 is suspended by a mid-priority header-less data stream 1000 without significant additional overhead, and the mid-priority header-less data stream 1000 is suspended by a high-priority header-less data stream 1200 without the creation of significant additional overhead. For illustrative purposes, the low-priority header-less frame is designated as header-less frame-0 900, the mid-priority header-less data stream as header-less frame-1 1000, and the high-priority header-less data stream as header-less frame-2 1200, respectively. Unlike the approach of the prior art, since the fragmentation and reconstruction of the header-less data streams 900, 1000 are governed by a priority sorting mechanism, the suspend/resume operation again proceeds without the creation of significant additional overhead. As shown in FIG. 12A, data transmission begins with a frame-0 start-flag 910 being inserted into the transmit FIFO 571 (FIG. 5C), which indicates to the system that frame-0 data 930a transmission is beginning. The transmit process 569 (FIG. 5C) then sends a header-less frame-0 start flag 920a to the transmit FIFO 571 (FIG. 5C), which indicates to the system that header-less frame-0 data 930a will follow. After the header-less frame-0 start flag 920a, the transmit process 569 (FIG. 5C) transmits header-less frame-0 data 930a to the transmit FIFO (FIG. 5C) for transmission to the channel via the twisted pair phone line 555 (FIG. 5C). When the transmit process 569 (FIG. 5C) receives a second header-less data stream (e.g., header-less frame-1 1000) it performs a priority analysis to determine whether header-less frame-1 1000 has priority over header-less frame-0 900, which is currently being transmitted. If, as in the non-limiting example of FIG. 12A, header-less frame-1 1000 has a higher priority than header-less frame-0 900, the transmit process 569 (FIG. 5C) suspends transmission of header-less frame-0 900 and transmits mid-priority header-less frame-1 1000. This is done by the transmit process 569 (FIG. 5C), which sends a header-less frame-1 start flag 1020 to the transmit FIFO 571 (FIG. 5C) followed by header-less frame-1 data 1030. If the transmit process 569 (FIG. 5C) then receives a third header-less data stream (e.g., header-less frame-2 1200) it performs a priority analysis to determine whether header-less frame-2 1200 has priority over header-less frame-1 1000, which is currently being transmitted. If, as in the non-limiting example of FIG. 12A, high-priority header-less frame-2 1200 has a higher priority than mid-priority header-less frame-1 1000, the transmit process 569 (FIG. 5C) suspends transmission of header-less frame-1 1000 and transmits high-priority header-less frame-2 1200 ahead of the mid-priority header-less frame-1 1000. This is done by the transmit process 569 (FIG. 5C), which sends a header-less frame-2 start flag 1220 to the transmit FIFO 571 (FIG. 5C) followed by header-less frame-2 data 1230. Once the header-less frame-2 data 430 has been transmitted in its entirety, the transmit process 569 (FIG. 5C) sends a header-less frame-2 end-flag 1240 to the transmit FIFO 571 (FIG. 5C) to indicate the end of header-less frame-2 1200 transmission. Having completed the transmission of high-priority header-less frame-2 1200, the transmit process 569 (FIG. 5C) fluidly resumes transmission of mid-priority header-less frame-1 data 1030b by sending header-less frame-1 data 1030b to the transmit FIFO 571 (FIG. 5C) for transmission through the channel. Once all of header-less frame-1 data 1030b has been transmitted, the transmit process 569 (FIG. 5C) inserts a header-less frame-1 end-flag 1040 into the transmit FIFO 571 (FIG. 5C) to indicate the end of header-less frame-1 1000 transmission. After completion of mid-priority header-less frame-1 1000 transmission, the transmit process 569 (FIG. 5C) fluidly resumes transmission of low-priority header-less frame-0 data 930b by sending header-less frame-0-data 930b to the transmit FIFO 571 (FIG. 5C) for transmission through the channel. Once all of header-less frame-0 data 930b has been transmitted, the transmit process 569 (FIG. 5C) inserts a header-less frame-0 end-flag 940 into the transmit FIFO 571 (FIG. 5C) to indicate the end of header-less frame-0 900 transmission. Since data stream hierarchy here is once again determined at the transmit process 569 (FIG. 5C) by a predefined priority sorting mechanism prior to transmission, reconstruction of the received header-less frame fragments by the receive process 589 (FIG. 5D) may again be accomplished by employing the predefined priority sorting mechanism to re-establish the original data stream hierarchy. As shown in FIG. 12B, the priority sorting mechanism allows transmission of data without the creation of significant additional overhead. Here, white arrows highlight the absence of the additional headers, while shaded arrows highlight the absence of FSE flags resulting from the use of special start flags.

As shown in the non-limiting examples of FIGS. 8A through 12B, the use of special start and end flags, which indicate the beginning and end of data streams, respectively, allows for greater efficiency due to the elimination of additional FSE flags and additional headers.

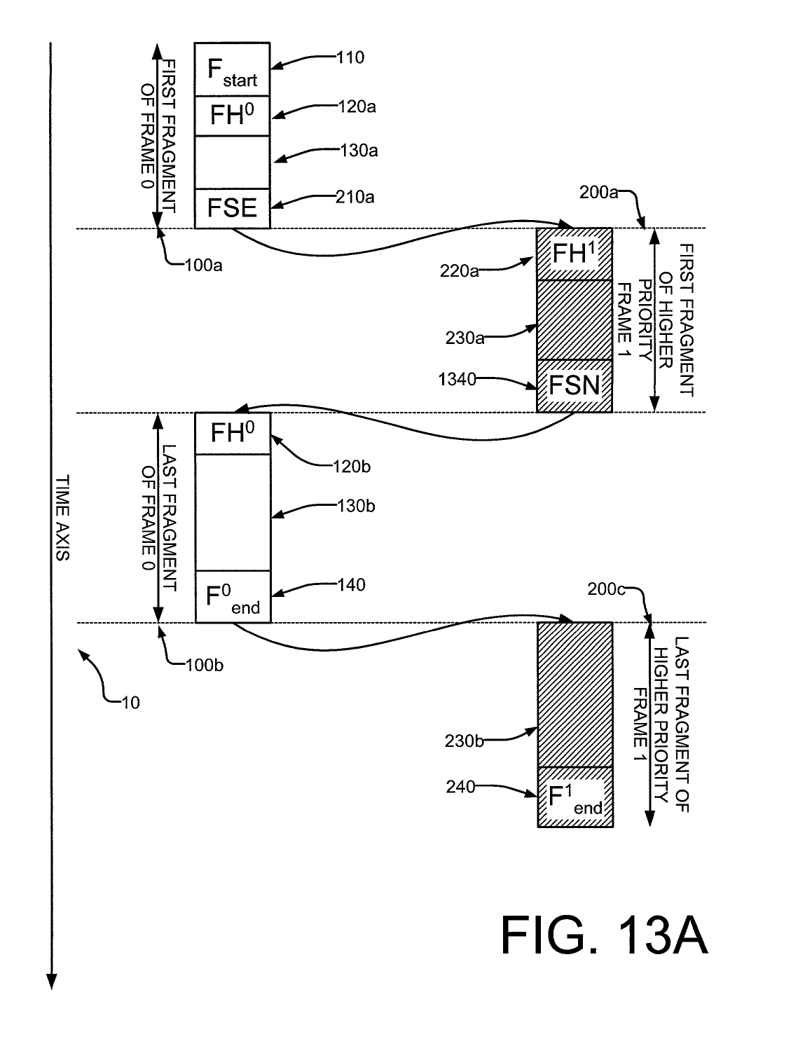

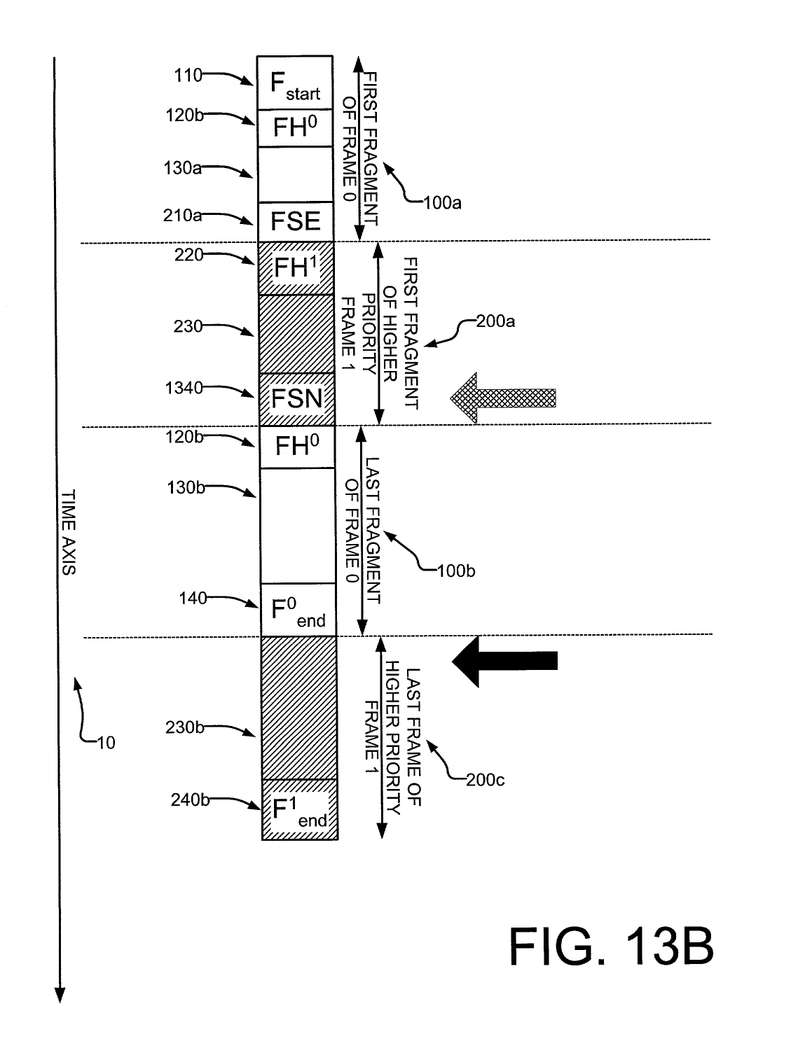

Another benefit arises from using a priority sorting mechanism for fragmenting and reconstructing data streams. Unlike the previous examples of FIGS. 6A through 12B, the priority sorting mechanism may be configured as a non-stacking algorithm, which allows for fragmentation and reconstruction using a non-priority-based approach, thereby allowing suspension of higher priority frames by lower priority frames under certain circumstances. Thus, for example, in situations where the system chooses to deviate from a priority-based approach, a special non-stack flag may be inserted into the data stream to indicate that a non-priority-based approach needs to be implemented. This type of approach (e.g., non-stacking algorithm) is illustrated in the non-limiting examples below, which are shown in FIGS. 13A through 15B.

FIG. 13A is a diagram illustrating an embodiment of the invention, wherein low-priority and high-priority data streams are successively suspended and resumed. For illustrative purposes, the low-priority frame is designated as frame-0 100 while the high-priority frame is designated as frame-1 200. Suspension of higher priority frames may be useful if a higher priority frame is much longer than a lower priority frame, thus, effectively resulting in non-transmission of the lower priority frame. Alternatively, this approach may be useful if there are numerous higher priority frames awaiting transmission, thereby prohibiting transmission of a short lower priority frame. Since, for these types of situations, suspension and resumption of transmission is no longer dependent on frame priority, a FILO approach may no longer be adequate for fragmentation and reconstruction of the data streams. Thus, the priority sorting mechanism would track the fragmentation of data in a non-stacking manner. As shown in FIG. 13A, data transmission begins with a start-flag 110 being inserted into the transmit FIFO 571 (FIG. 5C), which indicates to the system that data transmission is beginning. The transmit process 569 (FIG. 5C) then sends a frame-0 header 120a to the transmit FIFO 571 (FIG. 5C), which indicates to the system that frame-0 data 130a will follow. After the frame-0 header 120a, the transmit process 569 (FIG. 5C) transmits frame-0 data 130a to the transmit FIFO (FIG. 5C) for transmission to the channel via the twisted pair phone line 555 (FIG. 5C). When the transmit process 569 (FIG. 5C) receives a second data stream (e.g., frame-1 200a) it performs a priority analysis to determine whether frame-1 200a has priority over frame-0 100, which is currently being transmitted. If, as in the non-limiting example of FIG. 13A, frame-1 200 has a higher priority than frame-0 100, the transmit process 569 (FIG. 5C) suspends transmission of frame-0 100 and inserts a frame suspend enable (FSE) flag 210a into the transmit FIFO 571 (FIG. 5C), which indicates the suspended transmission of the lower priority frame-0 100. Upon suspension of frame-0 100, the higher priority frame-1 200a is transmitted. This is done by the transmit process 569 (FIG. 5C), which sends a frame-1 header 220a to the transmit FIFO 571 (FIG. 5C) followed by frame-1 data 230. During transmission of the frame-1 data 230a, if the system determines that it is appropriate to interrupt transmission of the higher priority frame 200a (e.g., the higher priority data packet is too long), then the transmit process 569 (FIG. 5C) sends a frame suspend non-stack (FSN) flag 1340 to the transmit FIFO 571 (FIG. 5C) to indicate suspension of the frame-1 200a transmission. Having suspended the transmission of higher priority frame-1 200a, the transmit process 569 (FIG. 5C) fluidly resumes transmission of frame-0 data 130b by sending frame-0-data 130b to the transmit FIFO 571 (FIG. 5C) for transmission through the channel. Once lower-priority frame-0 100b transmission is complete, the transmit process 569 (FIG. 5C) inserts a frame-0 end-flag 140, which indicates the end of transmission for frame-0 100b. Having completed the transmission of lower priority frame-0 100b, the transmit process 569 (FIG. 5C) fluidly resumes transmission of higher priority frame-1 data 230b by sending frame-1 data 230b to the transmit FIFO 571 (FIG. 5C) for transmission through the channel. Once all of frame-1 data 230b has been transmitted, the transmit process 569 (FIG. 5C) inserts a frame-1 end-flag 240 into the transmit FIFO 571 (FIG. 5C) to indicate the end of frame-1 200c transmission. Since data stream hierarchy is determined at the transmit process 569 (FIG. 5C) by a predefined priority sorting mechanism, reconstruction of the received frame fragments by the receive process 589 (FIG. 5D) may now be accomplished by employing the predefined priority sorting mechanism to re-establish the original data stream hierarchy. As shown in FIG. 13B, the priority sorting mechanism allows transmission of data without the creation of significant additional overhead. This is shown with a black arrow, which highlight the absence of the additional header, and a hashed arrow, which highlights the FSN flag 1340 used to demarcate the fragment of frame-1 200.

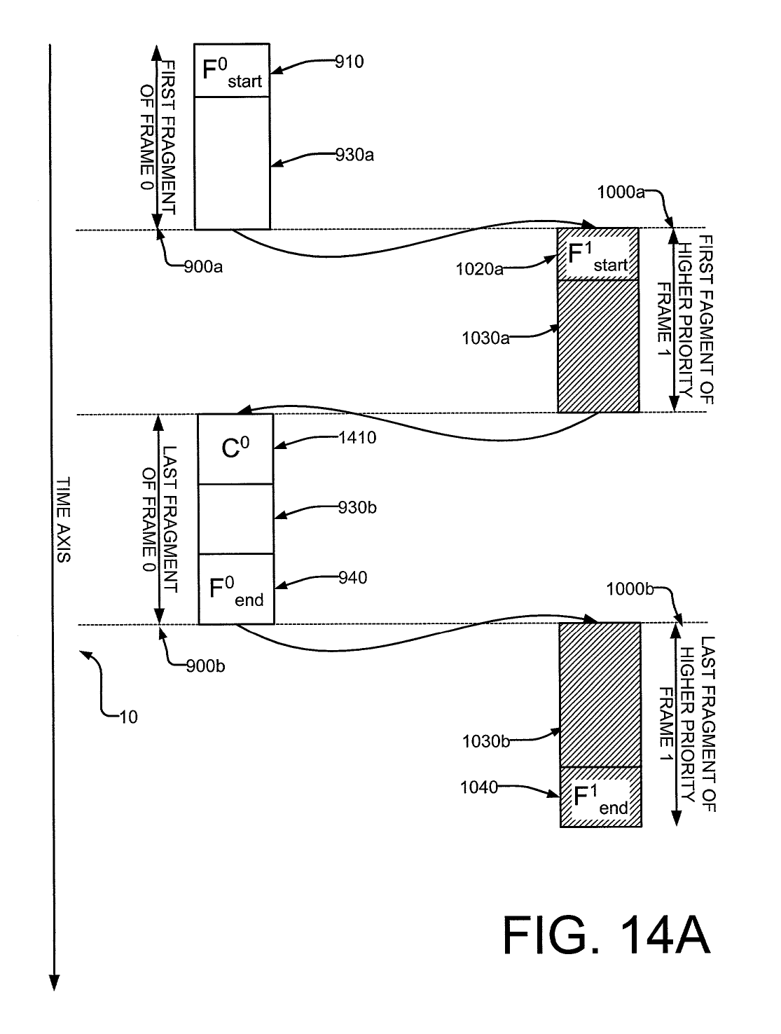

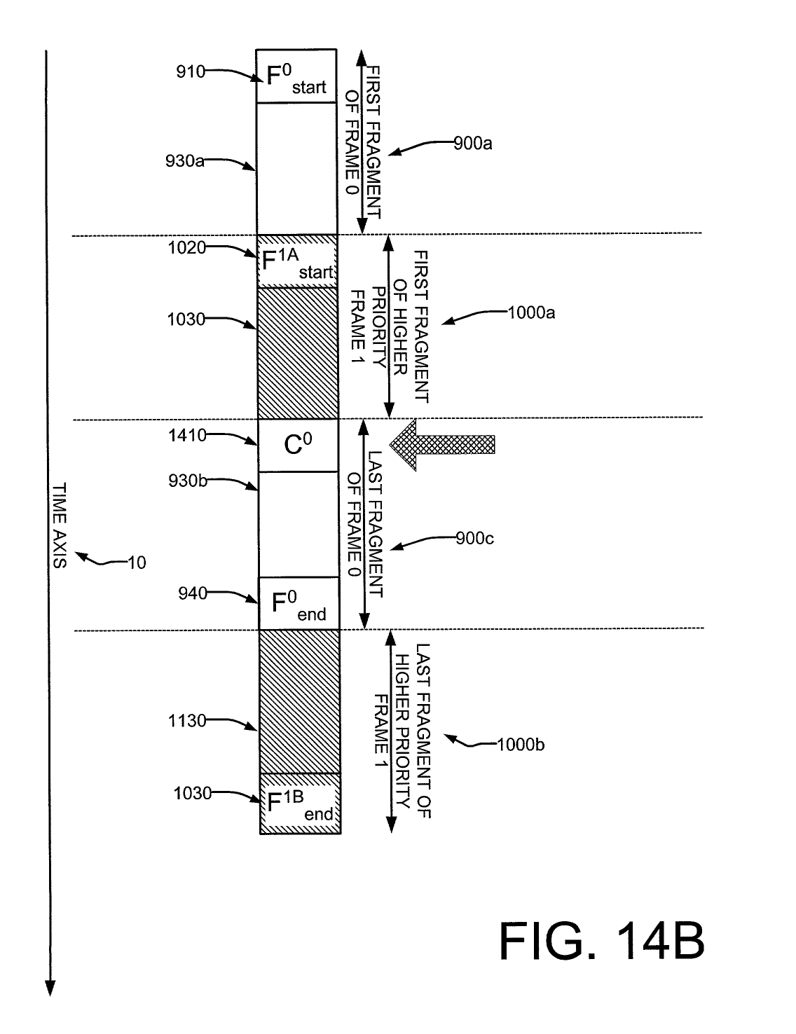

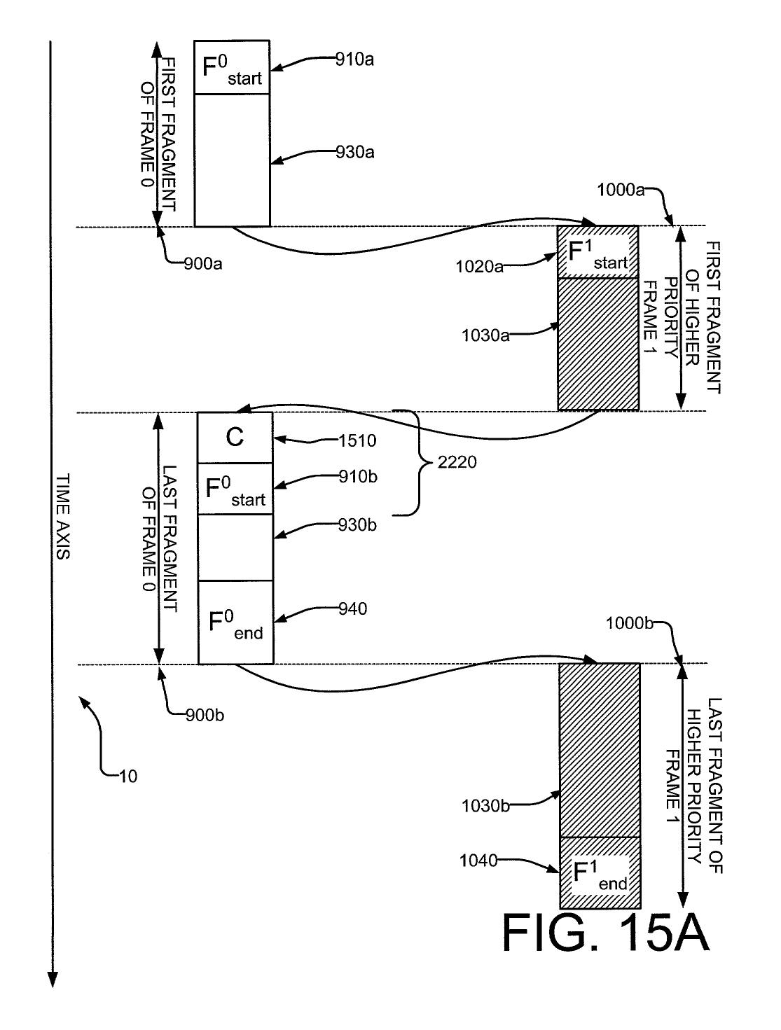

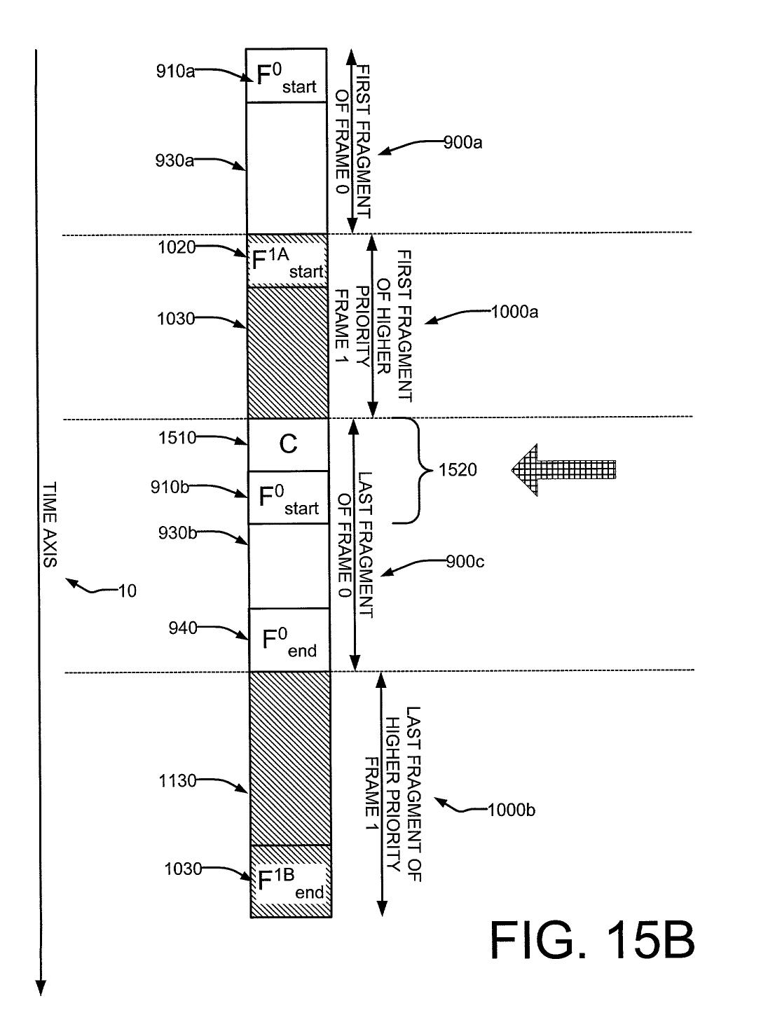

FIG. 14A is a diagram illustrating another embodiment of the invention, wherein low-priority and high-priority header-less data streams are successively suspended and resumed. For illustrative purposes, the low-priority header-less frame is designated as header-less frame-0 900 while the high-priority header-less frame is designated as header-less frame-1. As shown in FIG. 14A, data transmission begins with a start-flag 910 being inserted into the transmit FIFO 571 (FIG. 5C), which indicates to the system that frame-0 data 930a transmission is beginning. The transmit process 569 (FIG. 5C) then sends header-less frame-0 data 930a to the transmit FIFO (FIG. 5C) for transmission to the channel via the twisted pair phone line 555 (FIG. 5C). When the transmit process 569 (FIG. 5C) receives a second header-less data stream (e.g., header-less frame-1 1000a) it performs a priority analysis to determine whether header-less frame-1 1000a has priority over header-less frame-0 900, which is currently being transmitted. If, as in the non-limiting example of FIG. 14A, header-less frame-1 1000 has a higher priority than header-less frame-0 900, the transmit process 569 (FIG. 5C) suspends transmission of header-less frame-0 900 and inserts a header-less frame-1 start flag 1020a to the transmit FIFO 571 (FIG. 5C) followed by header-less frame-1 data 1030a. During transmission of the header-less frame-1 data 1030a, if the system determines that it is appropriate to interrupt transmission of the higher priority header-less frame 1000a (e.g., the higher priority data packet is too long) by the lower-priority header-less frame, then the transmit process 569 (FIG. 5C) sends a frame-0 continuation flag 1410 to the transmit FIFO 571 (FIG. 5C) to indicate resumed transmission of lower-priority header-less frame-0 900b. Having inserted the frame-0 continuation flag 1410, the transmit process 569 (FIG. 5C) fluidly resumes transmission of header-less frame-0 data 930b by sending header-less frame-0-data 930b to the transmit FIFO 571 (FIG. 5C) for transmission through the channel. Once lower-priority header-less frame-0 900b transmission is complete, the transmit process 569 (FIG. 5C) inserts a header-less frame-0 end-flag 940, which indicates the end of transmission for header-less frame-0 900b. Having completed the transmission of lower priority header-less frame-0 900b, the transmit process 569 (FIG. 5C) fluidly resumes transmission of higher priority header-less frame-1 data 1030b by sending header-less frame-1 data 1030b to the transmit FIFO 571 (FIG. 5C) for transmission through the channel. Once all of header-less frame-1 data 1030b has been transmitted, the transmit process 569 (FIG. 5C) inserts a header-less frame-1 end-flag 1040 into the transmit FIFO 571 (FIG. 5C) to indicate the end of header-less frame-1 1000c transmission. Since data stream hierarchy is determined at the transmit process 569 (FIG. 5C) by a predefined priority sorting mechanism, reconstruction of the received header-less frame fragments by the receive process 589 (FIG. 5D) may be accomplished by employing the predefined priority sorting mechanism to re-establish the original data stream hierarchy. As shown in FIG. 14B, the priority sorting mechanism allows successive suspension and resumption of data transmission without the creation of significant additional overhead. A hashed arrow, in FIG. 14B, highlights the frame-0 continuation flag 1410 used to indicate the interruption of higher-priority frame-1 1000 and continued transmission of lower-priority frame-0 900. The use of special continuation flags for each frame, however, may reduce efficiency because additional flags are created for each frame continuation. In other words, since each frame has its own continuation flag that is used to identify the resumed transmission of data (i.e., any given frame has a continuation flag associated with it), the number of continuation flags increases linearly with an increase in data streams. This problem may be mitigated by employing a predefined universal continuation flag as shown in FIGS. 15A and 15B.

FIG. 15A is a diagram illustrating yet another embodiment of the invention, wherein low-priority and high-priority header-less data streams are successively suspended and resumed. For illustrative purposes, the low-priority header-less frame is designated as header-less frame-0 900 while the high-priority header-less frame is designated as header-less frame-1 1000. As shown in FIG. 15A, data transmission begins with a start-flag 910a being inserted into the transmit FIFO 571 (FIG. 5C), which indicates to the system that frame-0 data 930a transmission is beginning. The transmit process 569 (FIG. 5C) then sends header-less frame-0 data 930a to the transmit FIFO (FIG. 5C) for transmission to the channel via the twisted pair phone line 555 (FIG. 5C). When the transmit process 569 (FIG. 5C) receives a second header-less data stream (e.g., header-less frame-1 1000a) it performs a priority analysis to determine whether header-less frame-1 1000a has priority over header-less frame-0 900, which is currently being transmitted. If, as in the non-limiting example of FIG. 15A, header-less frame-1 1000 has a higher priority than header-less frame-0 900, the transmit process 569 (FIG. 5C) suspends transmission of header-less frame-0 900 and inserts a header-less frame-1 start flag 1020a to the transmit FIFO 571 (FIG. 5C) followed by header-less frame-1 data 1030a. During transmission of the header-less frame-1 data 1030a, if the system determines that it is appropriate to interrupt transmission of the higher priority header-less frame 1000a by the lower-priority header-less frame-0 900, then the transmit process 569 (FIG. 5C) sends a predefined universal continuation flag 1510 in conjunction with a frame-0 start flag 910b to the transmit FIFO 571 (FIG. 5C). This combination of flags indicates a resumed transmission of lowerpriority header-less frame-0 900b. Having contiguously inserted the predefined universal continuation flag 1510 and the frame-0 start flag 910b into the transmit FIFO 571 (FIG. 5C), the transmit process 569 (FIG. 5C) fluidly resumes transmission of header-less frame-0 data 930b by sending header-less frame-0-data 930b to the transmit FIFO 571 (FIG. 5C) for transmission through the channel. Once lower-priority header-less frame-0 900b transmission is complete, the transmit process 569 (FIG. 5C) inserts a header-less frame-0 end-flag 940, which indicates the end of transmission for header-less frame-0 900b. Having completed the transmission of lower priority header-less frame-0 900b, the transmit process 569 (FIG. 5C) fluidly resumes transmission of higher priority header-less frame-1 data 1030b by sending header-less frame-1 data 1030b to the transmit FIFO 571 (FIG. 5C) for transmission through the channel. Once all of header-less frame-1 data 1030b has been transmitted, the transmit process 569 (FIG. 5C) inserts a header-less frame-1 end-flag 1040 into the transmit FIFO 571 (FIG. 5C) to indicate the end of header-less frame-1 1000b transmission. Since data stream hierarchy is determined at the transmit process 569 (FIG. 5C) by a predefined priority sorting mechanism, reconstruction of the received header-less frame fragments by the receive process 589 (FIG. 5D) may again be accomplished by employing the predefined priority sorting mechanism to re-establish the original data stream hierarchy. As shown in FIG. 15B, the priority sorting mechanism allows successive suspension and resumption of data transmission without the creation of significant additional overhead. A checkered arrow, in FIG. 15B, highlights the contiguous segments depicting the predefined universal continuation flag 1510 and the frame-0 start flag 910b used in conjunction to indicate the interruption of higher-priority frame-1 1000 and continued transmission of lower-priority frame-0 900. Since there is only one predefined universal continuation flag 1510, the inefficiency associated with data transparency (see FIGS. 14A and 14B) is now mitigated.

As shown in the non-limiting examples of FIGS. 13A through 15B, a priority sorting mechanism may be defined in a number of ways to allow transmission of data without the creation of additional overhead.

Method

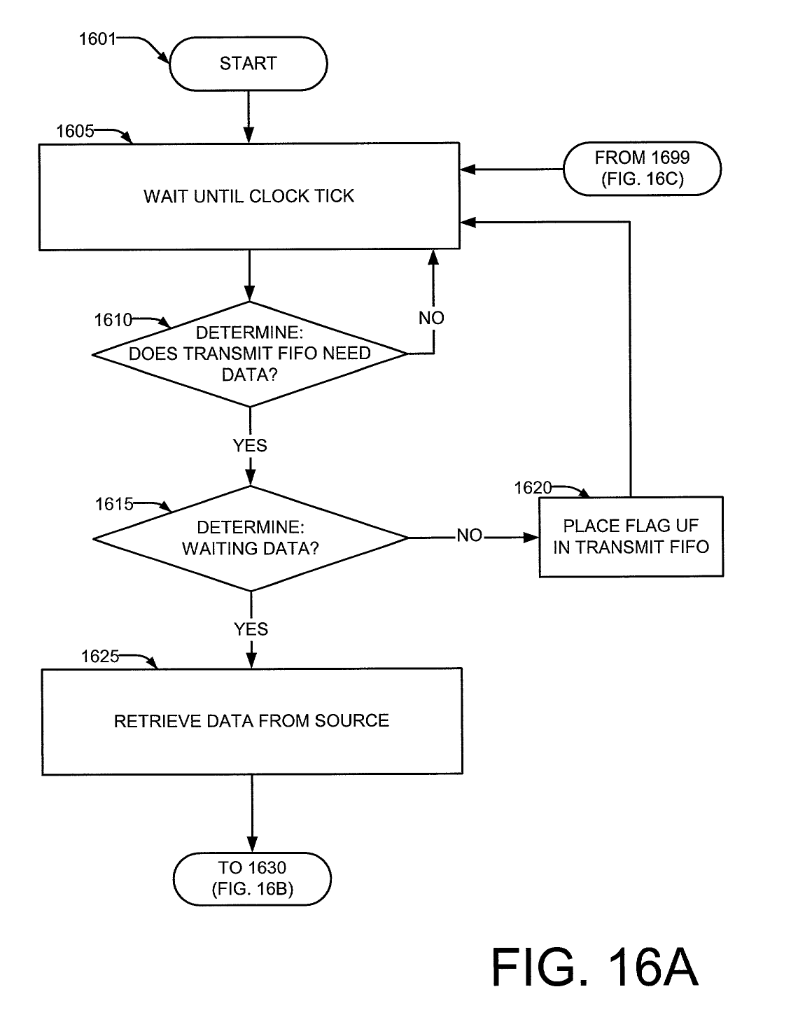

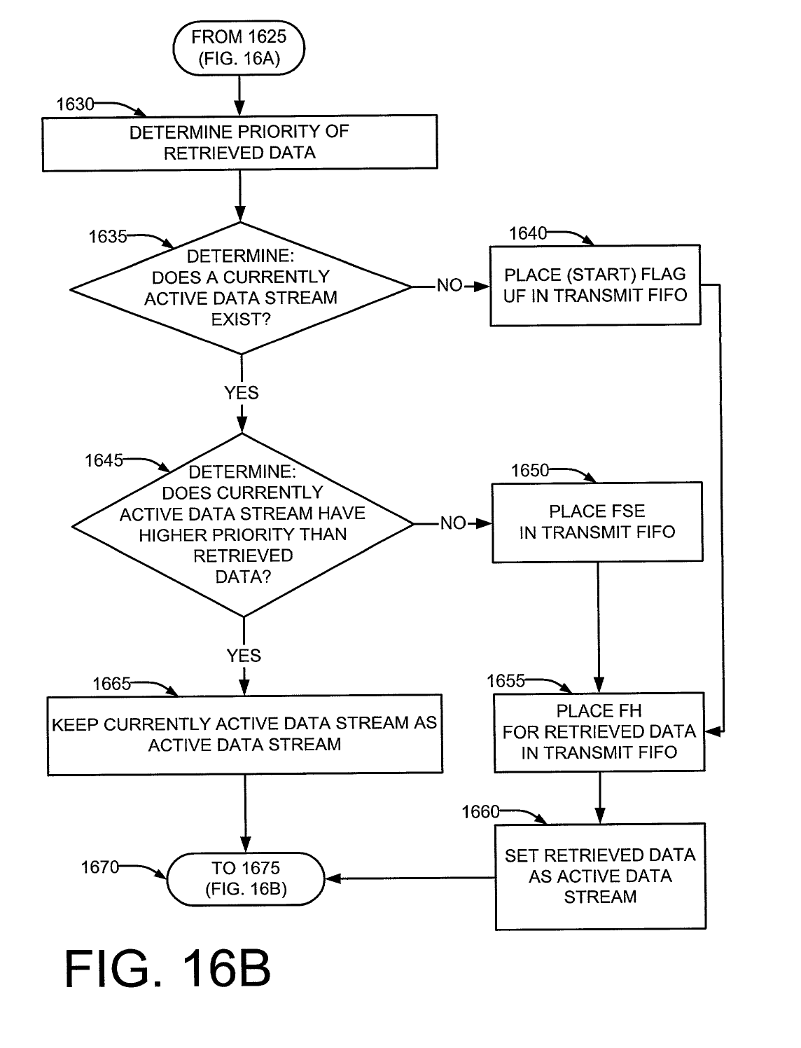

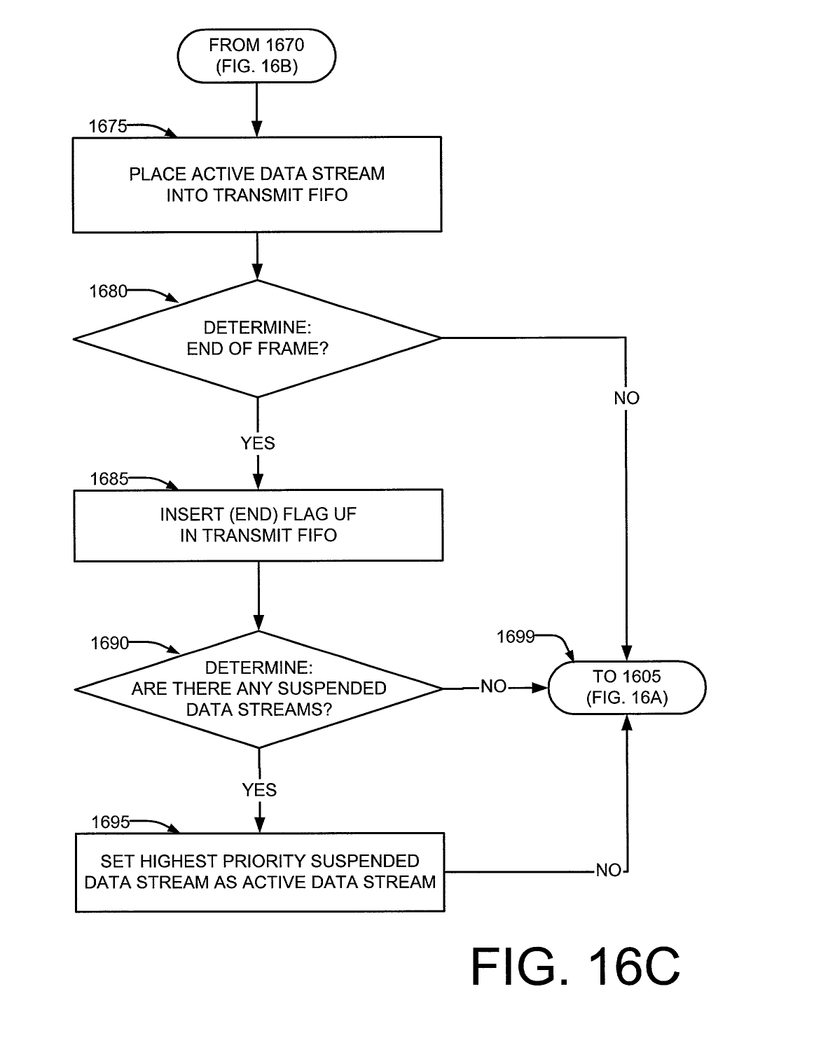

In addition to a system for efficiently transmitting data streams, the invention also encompasses a method for efficiently transmitting data streams. The method steps for transmitting information in several embodiments of the invention are illustrated in FIGS. 16A through 20C. In these non-limiting examples, the method steps are shown to correlate with the system as described in FIGS. 5A through 15B. However, the details associated with these steps are included for purposes of clarity only and should not be construed as limiting the scope of the invention, which is laid out in the claims following the detailed description.

FIGS. 16A through 16C are flowcharts illustrating the method steps associated with transmitting the data streams of FIGS. 6A through 8B using the system of FIG. 5C in one embodiment of the invention.

In this embodiment of the invention, the data streams (e.g., frame-1 200 of FIG. 6B), which are sorted by the transmit process 569 (FIG. 5C), contain headers (e.g., frame-1 header 220 of FIG. 6B) having priority information. In this non-limiting example, the system, in step 1605, waits for the next clock cycle. At the clock cycle, the transmit procedure 569 (FIG. 5C), in step 1610, determines whether the transmit FIFO 571 (FIG. 5C) needs data. If the transmit process 569 (FIG. 5C) determines 1610 that no data is needed, then the system waits 1605 for another clock cycle and repeats the process. If, however, the transmit process 569 (FIG. 5C) determines 1610 that the transmit FIFO 571 (FIG. 5C) needs data, then the transmit process 569 (FIG. 5C) further determines, in step 1615, whether the system is waiting data. If the transmit process 569 (FIG. 5C) determines 1615 that the system is not waiting data, then the transmit process 569 (FIG. 5C), in step 1620, places a flag in the transmit FIFO 571 (FIG. 5C) and waits 1605 for the next clock cycle. If, on the other hand, the transmit process 569 (FIG. 5C) determines 1615 that the system is waiting data, then the transmit process 569 (FIG. 5C), in step 1625, retrieves data from the source 559 (FIG. 5C). Once the data has been retrieved, the process continues to step 1630 in FIG. 16B.

Having retrieved 1625 the data from the source 559 (FIG. 5C), the transmit process 569 (FIG. 5C) then determines, in step 1630, the priority level of the retrieved 1625 data. After determining 1630 the priority level of the retrieved 1625 data, the transmit process 569 (FIG. 5C), in step 1635, determines whether there exists a currently active data stream. If the transmit process 569 (FIG. 5C) determines 1635 that there is currently no active data stream (i.e., the system is not already transmitting data), then the transmit process 569 (FIG. 5C), in step 1640, places a universal flag (UF) in the transmit FIFO 571 (FIG. 5C) to indicate the start of data transmission. Although this non-limiting example shows a UF being used as a start flag, it will be clear to one of ordinary skill in the art that a special start flag may be used in place of the UF. This, however, may decrease efficiency when used in conjunction with frame headers because additional special characters would be introduced for each special flag created. Therefore, in the preferred embodiment where frame headers are used, a UF is used to demarcate the beginning of a data stream. Similarly, in this non-limiting example, the UF is also used to represent an end-flag as well as other data stream delineators. Once the transmit process 569 (FIG. 5C) places 1640 the UF in the transmit FIFO 571 (FIG. 5C), a frame header for the retrieved 1625 data is placed, in step 1655, in the transmit FIFO 571 (FIG. 5C) by the transmit process 569 (FIG. 5C). Upon placing 1655 the frame header into the transmit FIFO 571 (FIG. 5C), the transmit process 569 (FIG. 5C), in step 1660, sets the retrieved 1625 data as the active data stream, which is to be transmitted according to the procedure set forth in FIG. 16C.

If, however, in step 1635, the transmit process 569 (FIG. 5C) determines that there exists a currently active data stream, then the transmit process further determines, in step 1645, whether the currently active data stream has a higher priority than the retrieved 1625 data. If the transmit process 569 (FIG. 5C) determines 1645 that the currently active data stream has a lower priority than the retrieved data, then the transmit process 569 (FIG. 5C), in step 1650, places a frame suspend enable (FSE) in the transmit FIFO 571 (FIG. 5C), thereby suspending transmission of the currently active data stream. Once the currently active data stream has been suspended, the transmit process 569 (FIG. 5C) places 1655 a frame header for the retrieved 1625 data in the transmit FIFO 571 (FIG. 5C) and sets 1660 the retrieved 1625 data as the active data stream, which is to be transmitted according to the procedure set forth in FIG. 16C.

If, in step 1645, the system determines that the retrieved 1725 data does not have a higher priority, then the transmit process 569 (FIG. 5C) keeps, in step 1665, the currently active data stream as the active data stream, which is to be transmitted according to the procedure set forth in FIG. 16C.

Once the active data stream has been determined according to the procedure set forth in FIG. 16B, the transmit process 569 (FIG. 5C) places, in step 1675, the active data stream into the transmit FIFO 571 (FIG. 5C). The transmit process 569 (FIG. 5C) then determines, in step 1680, whether it is the end of the frame (i.e., the end of the data stream). If the transmit process 569 (FIG. 5C) determines 1680 that it is not the end of the data stream, the system proceeds back to step 1605 where the transmit process 569 (FIG. 5C) repeats the procedure by waiting 1605 for the next clock cycle. If, however, the transmit process 569 (FIG. 5C) determines 1680 that it is the end of the data stream, then the transmit process 569 (FIG. 5C), in step 1685, inserts a UF in the transmit FIFO 571 (FIG. 5C) as an end-flag. Having completed the transmission of the data stream, the transmit process 569 (FIG. 5C) then determines, in step 1690, whether there are any suspended data streams. If the transmit process 569 (FIG. 5C) determines 1690 that there are no suspended data streams, then the procedure jumps back to step 1605 where the transmit process 569 (FIG. 5C) awaits the next clock cycle. If, on the other hand, there exist suspended data streams, then the transmit process 569 (FIG. 5C), in step 1695, sets the highest priority suspended data stream as the active data stream and the procedure repeats itself from step 1605 until all suspended data streams have been transmitted in order of priority.

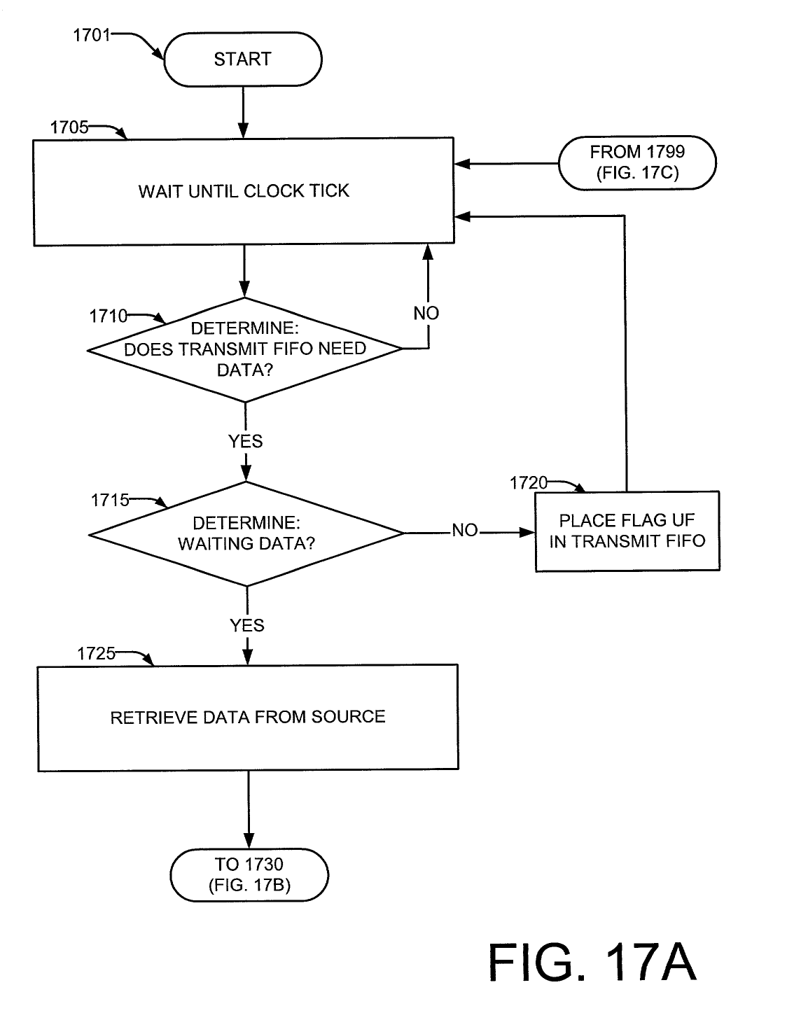

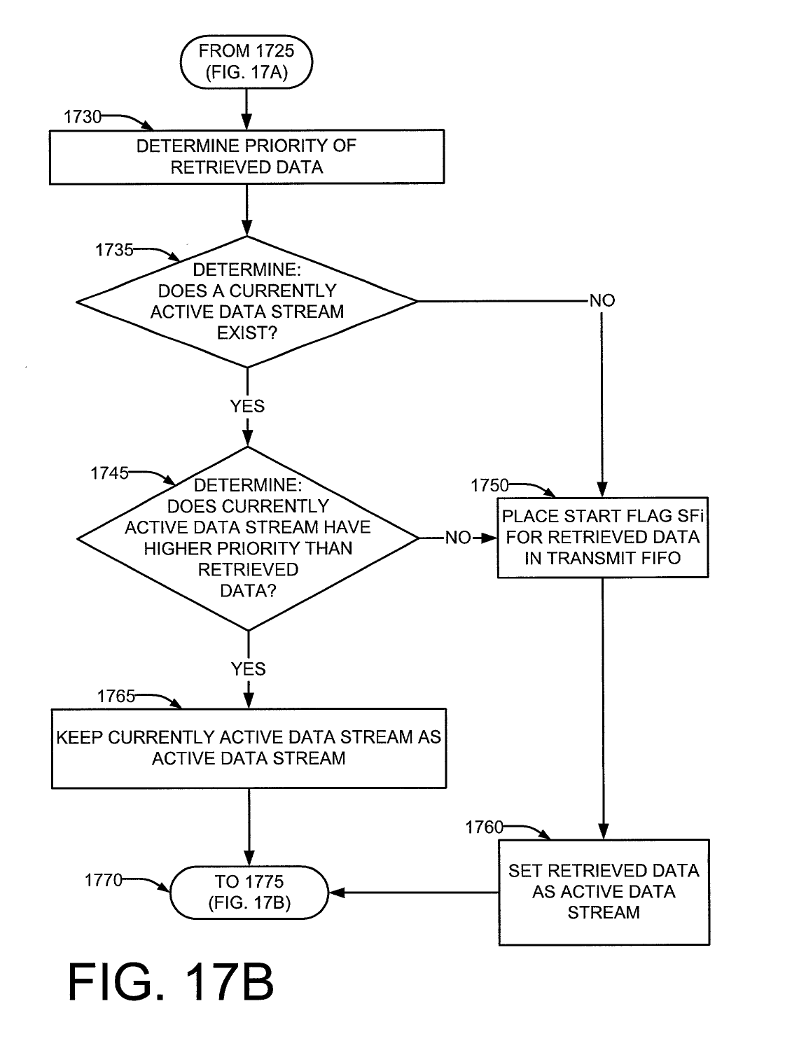

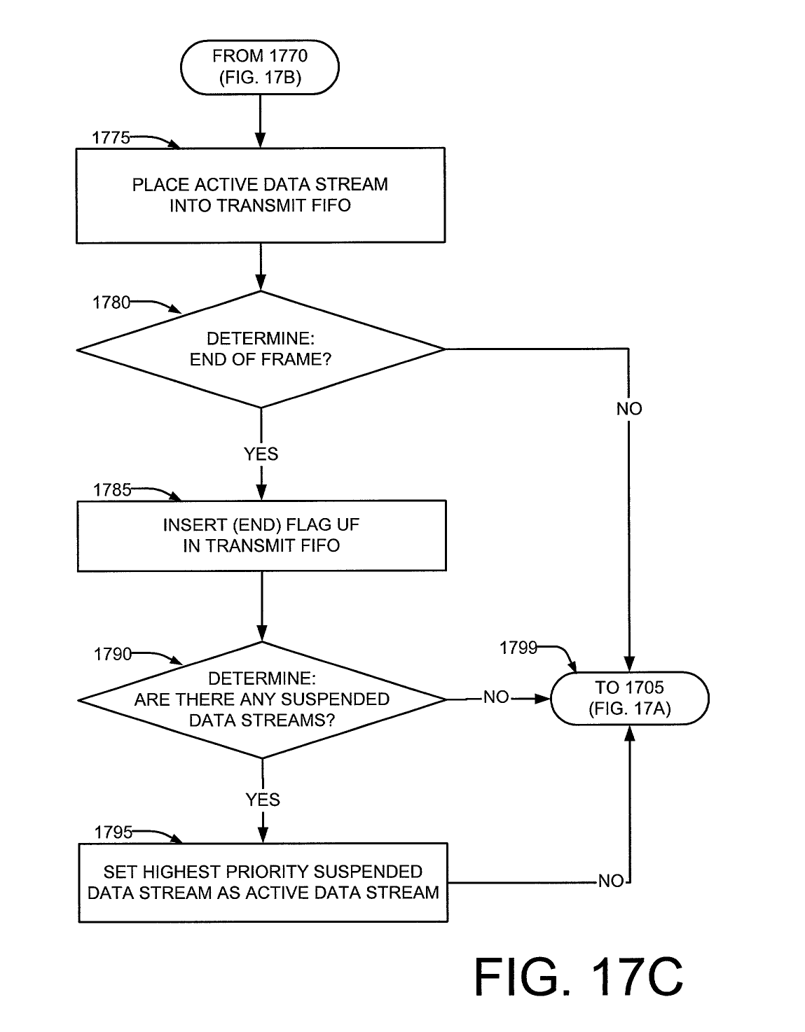

FIGS. 17A through 17C are flowcharts illustrating the method steps associated with transmitting the header-less data streams of FIGS. 9A through 12B using the system of FIG. 5C in another embodiment of the invention.

In this embodiment of the invention, the data streams (e.g., higher-priority frame-1 1000 of FIG. 6B), which are sorted by the transmit process 569 (FIG. 5C), contain special flags (e.g., frame-1 start-flag 1020 of FIG. 6B) having priority information. In this non-limiting example, the system, in step 1705, waits for the next clock cycle. At the clock cycle, the transmit process 569 (FIG. 5C), in step 1710, determines whether the transmit FIFO 571 (FIG. 5C) needs data. If the transmit process 569 (FIG. 5C) determines 1710 that no data is needed, then the system waits 1705 for another clock cycle and repeats the procedure. If, however, the transmit process 569 (FIG. 5C) determines 1710 that the transmit FIFO 571 (FIG. 5C) needs data, then the transmit process 569 (FIG. 5C) further determines, in step 1715, whether the system is waiting data. If the transmit process 569 (FIG. 5C) determines 1715 that the system is not waiting data, then the transmit process 569 (FIG. 5C), in step 1720, places a flag in the transmit FIFO 571 (FIG. 5C) and waits 1705 for the next clock cycle. If, on the other hand, the transmit process 569 (FIG. 5C) determines 1715 that the system is waiting data, then the transmit process 569 (FIG. 5C), in step 1725, retrieves data from the source 559 (FIG. 5C). Once the data has been retrieved, the process continues to step 1730 in FIG. 17B.

Having retrieved 1725 the data from the source 559 (FIG. 5C), the transmit process 569 (FIG. 5C) then determines, in step 1730, the priority level of the retrieved 1725 data. After determining 1730 the priority level of the retrieved 1725 data, the transmit process 569 (FIG. 5C), in step 1735, determines whether there exists a currently active data stream. If the transmit process 569 (FIG. 5C) determines 1735 that there is currently no active data stream (i.e., the system is not already transmitting data), then the transmit process 569 (FIG. 5C), in step 1750, places a special start flag (SFi) in the transmit FIFO 571 (FIG. 5C) to indicate the start of data transmission for frame i, wherein i represents the priority of the frame. Once the transmit process 569 (FIG. 5C) places 1750 SFi in the transmit FIFO 571 (FIG. 5C), the transmit process 569 (FIG. 5C), in step 1760, sets the retrieved 1725 data as the active data stream, which is to be transmitted according to the procedure set forth in FIG. 17C.

If, however, in step 1735, the transmit process 569 (FIG. 5C) determines that there exists a currently active data stream, then the transmit process further determines, in step 1745, whether the currently active data stream has a higher priority than the retrieved 1725 data. If the transmit process 569 (FIG. 5C) determines 1745 that the currently active data stream has a lower priority than the retrieved data, then the transmit process 569 (FIG. 5C), in step 1750, places SFi in the transmit FIFO 571 (FIG. 5C), thereby suspending transmission of the currently active data stream. Once the currently active data stream has been suspended, the transmit process 569 (FIG. 5C) sets 1760 the retrieved 1725 data as the active data stream, which is to be transmitted according to the procedure set forth in FIG. 17C. If, in step 1745, the system determines that the retrieved 1725 data does not have a higher priority, then the transmit process 569 (FIG. 5C) keeps, in step 1765, the currently active data stream as the active data stream, which is to be transmitted according to the procedure set forth in FIG. 17C.

Once the active data stream has been determined according to the procedure set forth in FIG. 17B, the transmit process 569 (FIG. 5C) places, in step 1775, the active data stream into the transmit FIFO 571 (FIG. 5C). The transmit process 569 (FIG. 5C) then determines, in step 1780, whether it is the end of the frame (i.e., the end of the data stream). If the transmit process 569 (FIG. 5C) determines 1780 that it is not the end of the data stream, the system proceeds back to step 1705 where the transmit process 569 (FIG. 5C) repeats the procedure by waiting 1705 for the next clock cycle. If, however, the transmit process 569 (FIG. 5C) determines 1780 that it is the end of the data stream, then the transmit process 569 (FIG. 5C), in step 1785, inserts a UF in the transmit FIFO 571 (FIG. 5C) as an end-flag. Having completed the transmission of the data stream, the transmit process 569 (FIG. 5C) then determines, in step 1790, whether there are any suspended data streams. If the transmit process 569 (FIG. 5C) determines 1790 that there are no suspended data streams, then the procedure jumps back to step 1705 where the transmit process 569 (FIG. 5C) awaits the next clock cycle. If, on the other hand, there exist suspended data streams, then the transmit process 569 (FIG. 5C), in step 1795, sets the highest priority suspended data stream as the active data stream and the procedure repeats itself from step 1705 until all suspended data streams have been transmitted in order of priority.

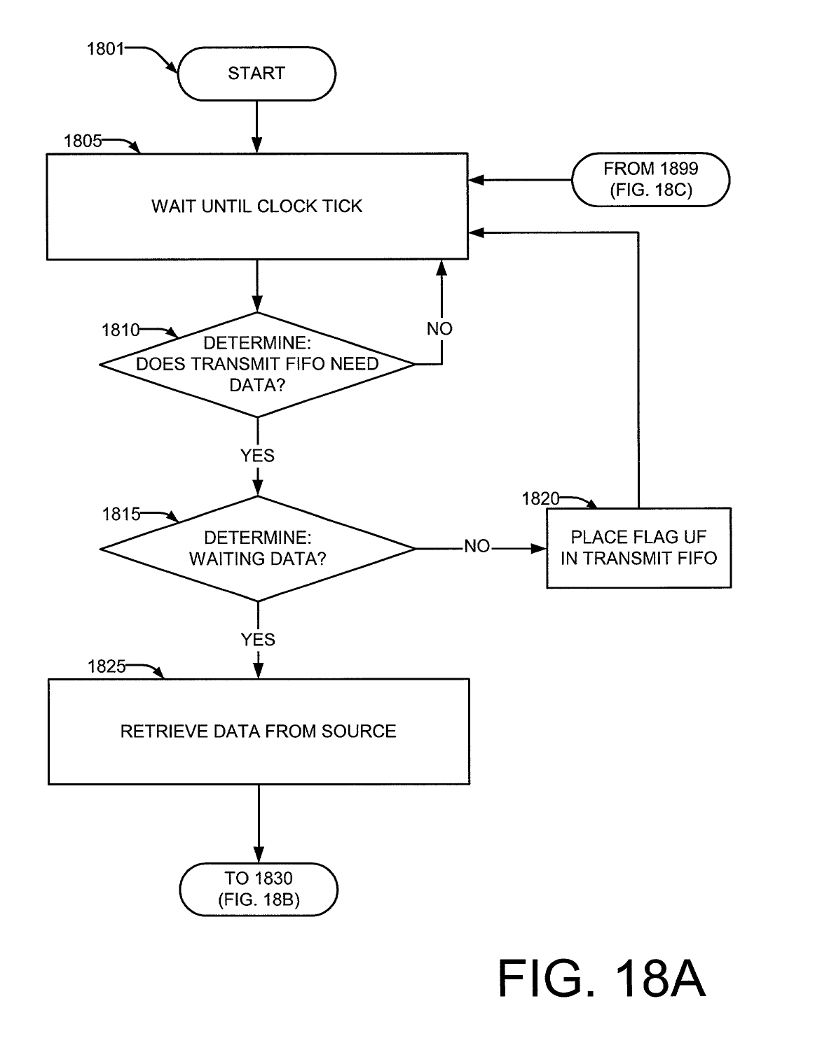

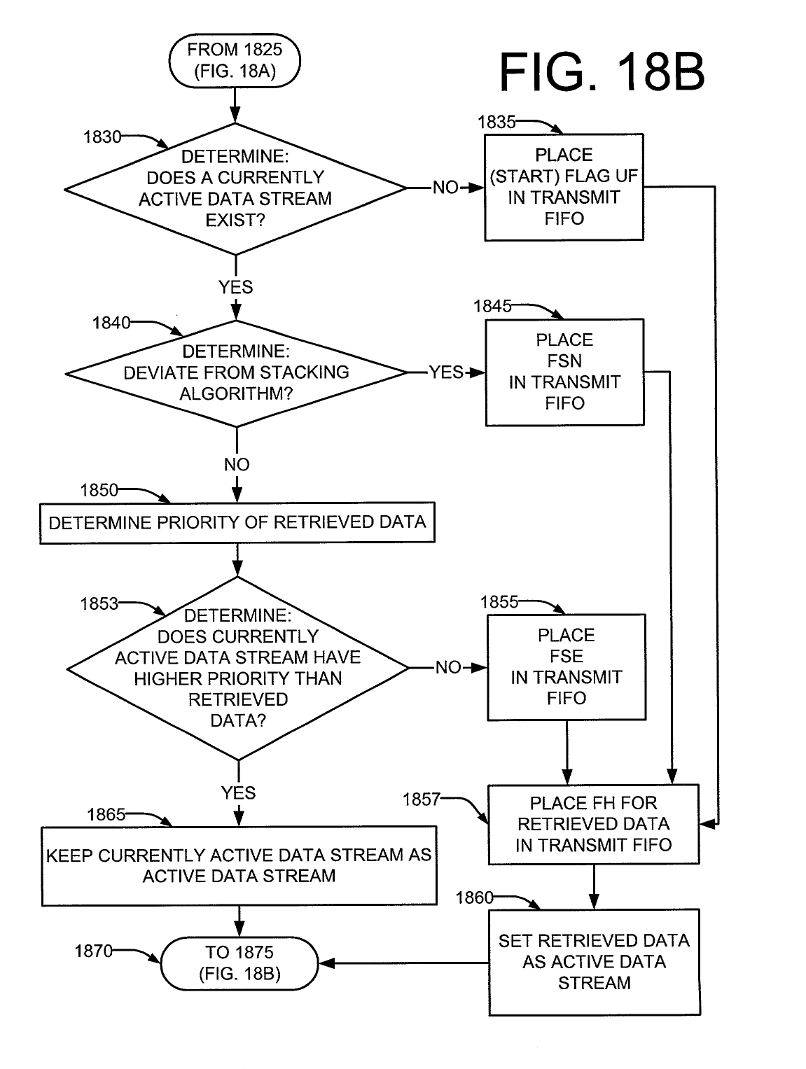

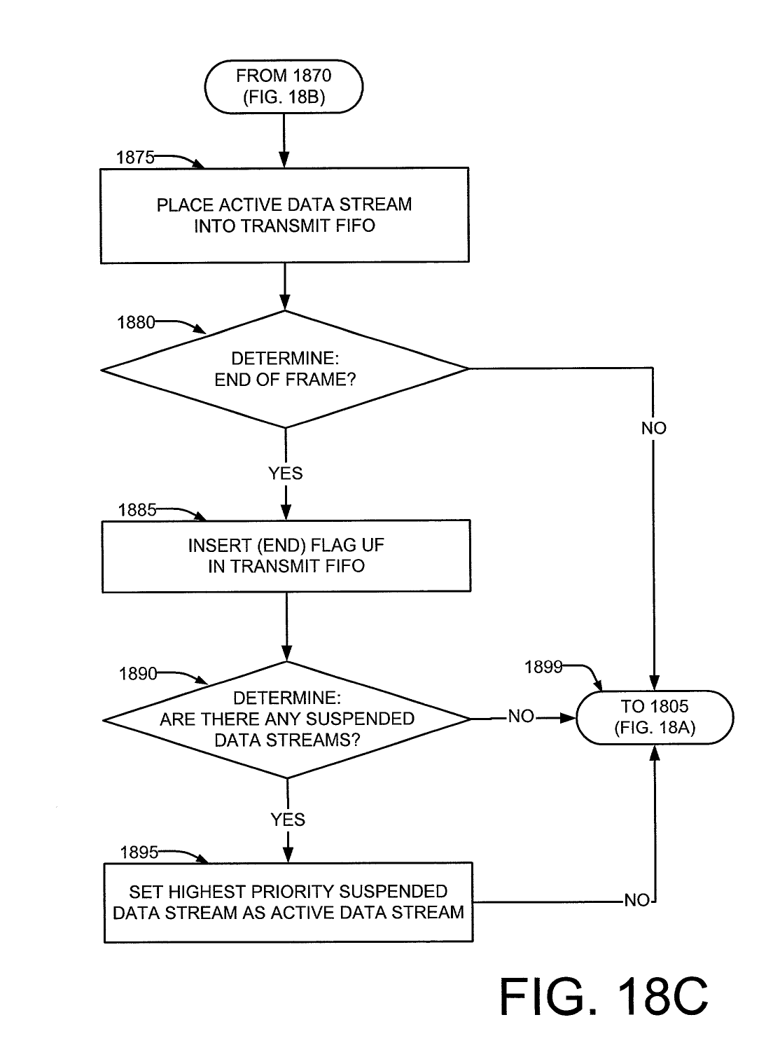

FIGS. 18A through 18C are flowcharts illustrating the method steps associated with continued transmission of data streams as shown in FIGS. 13A and 13B in one embodiment of the invention.

In this embodiment of the invention, the data streams (e.g., frame-1 200 of FIG. 6B), which are sorted by the transmit process 569 (FIG. 5C), contain headers (e.g., frame-1 header 220 of FIG. 6B) having priority information. In this non-limiting example, the system, in step 1805, waits for the next clock cycle. At the clock cycle, the transmit procedure 569 (FIG. 5C), in step 1810, determines whether the transmit FIFO 571 (FIG. 5C) needs data. If the transmit process 569 (FIG. 5C) determines 1810 that no data is needed, then the system waits 1805 for another clock cycle and repeats the process. If, however, the transmit process 569 (FIG. 5C) determines 1810 that the transmit FIFO 571 (FIG. 5C) needs data, then the transmit process 569 (FIG. 5C) further determines, in step 1815, whether the system is waiting data. If the transmit process 569 (FIG. 5C) determines 1815 that the system is not waiting data, then the transmit process 569 (FIG. 5C), in step 1820, places a flag in the transmit FIFO 571 (FIG. 5C) and waits 1805 for the next clock cycle. If, on the other hand, the transmit process 569 (FIG. 5C) determines 1815 that the system is waiting data, then the transmit process 569 (FIG. 5C), in step 1825, retrieves data from the source 559 (FIG. 5C). Once the data has been retrieved, the process continues to step 1830 in FIG. 18B.

Having retrieved 1825 the data from the source 559 (FIG. 5C), the transmit process 569 (FIG. 5C) then determines, in step 1830, whether a currently active data stream exists. If the transmit process 569 (FIG. 5C) determines 1830 that there is no currently active data stream, then the transmit process 569 (FIG. 5C), in step 1835, places a UF in the transmit FIFO 571 (FIG. 5C) to indicate the start of a data stream. After placing 1835 the UF in the transmit FIFO 1835 (FIG. 5C), the transmit process 569 (FIG. 5C) places, in step 1857, a frame header for the retrieved 1825 data in the transmit FIFO 571 (FIG. 5C) and sets, in step 1860, the retrieved 1825 data as the active data stream, which is to be transmitted according to the procedure set forth in FIG. 18C.

If, however, in step 1830, the transmit process 569 (FIG. 5C) determines that there exists a currently active data stream, then the transmit process further determines, in step 1840, whether the system should deviate from a strict stacking mechanism. If the transmit process 569 (FIG. 5C) determines 1840 that deviation from the strict stacking mechanism is appropriate, then the transmit FIFO 569 (FIG. 5C) places, in step 1845, a frame suspend non-stack (FSN) in the transmit FIFO 571 (FIG. 5C) to indicate deviation from the strict stacking mechanism. Upon placing 1845 the FSN in the transmit FIFO 571 (FIG. 5C), the transmit process 569 (FIG. 5C) places, in step 1857, a frame header for the retrieved 1825 data in the transmit FIFO 571 (FIG. 5C) and sets, in step 1860, the retrieved 1825 data as the active data stream, which is to be transmitted according to the procedure set forth in FIG. 18C.

If, in step 1840, the transmit process 567 (FIG. 5C) determines not to deviate from the strict stacking mechanism, then the transmit process 567 (FIG. 5C) determines, in step 1850, the priority of the retrieved data, and further determines, in step 1853, whether the currently active data stream has a higher priority than the retrieved 1825 data. If the transmit process 569 (FIG. 5C) determines 1853 that the currently active data stream has a lower priority than the retrieved data, then the transmit process 569 (FIG. 5C), in step 1855, places a frame suspend enable (FSE) in the transmit FIFO 571 (FIG. 5C), thereby suspending transmission of the currently active data stream. Once the currently active data stream has been suspended, the transmit process 569 (FIG. 5C) places 1857 a frame header for the retrieved 1825 data in the transmit FIFO 571 (FIG. 5C) and sets 1860 the retrieved 1825 data as the active data stream, which is to be transmitted according to the procedure set forth in FIG. 18C.

If, in step 1853, the system determines that the retrieved 1825 data does not have a higher priority, then the transmit process 569 (FIG. 5C) keeps, in step 1865, the currently active data stream as the active data stream, which is to be transmitted according to the procedure set forth in FIG. 18C.

Once the active data stream has been determined according to the procedure set forth in FIG. 18B, the transmit process 569 (FIG. 5C) places, in step 1875, the active data stream into the transmit FIFO 571 (FIG. 5C). The transmit process 569 (FIG. 5C) then determines, in step 1880, whether it is the end of the frame (i.e., the end of the data stream). If the transmit process 569 (FIG. 5C) determines 1880 that it is not the end of the data stream, the system proceeds back to step 1805 where the transmit process 569 (FIG. 5C) repeats the procedure by waiting 1805 for the next clock cycle. If, however, the transmit process 569 (FIG. 5C) determines 1880 that it is the end of the data stream, then the transmit process 569 (FIG. 5C), in step 1885, inserts a UF in the transmit FIFO 571 (FIG. 5C) as an end-flag. Having completed the transmission of the data stream, the transmit process 569 (FIG. 5C) then determines, in step 1890, whether there are any suspended data streams. If the transmit process 569 (FIG. 5C) determines 1890 that there are no suspended data streams, then the procedure jumps back to step 1805 where the transmit process 569 (FIG. 5C) awaits the next clock cycle. If, on the other hand, there exist suspended data streams, then the transmit process 569 (FIG. 5C), in step 1895, sets the highest priority suspended data stream as the active data stream and the procedure repeats itself from step 1805 until all suspended data streams have been transmitted in order of priority.

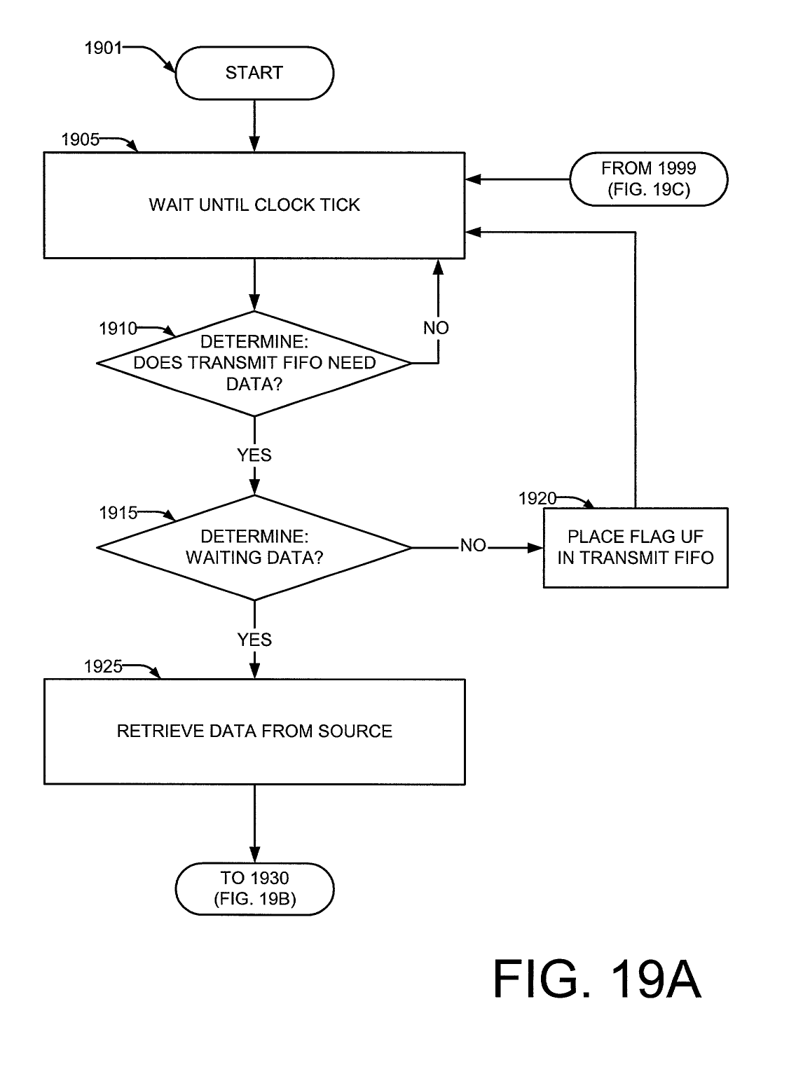

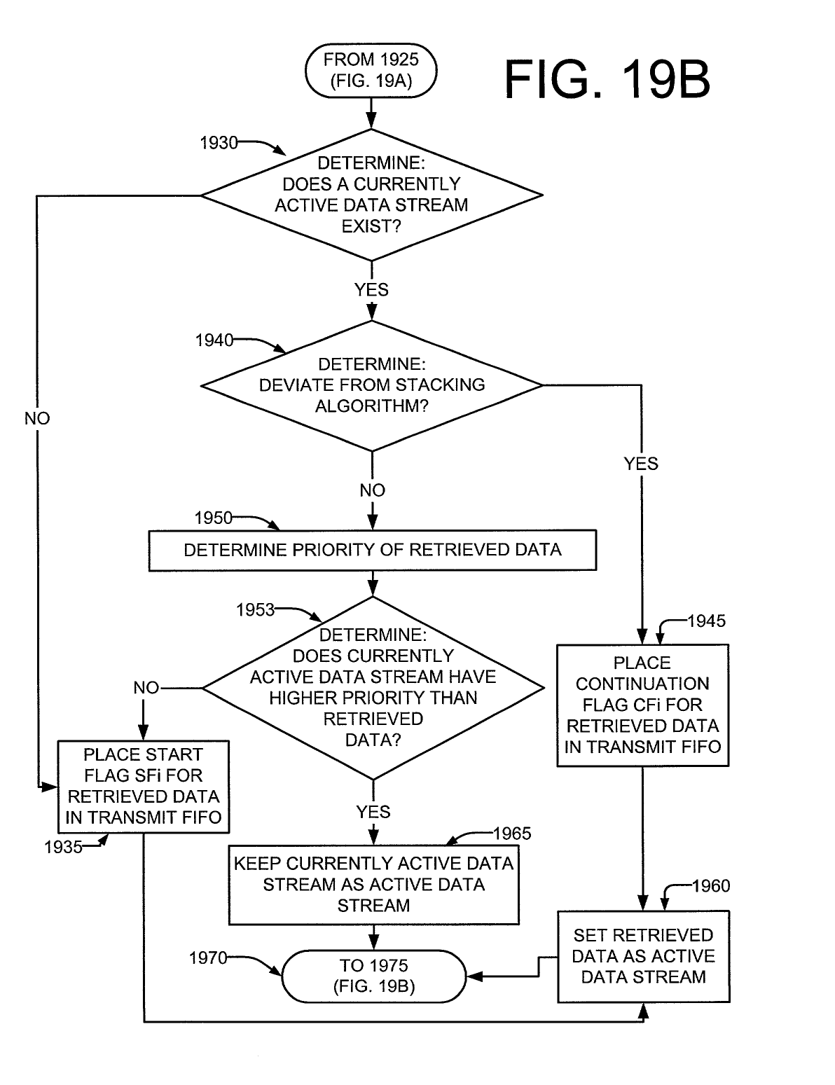

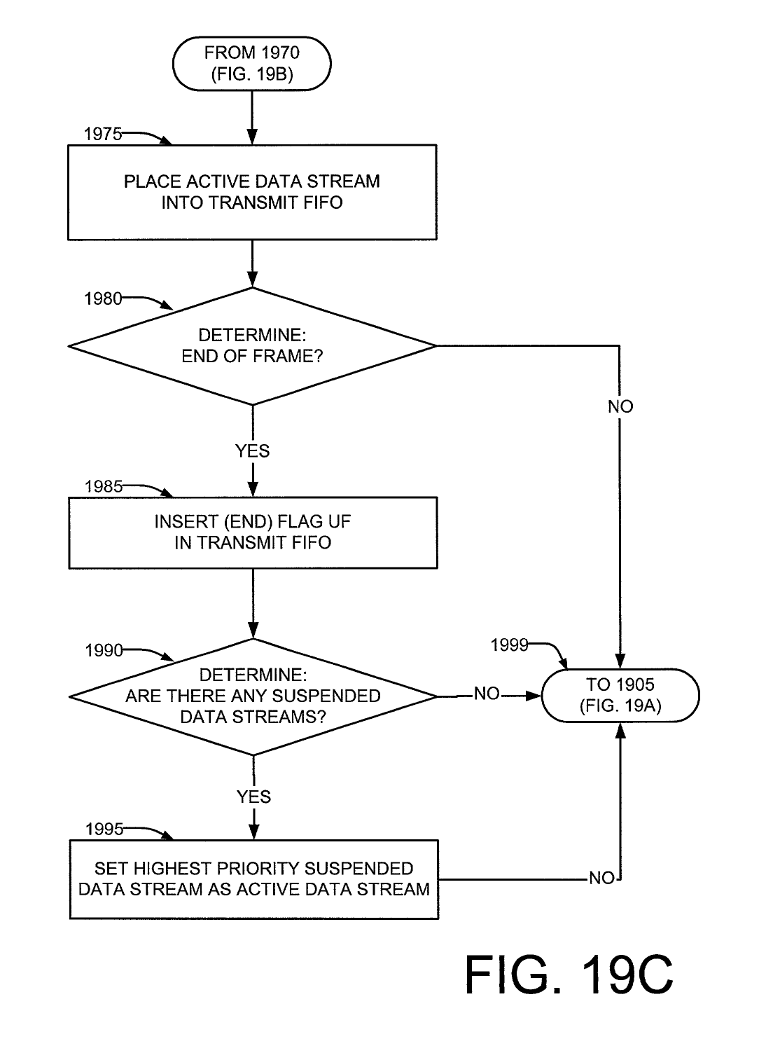

FIGS. 19A through 19C are flowcharts illustrating the method steps associated with continued transmission of header-less data streams as shown in FIGS. 14A and 14B in another embodiment of the invention.

In this embodiment of the invention, the data streams (e.g., header-less frame-1 1000 of FIG. 14B), which are sorted by the transmit process 569 (FIG. 5C), contain special start-flags (e.g., frame-1 start-flag 1020 of FIG. 14B) having priority information. In this non-limiting example, the system, in step 1905, waits for the next clock cycle. At the clock cycle, the transmit procedure 569 (FIG. 5C), in step 1910, determines whether the transmit FIFO 571 (FIG. 5C) needs data. If the transmit process 569 (FIG. 5C) determines 1910 that no data is needed, then the system waits 1905 for another clock cycle and repeats the process. If, however, the transmit process 569 (FIG. 5C) determines 1910 that the transmit FIFO 571 (FIG. 5C) needs data, then the transmit process 569 (FIG. 5C) further determines, in step 1915, whether the system is waiting data. If the transmit process 569 (FIG. 5C) determines 1915 that the system is not waiting data, then the transmit process 569 (FIG. 5C), in step 1920, places a flag in the transmit FIFO 571 (FIG. 5C) and waits 1905 for the next clock cycle. If, on the other hand, the transmit process 569 (FIG. 5C) determines 1915 that the system is waiting data, then the transmit process 569 (FIG. 5C), in step 1925, retrieves data from the source 559 (FIG. 5C). Once the data has been retrieved, the process continues to step 1930 in FIG. 19B.

Having retrieved 1925 the data from the source 559 (FIG. 5C), the transmit process 569 (FIG. 5C) then determines, in step 1930, whether a currently active data stream exists. If the transmit process 569 (FIG. 5C) determines 1930 that there is no currently active data stream, then the transmit process 569 (FIG. 5C), in step 1935, places special flag SFi in the transmit FIFO 571 (FIG. 5C) to indicate the start of data stream i. After placing 1935 SFi in the transmit FIFO 1935 (FIG. 5C), the transmit process 569 (FIG. 5C) sets, in step 1960, the retrieved 1925 data as the active data stream, which is to be transmitted according to the procedure set forth in FIG. 19C.

If, however, in step 1930, the transmit process 569 (FIG. 5C) determines that there exists a currently active data stream, then the transmit process 569 (FIG. 5C) further determines, in step 1940, whether the system should deviate from a strict stacking mechanism. If the transmit process 569 (FIG. 5C) determines 1940 that deviation from the strict stacking mechanism is appropriate, then the transmit FIFO 569 (FIG. 5C) places, in step 1945, a special continuation flag CFi in the transmit FIFO 571 (FIG. 5C) to indicate deviation from the strict stacking mechanism and the continuation of frame i transmission. Upon placing 1945 the CFi in the transmit FIFO 571 (FIG. 5C), the transmit process 569 (FIG. 5C) sets, in step 1960, the retrieved 1925 data as the active data stream, which is to be transmitted according to the procedure set forth in FIG. 19C.

If, in step 1940, the transmit process 567 (FIG. 5C) determines not to deviate from the strict stacking mechanism, then the transmit process 567 (FIG. 5C) determines, in step 1950, the priority of the retrieved data, and further determines, in step 1953, whether the currently active data stream has a higher priority than the retrieved 1925 data. If the transmit process 569 (FIG. 5C) determines 1953 that the currently active data stream has a lower priority than the retrieved data, then the transmit process 569 (FIG. 5C), in step 1935, places SFi in the transmit FIFO 571 (FIG. 5C), thereby suspending transmission of the currently active data stream. Once the currently active data stream has been suspended, the transmit process 569 (FIG. 5C) sets 1960 the retrieved 1925 data as the active data stream, which is to be transmitted according to the procedure set forth in FIG. 19C.

If, in step 1953, the system determines that the retrieved 1925 data does not have a higher priority, then the transmit process 569 (FIG. 5C) keeps, in step 1965, the currently active data stream as the active data stream, which is to be transmitted according to the procedure set forth in FIG. 19C.

Once the active data stream has been determined according to the procedure set forth in FIG. 19B, the transmit process 569 (FIG. 5C) places, in step 1975, the active data stream into the transmit FIFO 571 (FIG. 5C). The transmit process 569 (FIG. 5C) then determines, in step 1980, whether it is the end of the frame (i.e., the end of the data stream). If the transmit process 569 (FIG. 5C) determines 1980 that it is not the end of the data stream, the system proceeds back to step 1905 where the transmit process 569 (FIG. 5C) repeats the procedure by waiting 1905 for the next clock cycle. If, however, the transmit process 569 (FIG. 5C) determines 1980 that it is the end of the data stream, then the transmit process 569 (FIG. 5C), in step 1985, inserts a UF in the transmit FIFO 571 (FIG. 5C) as an end-flag. Having completed the transmission of the data stream, the transmit process 569 (FIG. 5C) then determines, in step 1990, whether there are any suspended data streams. If the transmit process 569 (FIG. 5C) determines 1990 that there are no suspended data streams, then the procedure jumps back to step 1905 where the transmit process 569 (FIG. 5C) awaits the next clock cycle. If, on the other hand, there exist suspended data streams, then the transmit process 569 (FIG. 5C), in step 1995, sets the highest priority suspended data stream as the active data stream and the procedure repeats itself from step 1905 until all suspended data streams have been transmitted in order of priority.

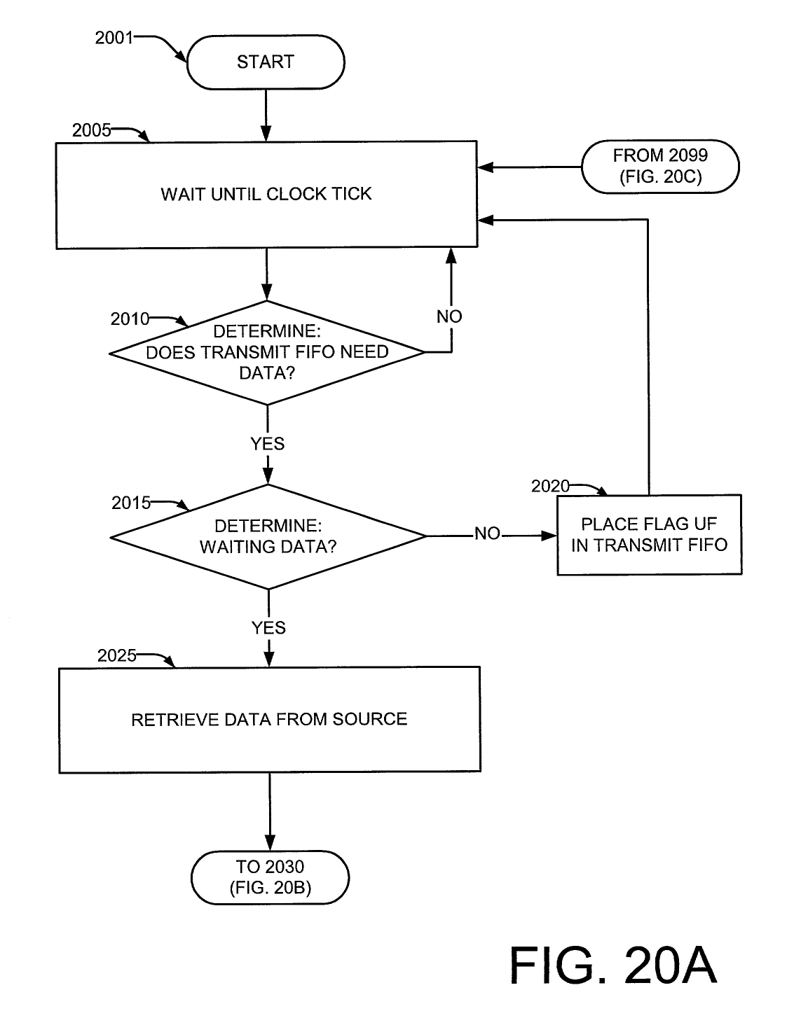

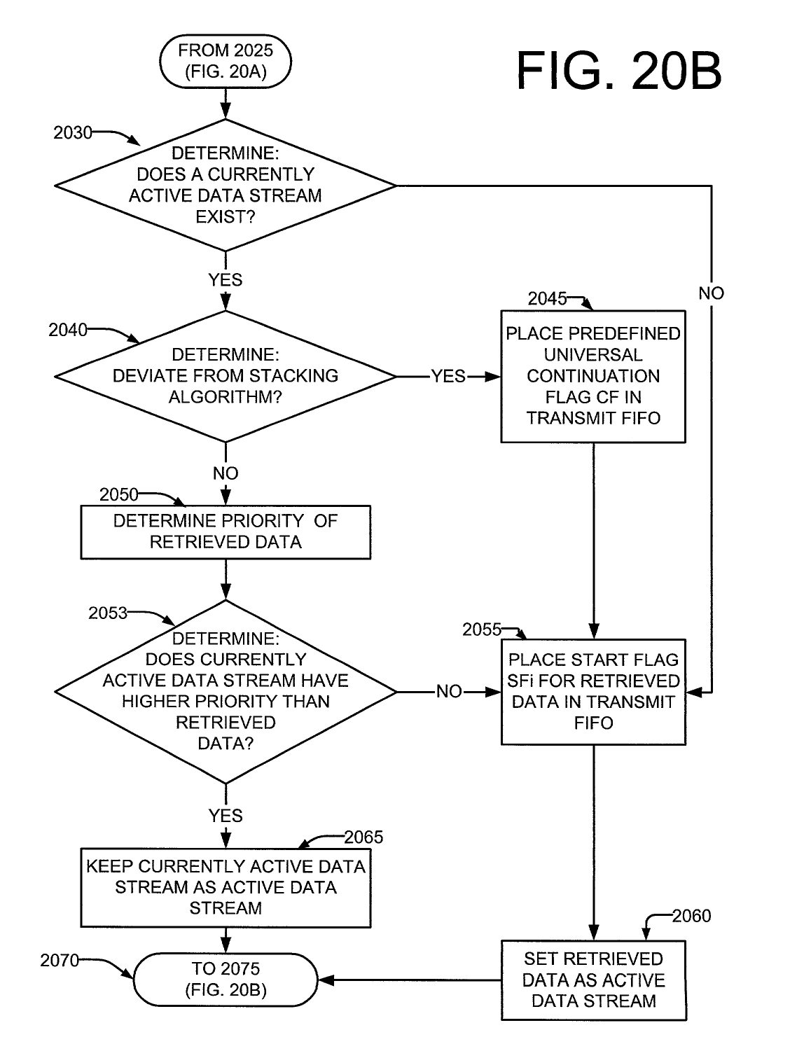

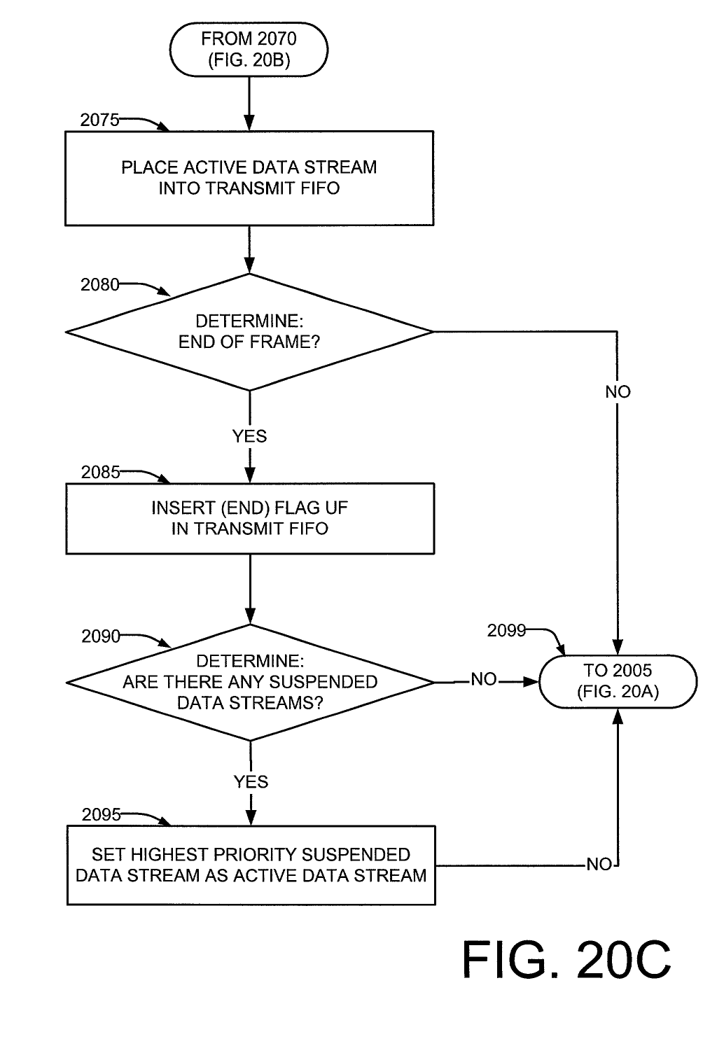

FIGS. 20A through 20C are flowcharts illustrating the method steps associated with continued transmission of header-less data streams using a predefined universal continuation flag as shown in FIGS. 15A and 15B in one embodiment of the invention.

In this embodiment of the invention, the data streams (e.g., header-less frame-1 1000 of FIG. 15B), which are sorted by the transmit process 569 (FIG. 5C), contain special start-flags (e.g., frame-1 start-flag 1020 of FIG. 15B) having priority information. In this non-limiting example, the system, in step 2005, waits for the next clock cycle. At the clock cycle, the transmit procedure 569 (FIG. 5C), in step 2010, determines whether the transmit FIFO 571 (FIG. 5C) needs data. If the transmit process 569 (FIG. 5C) determines 2010 that no data is needed, then the system waits 2005 for another clock cycle and repeats the process. If, however, the transmit process 569 (FIG. 5C) determines 2010 that the transmit FIFO 571 (FIG. 5C) needs data, then the transmit process 569 (FIG. 5C) further determines, in step 2015, whether the system is waiting data. If the transmit process 569 (FIG. 5C) determines 2015 that the system is not waiting data, then the transmit process 569 (FIG. 5C), in step 2020, places a flag in the transmit FIFO 571 (FIG. 5C) and waits 2005 for the next clock cycle. If, on the other hand, the transmit process 569 (FIG. 5C) determines 2015 that the system is waiting data, then the transmit process 569 (FIG. 5C), in step 2025, retrieves data from the source 559 (FIG. 5C). Once the data has been retrieved, the process continues to step 2030 in FIG. 20B.

Having retrieved 2025 the data from the source 559 (FIG. 5C), the transmit process 569 (FIG. 5C) then determines, in step 2030, whether a currently active data stream exists. If the transmit process 569 (FIG. 5C) determines 2030 that there is no currently active data stream, then the transmit process 569 (FIG. 5C), in step 2035, places special flag SFi in the transmit FIFO 571 (FIG. 5C) to indicate the start of data stream i. After placing 2035 SFi in the transmit FIFO 2035 (FIG. 5C), the transmit process 569 (FIG. 5C) sets, in step 2060, the retrieved 2025 data as the active data stream, which is to be transmitted according to the procedure set forth in FIG. 20C.

If, however, in step 2030, the transmit process 569 (FIG. 5C) determines that there exists a currently active data stream, then the transmit process 569 (FIG. 5C) further determines, in step 2040, whether the system should deviate from a strict stacking mechanism. If the transmit process 569 (FIG. 5C) determines 2040 that deviation from the strict stacking mechanism is appropriate, then the transmit FIFO 569 (FIG. 5C) places, in step 2045, a predefined universal continuation flag CF in the transmit FIFO 571 (FIG. 5C) to indicate deviation from the strict stacking mechanism. Upon placing 2045 the CF in the transmit FIFO 571 (FIG. 5C), the transmit process 569 (FIG. 5C) places, in step 2055, a start flag SFi in the transmit FIFO 571 (FIG. 5C) to indicate the start of data transmission for retrieved 2025 frame i. Having placed 2055 SFi in the transmit FIFO 571 (FIG. 5C), the transmit process 569 (FIG. 5C) sets, in step 2060, the retrieved 2025 data as the active data stream, which is to be transmitted according to the procedure set forth in FIG. 20C.

If, in step 2040, the transmit process 567 (FIG. 5C) determines not to deviate from the strict stacking mechanism, then the transmit process 567 (FIG. 5C) determines, in step 2050, the priority of the retrieved 2025 data, and further determines, in step 2053, whether the currently active data stream has a higher priority than the retrieved 2025 data. If the transmit process 569 (FIG. 5C) determines 2053 that the currently active data stream has a lower priority than the retrieved data, then the transmit process 569 (FIG. 5C), in step 2055, places SFi in the transmit FIFO 571 (FIG. 5C), thereby suspending transmission of the currently active data stream. Once the currently active data stream has been suspended, the transmit process 569 (FIG. 5C) sets 2060 the retrieved 2025 data as the active data stream, which is to be transmitted according to the procedure set forth in FIG. 20C.

If, in step 2053, the system determines that the retrieved 2025 data does not have a higher priority, then the transmit process 569 (FIG. 5C) keeps, in step 2065, the currently active data stream as the active data stream, which is to be transmitted according to the procedure set forth in FIG. 20C.

Once the active data stream has been determined according to the procedure set forth in FIG. 20B, the transmit process 569 (FIG. 5C) places, in step 2075, the active data stream into the transmit FIFO 571 (FIG. 5C). The transmit process 569 (FIG. 5C) then determines, in step 2080, whether it is the end of the frame (i.e., the end of the data stream). If the transmit process 569 (FIG. 5C) determines 2080 that it is not the end of the data stream, the system proceeds back to step 2005 where the transmit process 569 (FIG. 5C) repeats the procedure by waiting 2005 for the next clock cycle. If, however, the transmit process 569 (FIG. 5C) determines 2080 that it is the end of the data stream, then the transmit process 569 (FIG. 5C), in step 2085, inserts a UF in the transmit FIFO 571 (FIG. 5C) as an end-flag. Having completed the transmission of the data stream, the transmit process 569 (FIG. 5C) then determines, in step 2090, whether there are any suspended data streams. If the transmit process 569 (FIG. 5C) determines 2090 that there are no suspended data streams, then the procedure jumps back to step 2005 where the transmit process 569 (FIG. 5C) awaits the next clock cycle. If, on the other hand, there exist suspended data streams, then the transmit process 569 (FIG. 5C), in step 2095, sets the highest priority suspended data stream as the active data stream and the procedure repeats itself from step 2005 until all suspended data streams have been transmitted in order of priority.

Having described (1) an embodiment of the system of the invention in FIGS. 5A through 5D, (2) the configuration of the data streams for such a system in FIGS. 6A through 12B, and (3) the transmit procedure associated with the system and data streams in FIGS. 16A through 20C, it will be clear to one of ordinary skill in the art that the procedure for reconstructing the fragmented data streams according to the predetermined priority sorting mechanism may be deduced from the preceding description and the corresponding figures. Thus, the steps associated with receiving and reconstructing the data streams is not discussed here.

Although an exemplary embodiment of the present invention has been shown and described, it will be apparent to those of ordinary skill in the art that a number of changes, modifications, or alterations to the invention as described may be made, none of which depart from the spirit of the present invention. For example, although the method steps are shown as sequential steps in several embodiments of the invention, it will be clear to one of ordinary skill in the art that these steps may be taken out of order or performed concurrently. Additionally, it will be clear to one of ordinary skill in the art that certain steps (e.g., the step of waiting for data, etc.) are not distinct steps but, rather, ongoing processes merely depicted as a sequential step for purposes of clarity. Moreover, while the disclosed embodiments show up to two interruptions in data transmission, it will be clear to one of ordinary skill in the art that data stream transmission may be suspended and resumed continuously until all of the data streams have been transmitted. Also, while a FILO approach is shown as the best mode for implementing the priority sorting mechanism, it will be clear to one of ordinary skill in the art that there are numerous other ways to implement the priority sorting mechanism.

All such changes, modifications, and alterations should therefore be seen as within the scope of the present invention.

I claim:

1. In a signal transmission system, wherein a first data stream is being transmitted, the first data stream having a first data stream header, the first data stream header having data stream priority information, a method for suspending and resuming transmission of the first data stream comprising the steps of:
receiving a second data stream having a second data stream header, the second data stream header having data stream priority information;
determining a first data stream priority from the first data stream header;
determining a second data stream priority from the second data stream header;
comparing the first data stream priority with the second data stream priority;
preserving data stream transmission order using a priority sorting mechanism;
fragmenting the first data stream without creating a fragment header in response to a higher second data stream priority;
suspending transmission of the first data stream in response to a higher second data stream priority;
transmitting the second data stream; and
fluidly resuming transmission of the first data stream after transmitting the second data stream in accordance with the priority sorting mechanism.

2. In a signal transmission system wherein a first data stream transmission is in progress, a method for suspending and resuming transmission of the first data stream comprising the steps of:
receiving a second data stream having a suspend-flag;
comparing the first data stream priority with the second data stream priority;
preserving data stream transmission order using a priority sorting mechanism;
suspending transmission of the first data stream in response to a higher second data stream priority;
transmitting the second data stream; and
fluidly resuming transmission of the first data stream after transmitting the second data stream in accordance with the priority sorting mechanism.

3. The method of claim 2, wherein each data stream comprises a header.

4. The method of claim 3, wherein the step of comparing the first data stream priority includes evaluating a first data stream priority value that is included in the first data stream header.

5. The method of claim 3, wherein the step of comparing the second data stream priority includes evaluating a second data stream priority value that is included in the second data stream header.

6. The method of claim 3, wherein the comparing step further comprises the steps of:
determining a first data stream priority from the first data stream header;
determining a second data stream priority from the second data stream header; and
preserving data stream transmission order using a priority sorting mechanism.

7. The method of claim 2, wherein each data stream contains no header.

8. The method of claim 7, wherein each data stream comprises a special flag.

9. The method of claim 8, wherein the step of comparing the first data stream priority includes evaluating a first data stream priority value that is included in a first data stream special flag.

10. The method of claim 8, wherein the step of comparing the second data stream priority includes evaluating a second data stream priority value that is included in a second data stream special flag.

11. The method of claim 8, wherein the special flag indicates the start of a data stream.

12. The method of claim 8, wherein the special flag indicates the start of a fragment.

13. The method of claim 8, wherein each data stream has a 12-bit base.

14. The method of claim 8, wherein each data stream has a 16-bit base.

15. The method of claim 8, wherein each data stream has an n-bit base, wherein n is optimized to maximize the efficiency based on the expected distribution of frame lengths and the number of special characters.

16. A method for suspending and resuming transmissions of multiple data streams comprising the steps of:
comparing data stream priorities;
preserving data stream transmission information using a priority sorting mechanism;
suspending lower priority data streams;
transmitting higher priority data streams; and
fluidly resuming transmission of lower priority suspended data streams in accordance with the data stream transmission information preserved using the priority sorting mechanism.

17. In a signal transmission system wherein a first data stream transmission is in progress, the first data stream having a first data stream priority, a method for suspending and resuming transmission of the first data stream comprising the steps of:
receiving a lower-priority second data stream having a second data stream suspendflag;
determining a transmission priority order from the suspend-flag using a predetermined priority sorting mechanism;
suspending transmission of the first data stream in response to the data stream suspend-flag;
transmitting the lower-priority second data stream; and
fluidly resuming transmission of the first data stream after transmitting the lower-priority second data stream in accordance with the predetermined priority sorting mechanism.

18. The method of claim 17, wherein each data stream comprises a header.

19. The method of claim 18, wherein the first data stream priority is included in the first data stream header.

20. The method of claim 18, wherein the second data stream priority is included in the second data stream header.

21. The method of claim 18, wherein the suspending step further comprises the steps of:
interrupting transmission of the first data stream;
fragmenting the first data stream;
creating a header for each fragment of the first data stream, the header having data-stream transmission-priority information in accordance with the predetermined priority sorting mechanism.

22. The method of claim 17, wherein each data stream contains no header.

23. The method of claim 22, wherein each data stream comprises a special flag.

24. The method of claim 23, wherein the first data stream priority is included in the first data stream special flag.

25. The method of claim 23, wherein the second data stream priority is included in the second data stream special flag.

26. The method of claim 23, wherein the special flag indicates the start of a data stream.

27. The method of claim 23, wherein the special flag indicates the start of a fragment.

28. The method of claim 23, wherein each data stream has a 12-bit base.

29. The method of claim 23, wherein each data stream has a 16-bit base.

30. The method of claim 23, wherein each data stream has an n-bit base, wherein n is optimized to maximize the efficiency based on the expected distribution of frame lengths and the number of special characters.

31. The method of claim 23, wherein the suspending step further comprises the steps of:
interrupting transmission of the first data stream; and
fragmenting the first data stream without creating significant additional overhead.

32. A method for suspending and resuming transmissions of multiple data streams comprising the steps of:
comparing data stream priorities;
preserving data stream transmission information using a predetermined priority sorting mechanism;
suspending higher priority data streams;
transmitting lower priority data streams; and
fluidly resuming transmission of higher priority suspended data streams in accordance with the data stream transmission information preserved by the predetermined priority sorting mechanism.

33. In a signal transmission system, wherein a first data stream is being transmitted, the first data stream having a first data stream priority, a system for suspending and resuming transmission of the first data stream comprising:
a second data stream having a second data stream priority; and
a processor having a priority sorting mechanism, the priority sorting mechanism configured to determine data stream transmission order without creating significant additional overhead, the data stream transmission order determined as a flnction of the first data stream priority and the second data stream priority, the processor configured to selectively suspend the first data stream in response to the data stream transmission order determined by the priority sorting mechanism, the processor further configured to transmit the second data stream upon suspension of the first data stream, the processor further configured to resume transmission of the first data stream after transmission of the second data stream.

34. The system of claim 33, wherein the first data stream comprises a header having the first data stream priority.

35. The system of claim 33, wherein the second data stream comprises a header having the second data stream priority.

36. The system of claim 33, wherein the priority sorting mechanism is a stacking mechanism, wherein the data stream transmission order is determined on a first-in last-out basis.

37. The system of claim 33, wherein the first data stream priority is higher than the second data stream priority.

38. The system of claim 33, wherein the first data stream priority is not higher than the second data stream priority.

39. The system of claim 33, wherein each data stream contains no header.

40. The system of claim 39, wherein each data stream has a 12-bit base.

41. The system of claim 39, wherein each data stream has a 16-bit base.

42. The system of claim 39, wherein each data stream has an n-bit base, wherein n is optimized to maximize the efficiency based on the expected distribution of frame lengths and the number of special characters.

43. The system of claim 39, wherein the first data stream comprises a first data-stream special flag having the first data stream priority.

44. The system of claim 43, wherein the first data-stream special flag is configured as a first data stream opening flag.

45. The system of claim 44, wherein the first data-stream special flag is further configured as a data stream suspend enable flag.

46. The system of claim 43, wherein the first data-stream special flag is configured as a first data stream continuation flag.

47. The system of claim 43, wherein the first data-stream special flag is configured as a pre-defined universal continuation flag.

48. The system of claim 39, wherein the second data stream compri ses a second data-stream special flag having the second data stream priority.

49. The system of claim 48, wherein the second data-stream special flag is configured as a second data stream opening flag.

50. The system of claim 49, wherein the second data-stream special flag is configured as a data stream suspend enable flag.

51. The system of claim 48, wherein the second data-stream special flag is configured as a second data stream continuation flag.

52. The system of claim 48, wherein the second data-stream special flag is configured as a pre-defined universal continuation flag.

53. The system of claim 39, wherein the priority sorting mechanism is a stacking mechanism, wherein the data stream transmission order is determined on a first-in last-out basis.

54. The system of claim 39, wherein the first data stream priority is higher than the second data stream priority.

55. The system of claim 39, wherein the first data stream priority is not higher than the second data stream priority.

56. In a signal transmission system, wherein a first data stream is being transmitted, the first data stream having a first data stream priority, a system for suspending and resuming transmission of the first data stream comprising:
a second data stream having a second data stream priority;
means for determining data stream transmission order without creating significant additional overhead, the data stream transmission order determined as a flnction of the first data stream priority and the second data stream priority;
means for selectively suspending the first data stream in response to the data stream transmission order determined by the priority sorting mechanism;
means for transmitting the second data stream upon suspension of the first data stream; and
means for transmitting the first data stream after transmitting the second data stream.

57. The system of claim 56, wherein the first data stream comprises a header having the first data stream priority.

58. The system of claim 56, wherein the second data stream comprises a header having the second data stream priority.

59. The system of claim 56, wherein the first data stream priority is higher than the second data stream priority.

60. The system of claim 56, wherein the first data stream priority is not higher than the second data stream priority.

61. The system of claim 56, wherein each data stream contains no header.

62. The system of claim 61, wherein the first data stream comprises a first data-stream special flag having the first data stream priority.

63. The system of claim 62, wherein the first-data stream special flag is configured as a first data stream opening flag.

64. The system of claim 63, wherein the first-data stream special flag is further configured as a data stream suspend enable flag.

65. The system of claim 62, wherein the first-data stream special flag is configured as a first data stream continuation flag.

66. The system of claim 62, wherein the first-data stream special flag is configured as a pre-defined universal continuation flag.

67. The system of claim 61, wherein the second data stream comprises a second-data stream special flag having the second data stream priority.

68. The system of claim 67, wherein the second-data stream special flag is configured as a second data stream opening flag.

69. The system of claim 68, wherein the second-data stream special flag is configured as a data stream suspend enable flag.

70. The system of claim 67, wherein the second-data stream special flag is configured as a second data stream continuation flag.

71. The system of claim 67, wherein the second-data stream special flag is configured as a pre-defined universal continuation flag.

72. The system of claim 61, wherein the first data stream priority is higher than the second data stream priority.

73. The system of claim 61, wherein the first data stream priority is not higher than the second data stream priority.

74. In a signal transmission system, wherein a first data stream is being transmitted, the first data stream having a first data stream header, the first data stream header having data stream priority information, a system for suspending and resuming transmission of the first data stream comprising:
means for receiving a second data stream having a second data stream header, the second data stream header having data stream priority information;
means for determining a first data stream priority from the first data stream header;
means for determining a second data stream priority from the second data stream header;
means for comparing the first data stream priority with the second data stream priority;
means for preserving data stream transmission order using a priority sorting mechanism;
means for fragmenting the first data stream without creating a fragment header in response to a higher second data stream priority;
means for suspending transmission of the first data stream in response to a higher second data stream priority;
means for transmitting the second data stream; and
means for fluidly resuming transmission of the first data stream after transmitting the second data stream in accordance with the priority sorting mechanism.

75. In a signal transmission system wherein a first data stream transmission is in progress, a system for suspending and resuming transmission of the first data stream comprising:
means for receiving a second data stream having a suspend-flag;
means for comparing the first data stream priority with the second data stream priority;
means for preserving data stream transmission order using a priority sorting mechanism;
means for suspending transmission of the first data stream in response to a higher second data stream priority;
means for transmitting the second data stream; and
means for fluidly resuming transmission of the first data stream after transmitting the second data stream in accordance with the priority sorting mechanism.

76. The system of claim 75, wherein each data stream comprises a header.

77. The system of claim 76, wherein the first data stream priority is included in the first data stream header.

78. The system of claim 76, wherein the second data stream priority is included in the second data stream header.

79. The system of claim 76, wherein the comparing means further comprises:
means for determining a first data stream priority from the first data stream header;
means for determining a second data stream priority from the second data stream header; and
means for preserving data stream transmission order using a priority sorting mechanism.

80. The system of claim 75, wherein each data stream contains no header.

81. The system of claim 80, wherein each data stream comprises a special flag.

82. The system of claim 81, wherein the first data stream priority is included in the first data stream special flag.

83. The system of claim 81, wherein the second data stream priority is included in the second data stream special flag.

84. The system of claim 81, wherein the special flag indicates the start of a data stream.

85. The system of claim 81, wherein the special flag indicates the start of a fragment.

86. The system of claim 81, wherein each data stream has a 12-bit base.

87. The system of claim 81, wherein each data stream has a 16-bit base.

88. The system of claim 81, wherein each data stream has an n-bit base, wherein n is optimized to maximize the efficiency based on the expected distribution of frame lengths and the number of special characters.

89. A system for suspending and resuming transmissions of multiple data streams comprising:
means for comparing data stream priorities;
means for preserving data stream transmission information using a priority sorting mechanism;
means for suspending lower priority data streams;
means for transmitting higher priority data streams; and
means for fluidly resuming transmission of lower priority suspended data streams in accordance with the data stream transmission information preserved using the priority sorting mechanism.

90. In a signal transmission system wherein a first data stream transmission is in progress, the first data stream having a first data stream priority, a system for suspending and resuming transmission of the first data stream comprising:
means for receiving a lower-priority second data stream having a second data stream suspend-flag;
means for determining a transmission priority order from the suspend-flag using a predetermined priority sorting mechanism;
means for suspending transmission of the first data stream in response to the data stream suspend-flag;
means for transmitting the lower-priority second data stream; and
means for fluidly resuming transmission of the first data stream after transmitting the lower-priority second data stream in accordance with the predetermined priority sorting mechanism.

91. The system of claim 90, wherein each data stream comprises a header.

92. The system of claim 91, wherein the first data stream priority is included in the first data stream header.

93. The system of claim 91, wherein the second data stream priority is included in the second data stream header.

94. The system of claim 91, wherein the suspending means further comprises:
means for interrupting transmission of the first data stream;
means for fragmenting the first data stream;
means for creating a header for each fragment of the first data stream, the header having data-stream transmission priority information in accordance with the predetermined priority sorting mechanism.

95. The system of claim 90, wherein each data stream contains no header.

96. The system of claim 95, wherein each data stream comprises a special flag.

97. The system of claim 96, wherein the first data stream priority is included in the first data stream special flag.

98. The system of claim 96, wherein the second data stream priority is included in the second data stream special flag.

99. The system of claim 96, wherein the special flag indicates the start of a data stream.

100. The system of claim 96, wherein the special flag indicates the start of a fragment.

101. The system of claim 96, wherein each data stream has a 12-bit base.

102. The system of claim 96, wherein each data stream has a 16-bit base.

103. The system of claim 96, wherein each data stream has an n-bit base, wherein n is optimized to maximize the efficiency based on the expected distribution of frame lengths and the number of special characters.

104. The system of claim 96, wherein the suspending means further comprises:
means for interrupting transmission of the first data stream; and
means for fragmenting the first data stream without creating significant additional overhead.

105. A system for suspending and resuming transmissions of multiple data streams comprising:
means for comparing data stream priorities;
means for preserving data stream transmission information using a predetermined priority sorting mechanism;
means for suspending higher priority data streams;
means for transmitting lower priority data streams; and
means for fluidly resuming transmission of higher priority suspended data streams in accordance with the data stream transmission information preserved by the predetermined priority sorting mechanism.
